(19) United States
(12) Patent Application Publication
(10) Pub. No.: US 2023/0362951 A1
(43) Pub. Date: Nov. 9, 2023

(54) METHOD AND APPARATUS OF TCI STATE INDICATION AND UPDATE VIA DYNAMIC SIGNALING

(71) Applicant: Samsung Electronics Co., Ltd., Suwon-si (KR)

(72) Inventors: Dalin Zhu, Allen, TX (US); Emad N. Farag, Flanders, NJ (US); Eko Onggosanusi, Coppell, TX (US)

(21) Appl. No.: 18/308,983

(22) Filed: Apr. 28, 2023

Related U.S. Application Data
(60) Provisional application No. 63/459,863, filed on Apr. 17, 2023.
(60) Provisional application No. 63/456,959, filed on Apr. 4, 2023.
(60) Provisional application No. 63/456,287, filed on Mar. 31, 2023.
(60) Provisional application No. 63/454,560, filed on Mar. 24, 2023.
(60) Provisional application No. 63/452,937, filed on Mar. 17, 2023.
(60) Provisional application No. 63/442,646, filed on Feb. 1, 2023.
(60) Provisional application No. 63/339,677, filed on May 9, 2022.

(51) Int. Cl. H04W 72/232; H04W 72/231

(52) U.S. Cl. CPC H04W 72/231; H04W 72/232

(57) ABSTRACT

Methods and apparatuses for transmission configuration indication (TCI) state indication and update via dynamic signaling in a wireless communication system. A method performed by a user equipment (UE) includes receiving, in a radio resource control (RRC) signaling, a first indicator; receiving, in a medium access control (MAC) control element (CE), a second indicator; receiving scheduling information of a physical downlink shared channel (PDSCH); and receiving, based on a first or second applied TCI state, the PDSCH. The method further includes identifying, based on the first indicator, at least one of a first group or a second group of TCI states; determining, based on the second indicator, whether a first or second TCI state updates the first or second applied TCI state; and determining, based on the identification and the second indicator, whether the first and second TCI states belong to the first group or second group of TCI states.

### CROSS REFERENCE TO RELATED APPLICATIONS AND CLAIM OF PRIORITY

The present application claims priority to:
U.S. Provisional Pat. Application No. 63/339,677, filed on May 9, 2022;
U.S. Provisional Pat. Application No. 63/442,646, filed on Feb. 1, 2023;
U.S. Provisional Pat. Application No. 63/452,937, filed on Mar. 17, 2023;
U.S. Provisional Pat. Application No. 63/454,560, filed on Mar. 24, 2023;
U.S. Provisional Pat. Application No. 63/456,287, filed on Mar. 31, 2023;
U.S. Provisional Pat. Application No. 63/456,959, filed on Apr. 4, 2023; and
U.S. Provisional Pat. Application No. 63/459,863, filed on Apr. 17, 2023. The contents of the above-identified patent documents are incorporated herein by reference.

### TECHNICAL FIELD

The present disclosure relates generally to wireless communication systems and, more specifically, the present disclosure relates to a transmission configuration indication (TCI) state indication and update via dynamic signaling in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a TCI state indication and update via a dynamic signaling in a wireless communication system.

In one embodiment, a user equipment (UE) is provided. The UE includes a transceiver configured to receive, in a radio resource control (RRC) signaling, a first indicator associated with one or more TCI states; receive, in a medium access control (MAC) control element (CE), a second indicator for a TCI codepoint including a first TCI state or a second TCI state; receive, in downlink control information (DCI), scheduling information of a physical downlink shared channel (PDSCH); and receive, based on a first applied TCI state or a second applied TCI state, the PDSCH. The UAE further includes a processor operably coupled to the transceiver. The processor is configured to identify, based on the first indicator, at least one of a first group or a second group of TCI states; determine, based on the second indicator, whether the first or second TCI state updates the first or second applied TCI state; and determine, based on the identification and the second indicator, whether the first and second TCI states belong to the first group or second group of TCI states.

In another embodiment, a base station (BS) Is provided. The BS includes a transceiver configured to transmit, in a RRC signaling, a first indicator associated with one or more TCI states; transmit, in a MAC-CE, a second indicator for a TCI codepoint including a first TCI state or a second TCI state; transmit, in DCI, scheduling information of a PDSCH; and transmit the PDSCH for reception based on a first applied TCI state or a second applied TCI state. The first indicator provides an indication of at least one of a first group or a second group of TCI states. The second indicator indicates whether the first or second TCI state updates the first or second applied TCI state. The indication and the second indicator indicate whether the first and second TCI states belong to the first group or second group of TCI states.

In yet another embodiment, a method performed by a UE is provided. The method includes receiving, in a RRC signaling, a first indicator associated with one or more TCI states; receiving, in a MAC-CE, a second indicator for a TCI codepoint including a first TCI state or a second TCI state; receiving, in DCI, scheduling information of a PDSCH; and receiving, based on a first applied TCI state or a second applied TCI state, the PDSCH. The method further includes identifying, based on the first indicator, at least one of a first group or a second group of TCI states; determining, based on the second indicator, whether the first or second TCI state updates the first or second applied TCI state; and determining, based on the identification and the second indicator, whether the first and second TCI states belong to the first group or second group of TCI states.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of multiple transmission and reception point system according to embodiments of the present disclosure; and

FIG. 9 illustrates an example of MAC CE command to activate TCI states according to embodiments of the present disclosure;

FIG. 10 illustrates a flowchart of a method for TCI states indication and application according to embodiments of the present disclosure;

FIG. 11 illustrates another flowchart of a method for TCI states indication and application according to embodiments of the present disclosure;

FIG. 12 illustrates an example of TCI states grouping via bitmaps according to embodiments of the present disclosure;

FIG. 13 illustrates an example of associating TCI states to aperiodic CSI-RS resources according to embodiments of the present disclosure;

FIG. 14 illustrates another example of associating TCI states to aperiodic CSI-RS resources according to embodiments of the present disclosure;

FIG. 15 illustrates an example of associating TCI states to aperiodic SRS resources according to embodiments of the present disclosure; and

FIG. 16 illustrates another example of associating TCI states to aperiodic SRS resources according to embodiments of the present disclosure.

### DETAILED DESCRIPTION

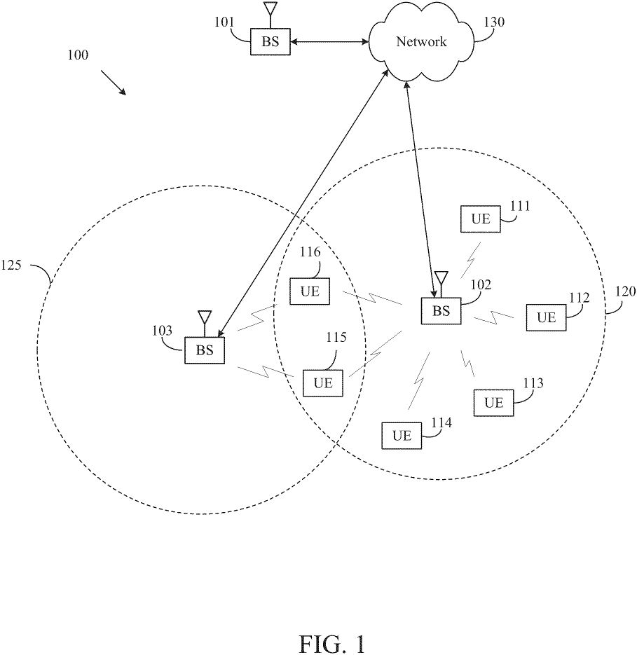

FIG. 1 through FIG. 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a TCI state indication and update via a dynamic signaling in a wireless communication system. In certain embodiments, and one or more of the gNBs 101-103 includes circuitry, programing, or a combination thereof, for a TCI state indication and update via a dynamic signaling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

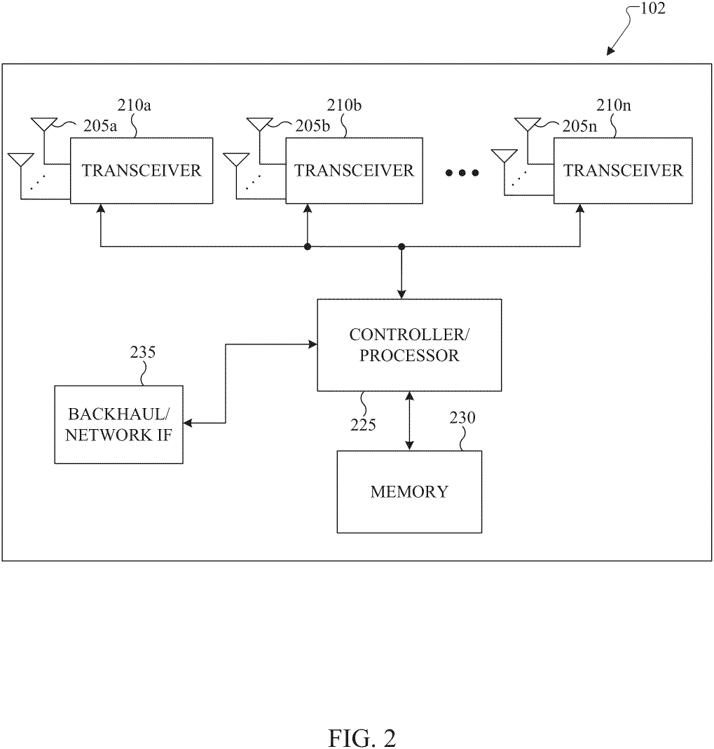

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n downconvert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a TCI state indication and update via a dynamic signaling in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

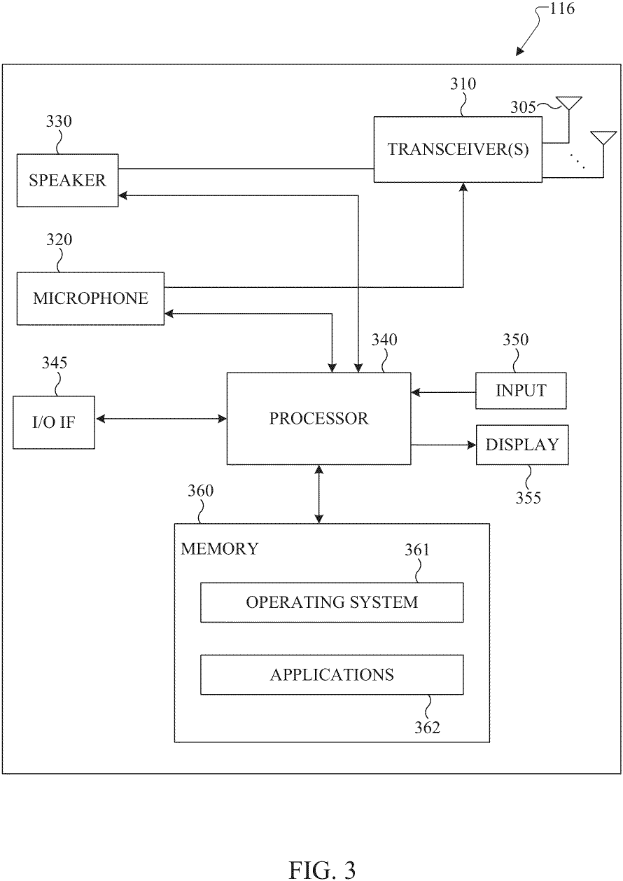

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a TCI state indication and update via a dynamic signaling in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

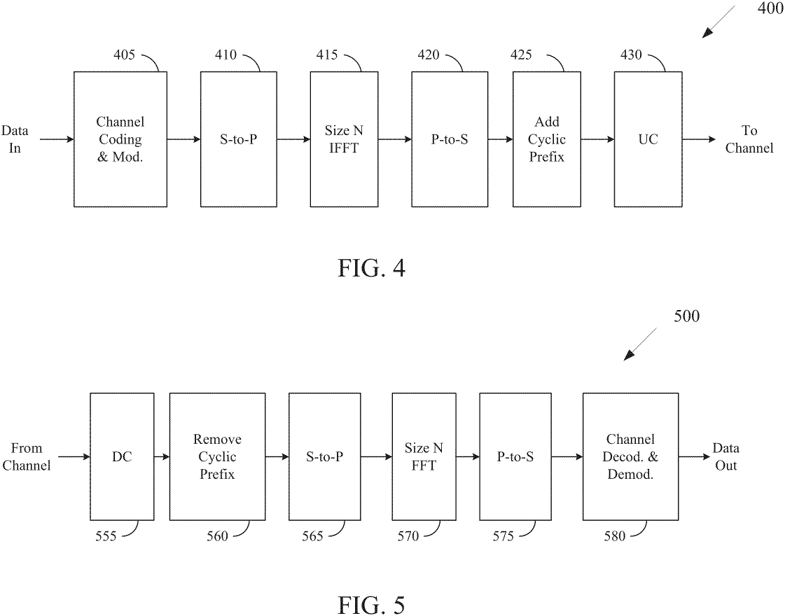

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a TCI state indication and update via a dynamic signaling in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

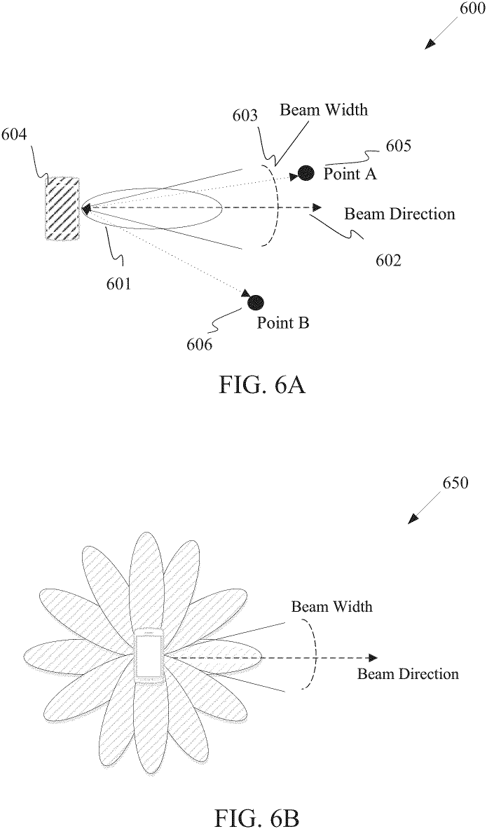

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

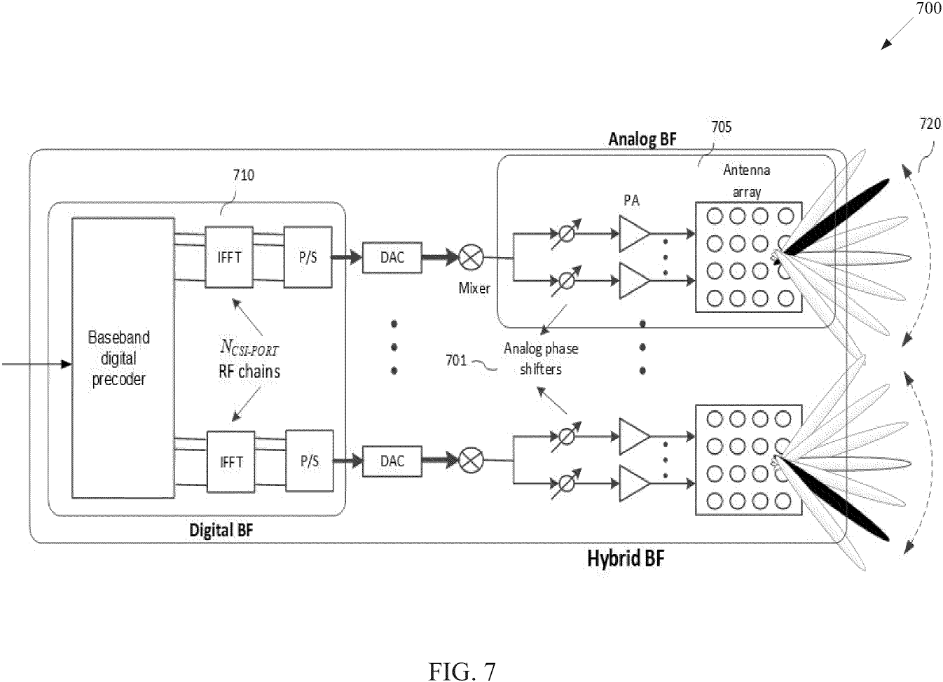

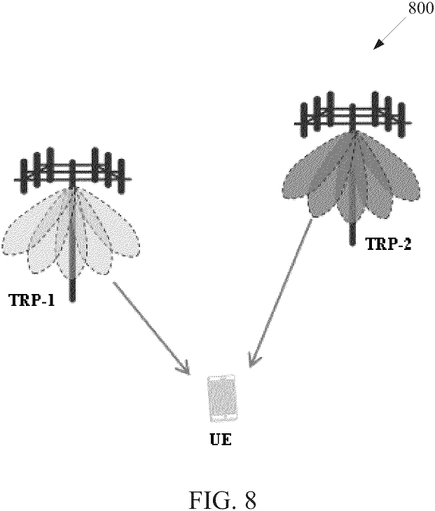

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports -which can correspond to the number of digitally precoded ports - tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration - to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss @100 m distance), larger number of and sharper analog beams (hence larger number of radiators in the array) may be needed to compensate for the additional path loss.

FIG. 8 illustrates an example of multiple transmission and reception point system 800 according to embodiments of the present disclosure. An embodiment of the multiple transmission and reception point system 800 shown in FIG. 8 is for illustration only.

In a multiple transmission and reception point (TRP) system depicted in FIG. 8, the UE could simultaneously receive from multiple physically non-co-located TRPs various channels/RSs such as PDCCHs and/or PDSCHs using either a single receive (RX) panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) A plurality of CORESETs associated with a TRP-specific index/indicator/identity.

A cell/TRP in an inter-cell system (e.g., an inter-cell multi-TRP system) could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, in an inter-cell system, different cells/TRPs could broadcast different PCIs, and/or one or more cells/TRPs (referred to/defined as non-serving cells/TRPs in the present disclosure) could broadcast different PCIs from that of the serving cell/TRP (i.e., the serving cell PCI), and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI).

In Rel. 17, a unified transmission configuration indication (TCI) framework is specified for single-TRP operation, wherein a common beam could be indicated for all UE-dedicated control and/or data channels. To extend the Rel. 17 unified TCI framework to the multi-TRP operation, various design aspects such as means of configurating one or more TCI fields or TCI state codepoints in a downlink control information (DCI) format (e.g., DCI format 1_1 or 1_2 with or without DL assignment) to indicate beams for multiple TRPs need to be specified.

The present disclosure provides various design aspects related to DCI based beam indication for multi-TRP operation. In particular, detailed configuration methods of TCI states, TCI fields or TCI state codepoints in DCI format 1_1 or 1_2 with or without DL assignment, and their association with different TRPs in a multi-TRP system, are specified/provided in the present disclosure. This disclosure further specifies various methods to update one or more of the indicated TCI states for the multi-TRP operation.

As described in the U.S. Pat. Application 17/584,239, which is incorporate by reference into the present disclosure, a unified TCI framework could indicate/include N≥1 DL TCI states and/or M≥1 UL TCI states, wherein the indicated TCI state could be at least one of: (1) A DL TCI state and/or its corresponding/associated TCI state ID; (2) an UL TCI state and/or its corresponding/associated TCI state ID; (3) a joint DL and UL TCI state and/or its corresponding/associated TCI state ID; and (4) Separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. In the U.S. Pat. Application 17/584,239, which is incorporate by reference into the present disclosure, following examples are provided.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH. For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment. For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant. Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; or (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed above, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

The UE could be higher layer configured by the network M>1 or N>1 pools of TCI states or TCI state identities (IDs). As aforementioned, here, a TCI state could correspond to a separate DL TCI state provided by DLorJointTCIState, or a separate UL TCI state provided by UL-TCIState, or a joint DL and UL TCI state provided by DLorJointTCIState. Each of the higher layer configured M>1 or N>1 pools of TCI states/TCI state IDs could be associated with an entity ID. In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first pool of TCI states/TCI state IDs could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second pool of TCI states/TCI state IDs could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last pool of TCI states/TCI state IDs could be associated with the highest PCI value or the last PCI value in the higher layer configured list of PCIs or the highest PCI index or the last PCI index in the set of PCI indexes or the PCI index pointing to the highest PCI value in the higher layer configured list of PCIs. Or equivalently, the m-th (or n-th) pool of TCI states/TCI state IDs could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1,..., M} and n∈{1,..., N}.

For M=2 (or N=2), the first (or second) pool of TCI states/TCI state IDs could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) pool of TCI states/TCI state IDs could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) pool of TCI states/TCI state IDs could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, each of the M>1 (or N>1) pools of TCI states/TCI state IDs could be configured to the UE via a separate higher layer parameter. That is, the UE could be configured by the network M>1 (or N>1) separate higher layer parameters each configuring/indicating a pool of TCI states/TCI state IDs. Furthermore, the higher layer parameter that configures a pool of TCI states/TCI state IDs could also include/indicate an entity ID as described above. For this case, a pool TCI states/TCI state IDs and an entity ID are associated if the pool of TCI states/TCI state IDs and the entity ID are configured/indicated via the same higher layer parameter.

In addition, when the UE is higher layer configured by the network M>1 or N>1 pools of TCI states or TCI state IDs, where each TCI state configured therein corresponds to a separate DL TCI state provided by DLorJointTCIState, or a separate UL TCI state provided by UL-TCIState, or a joint DL and UL TCI state provided by DLorJointTCIState, following examples can be provided.

In one example, for the m-th (or n-th) pool of TCI states/TCI state IDs comprising K(m) (or K(n)) TCI states/TCI state IDs where m∈{1,..., M} and n∈{1,..., N}, the TCI state IDs in the m-th (or n-th) pool of TCI states/TCI state IDs or the TCI states in the m-th (or n-th) pool of TCI states/TCI state IDs are indexed according to 0, ..., K(m) - 1 (or K(n) - 1) or 1, ..., K(m) (or K(n)). For example, for M=2 (or N=2), the first pool of TCI states/TCI state IDs could comprise K1 (e.g., 64) TCI states/TCI state IDs, and the second pool of TCI states/TCI state IDs could comprise K2 (e.g., 64) TCI states/TCI state IDs. For this example, the TCI state IDs in the first pool of TCI states/TCI state IDs or the TCI states in the first pool of TCI states/TCI state IDs could be indexed according to 0, ..., K1 - 1 (e.g., 0, ..., 63) or 1, ..., K1 (e.g., 1, ..., 64), and the TCI state IDs in the second pool of TCI states/TCI state IDs or the TCI states in the second pool of TCI states/TCI state IDs could be indexed according to 0, ..., K2 - 1 (e.g., 0, ..., 63) or 1, ..., K2 (e.g., 1, ..., 64).

In another example, the m-th (or n-th) pool of TCI states/TCI state IDs could comprise K(m) (or K(n)) TCI states/TCI state IDs where m∈{1,..., M} and n∈{1,..., N}. For this case, the TCI state IDs in the m-th (or n-th) pool of TCI states/TCI state IDs or the TCI states in the m-th (or n-th) pool of TCI states/TCI state IDs are indexed according to

$${\sum }_{i = 1}^{m - 1} K \left(i\right) \left(\text{or} {\sum }_{j = 1}^{n - 1} K \left(j\right)\right) , ... ,$$

$$\sum {}_{i = 1}^{m - 1} K \left(i\right) + K \left(m\right) - 1 \left(o r \sum {}_{j = 1}^{n - 1} K \left(j\right) + K \left(n\right) - 1\right)$$

or

$$\sum {}_{i = 1}^{m - 1} K \left(i\right) + 1 \left(o r \sum {}_{j = 1}^{n - 1} K \left(j\right) + 1\right) , ... ,$$

$$\sum {}_{i = 1}^{m - 1} K \left(i\right) + K \left(m\right) \left(o r \sum {}_{j = 1}^{n - 1} K \left(j\right) + K \left(n\right)\right) ,$$

where

$${\sum }_{i = 1}^{0} K \left(i\right) = 0 \left(\text{or} {\sum }_{j = 1}^{n - 1} K \left(j\right) = 0\right) .$$

For example, for M=2 (or N=2), the first pool of TCI states/TCI state IDs could comprise K1 (e.g., 64) TCIstates/TCI state IDs, and the second pool of TCI states/TCI state IDs could comprise K2 (e.g., 64) TCI states/TCI state IDs.

For this example, the TCI state IDs in the first pool of TCI states/TCI state IDs or the TCI states in the first pool of TCI states/TCI state IDs could be indexed according to 0, ..., K1 -1 (e.g., 0, ..., 63) or 1, ..., K1 (e.g., 1, ..., 64), and the TCI state IDs in the second pool of TCI states/TCI state IDs or the TCI states in the second pool of TCI states/TCI state IDs could be indexed according to K1, ..., K1 + K2 - 1 (e.g., 64, ..., 127) or K1 + 1, ..., K1 + K2 (e.g., 65, ..., 128).

Alternatively, the UE could be higher layer configured by the network a single pool of TCI states or TCI state IDs. As aforementioned, here, a TCI state could correspond to a separate DL TCI state provided by DLorJointTCIState, or a separate UL TCI state provided by UL-TCIState, or a joint DL and UL TCI state provided by DLorJointTCIState. A TCI state or TCI state ID configured in the pool of TCI states/TCI state IDs could be associated with an entity ID. In the present disclosure, the entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. Furthermore, one or more of the TCI states or TCI state IDs configured in the pool of TCI states/TCI state IDs could be associated with the same entity ID, and different TCI states or TCI state IDs configured in the pool of TCI states/TCI state IDs could be associated with different entity IDs. In the present disclosure, the TCI states or TCI state IDs in the pool of TCI states/TCI state IDs could be divided/partitioned into M>1 (or N>1) TCI state groups each comprising one or more TCI states/TCI state IDs. The TCI states or TCI state IDs in the same TCI state group are associated with the same entity ID.

In one example, the m-th (or n-th) TCI state group could comprise K(m) (or K(n)) TCI states/TCI state IDs where m∈{1,...,M} and n∈{1,...N}. For this case, the TCI state IDs in the m-th (or n-th) TCI state group or the TCI states in the m-th (or n-th) TCI state group are indexed according to

$${\sum }_{i = 1}^{m - 1} K \left(i\right) \left(\text{or} {\sum }_{j = 1}^{n - 1} K \left(j\right)\right) , … ,$$

$${\sum }_{i = 1}^{m - 1} K \left(i\right) \text{+K} \left(\text{m}\right) - 1 \left(\text{or} {\sum }_{j = 1}^{n - 1} K \left(j\right) \text{+K} \left(\text{n}\right) - 1\right)$$

or

$$\sum {}_{i = 1}^{m - 1} K \left(i\right) + 1 \left(o r \sum {}_{j = 1}^{n - 1} K \left(j\right) + 1\right) , ... ,$$

$$\sum {}_{i = 1}^{m - 1} K \left(i\right) + K \left(m\right) \left(o r \sum {}_{j = 1}^{n - 1} K \left(j\right) + K \left(n\right)\right) ,$$

where

$$\sum {}_{i = 1}^{0} K \left(i\right) = 0 \left(o r {\sum }_{j = 1}^{n - 1} K \left(j\right) = 0\right) .$$

For example, for M=2 (or N=2), the first TCI state group could comprise K1 (e.g., 32) TCI states/TCI state IDs in the pool of TCI states/TCI state IDs, and the second TCI state group could comprise K2 (e.g., 32) TCI states/TCI state IDs in the pool of TCI states/TCI stateIDs. For this example, the TCI state IDs in the first TCI state group or the TCI states in the first TCI state group could be indexed according to 0, ..., K1 - 1 (e.g., 0, ..., 31) or 1, ..., K1 (e.g., 1, ..., 32), and the TCI state IDs in the second TCI state group or the TCI states in the second TCI state group could be indexed according to K1, ..., K1 + K2 - 1 (e.g., 32, ..., 63) or K1 + 1, ..., K1 + K2 (e.g., 33, ..., 65). For this example, the UE could be configured by the network, e.g., via higher layer RRC signaling, the number of TCI states/TCI state IDs (e.g., K(m) or K(n) with m∈{1,..., M} and n∈{1,..., N}) in each of the TCI state groups (e.g., the m-th or the n-th TCI state group with m∈{1,..., M} and n∈{1,..., N}) configured in the pool of TCI states/TCI state IDs.

In another example, the UE could be configured by the network M>1 (or N>1) parameters (e.g., higher layer RRC parameters) each associated with/corresponding to/configured for a TCI state group. Each parameter could include/indicate one or more TCI states/TCI state IDs. For this case, the TCI state group associated with the parameter could comprise the one or more TCI states/TCI state IDs configured in the parameter.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, the first TCI state group could be associated with the lowest PCI value or the first PCI value in the higher layer configured list of PCIs or the lowest PCI index or the first PCI index in the set of PCI indexes or the PCI index pointing to the lowest PCI value in the higher layer configured list of PCIs, the second TCI state group could be associated with the second lowest PCI value or the second PCI value in the higher layer configured list of PCIs or the second lowest PCI index or the second PCI index in the set of PCI indexes or the PCI index pointing to the second lowest PCI value in the higher layer configured list of PCIs, and so on, and the last TCI state group could be associated with the highest PCI value or the last PCI value in the higher layer configured list of PCIs or the highest PCI index or the last PCI index in the set of PCI indexes or the PCI index pointing to the highest PCI value in the higher layer configured list of PCIs. Or equivalently, the m-th (or n-th) TCI state group could be associated with the m-th (or n-th) lowest (or highest) PCI value or the m-th (or n-th) PCI value in the higher layer configured list of PCIs or the m-th (or n-th) lowest (or highest) PCI index or the first PCI index in the set of PCI indexes or the PCI index pointing to the m-th (or n-th) lowest (or highest) PCI value in the higher layer configured list of PCIs, where m∈{1,..., M} and n∈{1,..., N}.

For M=2 (or N=2), the first (or second) TCI state group could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, if the UE is provided in PDCCH-Config two values of CORESETPoolIndex (i.e., 0 and 1), for M=2 (or N=2), the first (or second) TCI state group could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state group could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, the (higher layer) parameter discussed in example that indicates one or more TCI states/TCI state IDs for a TCI state group could also include/indicate an entity ID as described above. For this case, a TCI state group and an entity ID are associated if the TCI state group and the entity ID are associated with the same (higher layer) parameter specified in examples in the present disclosure.

The UE could receive from the network one or more MAC CE subselection/activation commands activating one or more TCI states/TCI state IDs from the one or more TCI state pools (specified in examples in the present disclosure) or the one or more TCI state groups (specified in examples in the present disclosure), used to map up to Nc≥1 (e.g., 8, 16, 32 or 64) TCI state codepoints in a DCI format.

In one example, the UE could receive from the network a MAC CE subselection/activation command activating a set of Nc ≥ 1 (e.g., 8, 16, 32 or 64) TCI state codepoints. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, a codepoint could correspond to a TCI state, wherein the TCI state could be a separate DL TCI state provided by DLorJointTCIState, a separate UL TCI state provided by UL-TCIState or a joint DL and UL TCI state provided by DLorJointTCIState.

Yet for another example, a codepoint could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState, or a joint DL and UL TCI state provided by DLorJointTCIState, and the second TCI state could be a separate DL TCI state provided by DLorJointTCIState, a separate UL TCI state provided by UL-TCIState, or a joint DL and UL TCI state provided by DLorJointTCIState. Furthermore, the first TCI state could be activated/selected by the MAC CE from the first (or second) TCI state pool (specified in examples in the present disclosure) or the first (or second) TCI state group (specified in examples in the present disclosure), and the second TCI state could be activated/selected by the MAC CE from the second (or first) TCI state pool (specified in examples in the present disclosure) or the second (or first) TCI state group (specified examples in the present disclosure).

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState, or a joint DL and UL TCI state provided by DLorJointTCIState, and the second TCI state could be a separate DL TCI state provided by DLorJointTCIState, a separate UL TCI state provided by UL-TCIState, or a joint DL and UL TCI state provided by DLorJointTCIState. Furthermore, the first (or second) TCI state could be associated with the entity ID associated with the serving cell PCI/PCI index or the lowest entity ID or the first entity ID in the higher layer configured list of entity IDs, and the second (or first) TCI state could be associated with the entity ID associated with a PCI/PCI index other than the serving cell PCI/PCI index or the highest entity ID value or the last entity ID value in the higher layer configured list of entity IDs.

Alternatively, the first (or second) TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to a first TCI state and a second TCI state. For this case, the first TCI state could be a separate DL TCI state provided by DLorJointTCIState, a separate UL TCI state provided by UL-TCIState, or a joint DL and UL TCI state provided by DLorJointTCIState, and the second TCI state could be a separate DL TCI state provided by DLorJointTCIState, a separate UL TCI state provided by UL-TCIState, or a joint DL and UL TCI state provided by DLorJointTCIState.

Furthermore, if the UE is provided in PDCCH-Config two values of CORESETPoolIndex (i.e., 0 and 1), the first (or second) TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState, or a joint DL and UL TCI state provided by DLorJointTCIState, and the second TCI state in the first pair could be a separate DL TCI state provided by DLorJointTCIState, a separate UL TCI state provided by UL-TCIState, or a joint DL and UL TCI state provided by DLorJointTCIState.

For instance, one TCI state in the first pair could be for DL channels/signals, and the other TCI state in the first pair could be for UL channels/signals. Similarly, the first TCI state in the second pair could be a separate DL TCI state provided by DLorJointTCIState, a separate UL TCI state provided by UL-TCIState, or a joint DL and UL TCI state provided by DLorJointTCIState, and the second TCI state in the second pair could be a separate DL TCI state provided by DLorJointTCIState, a separate UL TCI state provided by UL-TCIState, or a joint DL and UL TCI state provided by DLorJointTCIState.

For instance, one TCI state in the second pair could be for DL channels/signals, and the other TCI state in the second pair could be for UL channels/signals. Furthermore, the first and second TCI states in the first pair could be activated/selected by the MAC CE from the first (or second) TCI state pool (specified in examples in the present disclosure ) or the first (or second) TCI state group (specified in examples in the present disclosure), and the first and second TCI states in the second pair could be activated/selected by the MAC CE from the second (or first) TCI state pool (specified in examples in the present disclosure) or the second (or first) TCI state group (specified in examples in the present disclosure).

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState, or a joint DL and UL TCI state provided by DLorJointTCIState, and the second TCI state in the first pair could be a separate DL TCI state provided by DLorJointTCIState, a separate UL TCI state provided by UL-TCIState, or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState, or a joint DL and UL TCI state provided by DLorJointTCIState, and the second TCI state in the second pair could be a separate DL TCI state provided by DLorJointTCIState, a separate UL TCI state provided by UL-TCIState, or a joint DL and UL TCI state provided by DLorJointTCIState. For instance, one TCI state in the second pair could be for DL channels/signals, and the other TCI state in the second pair could be for UL channels/signals.

Furthermore, the first and second TCI states in the first (or second) pair could be associated with the entity ID associated with the serving cell PCI/PCI index or the lowest entity ID value or the first entity ID value in the higher layer configured list of entity IDs, and the first and second TCI states in the second (or first) pair could be associated with the entity ID associated with a PCI/PCI index other than the serving cell PCI/PCI index or the highest entity ID value or the last entity ID value in the higher layer configured list of entity IDs. Alternatively, the first and second TCI states in the first (or second) pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint could correspond to two pairs of TCI states with each pair comprising two TCI states. The first TCI state in the first pair could be a separate DL TCI state provided by DLorJointTCIState, a separate UL TCI state provided by UL-TCIState, or a joint DL and UL TCI state provided by DLorJointTCIState, and the second TCI state in the first pair could be a separate DL TCI state provided by DLorJointTCIState, a separate UL TCI state provided by UL-TCIState, or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState, or a joint DL and UL TCI state provided by DLorJointTCIState, and the second TCI state in the second pair could be a separate DL TCI state provided by DLorJointTCIState, a separate UL TCI state provided by UL-TCIState, or a joint DL and UL TCI state provided by DLorJointTCIState. For instance, one TCI state in the second pair could be for DL channels/signals, and the other TCI state in the second pair could be for UL channels/signals.

Furthermore, if the UE is provided in PDCCH-Config two values of CORESETPoolIndex (i.e., 0 and 1), the first and second TCI states in the first (or second) pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In another example, for M=2 (or N=2), a codepoint could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState. Furthermore, the first TCI state could be activated/selected by the MAC CE from the first (or second) TCI state pool (specified in the examples of the present disclosure or the first (or second) TCI state group (specified in the examples of the present disclosure.

In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals. Furthermore, the first and second TCI states in the first pair could be activated/selected by the MAC CE from the first (or second) TCI state pool (specified in the examples of the present disclosure) or the first (or second) TCI state group (specified in the examples of the present disclosure).

In yet another example, for M=2 (or N=2), a codepoint could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState. Furthermore, the first TCI state could be associated with the entity ID associated with the serving cell PCI/PCI index or the lowest entity ID or the first entity ID in the higher layer configured list of entity IDs or the entity ID associated with a PCI/PCI index other than the serving cell PCI/PCI index or the highest entity ID value or the last entity ID value in the higher layer configured list of entity IDs.

Alternatively, the first TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals. Furthermore, the first and second TCI states in the first pair could be associated with the entity ID associated with the serving cell PCI/PCI index or the lowest entity ID value or the first entity ID value in the higher layer configured list of entity IDs or the entity ID associated with a PCI/PCI index other than the serving cell PCI/PCI index or the highest entity ID value or the last entity ID value in the higher layer configured list of entity IDs.

Alternatively, the first and second TCI states in the first pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In yet another example, for M=2 (or N=2), a codepoint could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState. Furthermore, if the UE is provided in PDCCH-Config two values of CORESETPoolIndex (i.e., 0 and 1), the first TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Furthermore, if the UE is provided in PDCCH-Config two values of CORESETPoolIndex (i.e., 0 and 1), the first and second TCI states in the first pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

As discussed in the present disclosure, one or more of the Nc≥1 (e.g., 8, 16, 32 or 64) TCI state codepoints activated by the MAC CE could correspond to the TCI state codepoints described in the examples of the present disclosure. Furthermore, a “transmission configuration indication” field in DCI format 1_1 or 1_2 with or without DL assignment could indicate a TCI state codepoint from the Nc≥1 (e.g., 8, 16, 32 or 64) activated TCI state codepoints determined according to the the examples of the present disclosure.

Alternatively, DCI format 1_1 with or without DL assignment or DCI format 1_2 with or without DL assignment could indicate/include a first “transmission configuration indication” field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “transmission configuration indication” field in the DCI format 1_1 or 1_2 (with or without DL assignment). When the two TCI fields are configured in the DCI format 1_1 or 1_2 with or without DL assignment for beam indication, the first or the second TCI state codepoints could be from the Nc≥1 (e.g., 8, 16, 32 or 64) activated TCI state codepoints determined according to the examples in the present disclosure.

Optionally, the UE could receive from the network an auxiliary MAC CE subselection/activation command selecting/activating one or more (Nc′≥1, e.g., Nc′=8, 16, 32 or 64) TCI state codepoints from the set of Nc activated TCI state codepoints as a subset of Nc′ TCI state codepoints, wherein the number/value of Nc′ could be (1) fixed, e.g., in the system specifications or (2) provided by the network via higher layer RRC signaling and/or MAC CE command and/or dynamic DCI based signaling. For this case, the “transmission configuration indication” field in DCI format 1_1 or 1_2 with or without DL assignment could indicate a TCI state codepoint from the subset of Nc′≥1 (e.g., 8, 16, 32 or 64) TCI state codepoints, or the first or the second TCI state codepoints indicated by the first or the second TCI fields (if configured) in DCI format 1_1 or 1_2 with or without DL assignment could correspond to a TCI state codepoint from the subset of Nc′≥1 (e.g., 8, 16, 32 or 64) TCI state codepoints.

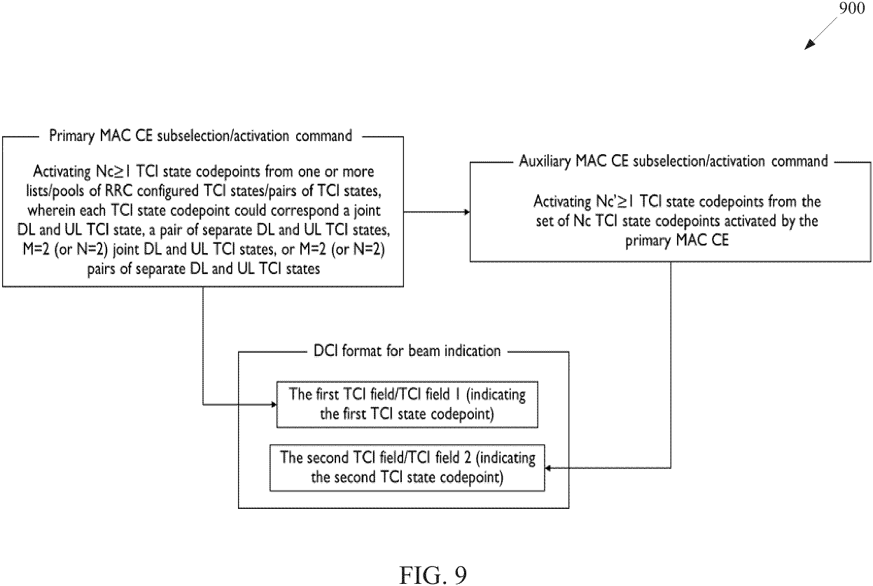

FIG. 9 illustrates an example of MAC CE command to activate TCI states 900 according to embodiments of the present disclosure. An embodiment of the MAC CE command to activate TCI states 900 shown in FIG. 9 is for illustration only.

A conceptual example of applying the auxiliary MAC CE command to activate one or more TCI states/pairs of TCI states for a TCI field is presented in FIG. 9. As illustrated in FIG. 9, a UE could first receive from the network a primary MAC CE subselection/activation command activating Nc ≥ 1 TCI state codepoints from the higher layer RRC configured list(s)/pool(s) of TCI states/pairs of TCI states. The first TCI field/TCI field 1 in a DCI format for beam indication could indicate the first TCI state codepoint selected from the set of Nc TCI state codepoints provided by the primary MAC CE command. The UE could also receive an auxiliary MAC CE subselection/activation command activating Nc′ ≥ 1 TCI state codepoints from the set of Nc TCI state codepoints provided by the primary MAC CE command. The second TCI field/TCI field 2 in the same DCI format for beam indication could indicate the second TCI state codepoint selected from the set of Nc′ TCI state codepoints provided by the auxiliary MAC CE command.

Furthermore, in the present disclosure, the UE could be indicated by the network, e.g., via higher layer RRC signaling and/or MAC CE command and/or dynamic DCI based signaling, whether a single TCI field (e.g., the existing “transmission configuration indication” field) is configured in the DCI (e.g., DCI format 1_1 or 1_2 with or without downlink assignment) to indicate the M=2 (or N=2) TCI states/pairs of TCI states or two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions.

Additionally, if DCI format 1_1 or 1_2 for beam indication is with DL assignment or the number of TCI state codepoints Nc to be activated by MAC CE is smaller than a threshold, the TCI state codepoint indicated in the “transmission configuration indication” field could only correspond to/indicate a single TCI state or a single pair of TCI states (e.g., the TCI state codepoint specified in the examples of the present disclosure) for single-TRP operation. If two TCI fields are allowed to be configured in a DCI format for beam indication, and if DCI format 1_1 or 1_2 for beam indication is with DL assignment or the number of TCI state codepoints Nc to be activated by MAC CE is smaller than a threshold, only one TCI field (e.g., either TCI field 1 or TCI field 2) can be configured in the DCI format, and the TCI state codepoint (e.g., either the first TCI state codepoint or the second TCI state codepoint) indicated in the corresponding TCI field could only correspond to/indicate a single TCI state or a single pair of TCI states (e.g., the TCI state codepoint specified in the examples of the present disclosure) for single-TRP operation. If DCI format 1_1 or 1_2 for beam indication is with DL assignment or the number of TCI state codepoints Nc to be activated by MAC CE is smaller than a threshold, each of the MAC CE activated TCI state codepoints could only correspond to/indicate a single TCI state or a single pair of TCI states (e.g., the TCI state codepoint specified in the examples of the present disclosure) for single-TRP operation. In the present disclosure, the threshold could be (1) fixed, e.g., 8, 16, 32 or 64, or (2) configured by the network via higher layer RRC signaling or/and MAC CE command or/and DCI based signaling.

In one example, for M=2 (or N=2), the UE could receive from the network a MAC CE subselection/activation command activating two sets of TCI state codepoints. For this case, the first set could contain Nc1≥1 (e.g., 8, 16, 32 or 64) TCI state codepoints, and the second set could contain Nc2≥1 (e.g., 8, 16, 32 or 64) TCI state codepoints. Alternatively, the UE could receive from the network a first MAC CE subselection/activation command activating a first set of Nc1≥ 1 (e.g., 8, 16, 32 or 64) TCI state codepoints, and a second MAC CE subselection/activation command activating a second set of Nc2≥1 (e.g., 8, 16, 32 or 64) TCI state codepoints. In the present disclosure, the number/value of Nc1 or Nc2 could be (1) fixed, e.g., in the system specifications or (2) provided by the network via higher layer RRC signaling and/or MAC CE command and/or dynamic DCI based signaling.

For example, a codepoint in the first set of codepoints or the second set of codepoints could correspond to a TCI state, wherein the TCI state could be a separate DL TCI state provided by DLorJointTCIState, a separate UL TCI state provided by UL-TCIState or a joint DL and UL TCI state provided by DLorJointTCIState.

For another example, a codepoint in the first set of codepoints or the second set of codepoints could correspond to a pair of two TCI states, wherein the first TCI state in the pair could be a separate DL TCI state provided by DLorJointTCIState, a separate UL TCI state provided by UL-TCIState or a joint DL and UL TCI state provided by DLorJointTCIState, and the second TCI state in the pair could be a separate DL TCI state provided by DLorJointTCIState, a separate UL TCI state provided by UL-TCIState or a joint DL and UL TCI state provided by DLorJointTCIState. For instance, one TCI state in the pair could be for DL channels/signals, and the other TCI state in the pair could be for UL channels/signals.

Yet for another example, for M=2 (or N=2), a codepoint in the first (or second) set of codepoints could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState. Furthermore, the first TCI state could be activated/selected by the corresponding MAC CE from the first (or second) TCI state pool (specified in the examples of the present disclosure) or the first (or second) TCI state group (specified in the examples of the present disclosure), and the second TCI state could be activated/selected by the corresponding MAC CE from the second (or first) TCI state pool (specified in the examples of the present disclosure) or the second (or first) TCI state group (specified in the examples of the present disclosure).

Yet for another example, for M=2 (or N=2), a codepoint in the first (or second) set of codepoints could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, the first (or second) TCI state could be associated with the entity ID associated with the serving cell PCI/PCI index or the lowest entity ID or the first entity ID in the higher layer configured list of entity IDs, and the second (or first) TCI state could be associated with the entity ID associated with a PCI/PCI index other than the serving cell PCI/PCI index or the highest entity ID value or the last entity ID value in the higher layer configured list of entity IDs.

Alternatively, the first (or second) TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint in the first (or second) set of codepoints could correspond to a first TCI state and a second TCI state. For this case, the first TCI state could be a separate DL TCI state provided by DLorJointTCIState, a separate UL TCI state provided by UL-TCIState or a joint DL and UL TCI state provided by DLorJointTCIState, and the second TCI state could be a separate DL TCI state provided by DLorJointTCIState, a separate UL TCI state provided by UL-TCIState or a joint DL and UL TCI state provided by DLorJointTCIState.

Furthermore, if the UE is provided in PDCCH-Config two values of CORESETPoolIndex (i.e., 0 and 1), the first (or second) TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint in the first (or second) set of codepoints could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals. Furthermore, the first and second TCI states in the first pair could be activated/selected by the corresponding MAC CE from the first (or second) TCI state pool (specified in the examples of the present disclosure) or the first (or second) TCI state group (specified in the examples of the present disclosure), and the first and second TCI states in the second pair could be activated/selected by the corresponding MAC CE from the second (or first) TCI state pool (specified in the examples of the present disclosure ) or the second (or first) TCI state group (specified in the examples of the present disclosure).

Yet for another example, for M=2 (or N=2), a codepoint in the first (or second) set of codepoints could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, the first and second TCI states in the first (or second) pair could be associated with the entity ID associated with the serving cell PCI/PCI index or the lowest entity ID value or the first entity ID value in the higher layer configured list of entity IDs, and the first and second TCI states in the second (or first) pair could be associated with the entity ID associated with a PCI/PCI index other than the serving cell PCI/PCI index or the highest entity ID value or the last entity ID value in the higher layer configured list of entity IDs.

Alternatively, the first and second TCI states in the first (or second) pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint in the first (or second) set of codepoints could correspond to two pairs of TCI states with each pair comprising two TCI states. The first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals. Similarly, the first TCI state in the second pair could be a separate DL TCI state provided by DLorJointTCIState, a separate UL TCI state provided by UL-TCIState or a joint DL and UL TCI state provided by DLorJointTCIState, and the second TCI state in the second pair could be a separate DL TCI state provided by DLorJointTCIState, a separate UL TCI state provided by UL-TCIState or a joint DL and UL TCI state provided by DLorJointTCIState. For instance, one TCI state in the second pair could be for DL channels/signals, and the other TCI state in the second pair could be for UL channels/signals.

Furthermore, if the UE is provided in PDCCH-Config two values of CORESETPoolIndex (i.e., 0 and 1), the first and second TCI states in the first (or second) pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the first and second TCI states in the second (or first) pair could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint in the first (or second) set of codepoints could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState. Furthermore, the first TCI state could be activated/selected by the MAC CE from the first (or second) TCI state pool (specified in the examples of the present disclosure) or the first (or second) TCI state group (specified in the examples of the present disclosure).

In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals. Furthermore, the first and second TCI states in the first pair could be activated/selected by the MAC CE from the first (or second) TCI state pool (specified in the examples of the present disclosure) or the first (or second) TCI state group (specified in the examples of the present disclosure).

Yet for another example, for M=2 (or N=2), a codepoint in the first (or second) set of codepoints could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState.

Furthermore, the first TCI state could be associated with the entity ID associated with the serving cell PCI/PCI index or the lowest entity ID or the first entity ID in the higher layer configured list of entity IDs or the entity ID associated with a PCI/PCI index other than the serving cell PCI/PCI index or the highest entity ID value or the last entity ID value in the higher layer configured list of entity IDs.

Alternatively, the first TCI state could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs. In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState.

For instance, one TCI state in the first pair could be for DL channels/signals, and the other TCI state in the first pair could be for UL channels/signals. Furthermore, the first and second TCI states in the first pair could be associated with the entity ID associated with the serving cell PCI/PCI index or the lowest entity ID value or the first entity ID value in the higher layer configured list of entity IDs or the entity ID associated with a PCI/PCI index other than the serving cell PCI/PCI index or the highest entity ID value or the last entity ID value in the higher layer configured list of entity IDs.

Alternatively, the first and second TCI states in the first pair could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, for M=2 (or N=2), a codepoint in the first (or second) set of codepoints could correspond to a first TCI state and a first pair of TCI states comprising two TCI states. For this case, the first TCI state could be a separate DL TCI state provided by DLorJointTCIState, a separate UL TCI state provided by UL-TCIState or a joint DL and UL TCI state provided by DLorJointTCIState. Furthermore, if the UE is provided in PDCCH-Config two values of CORESETPoolIndex (i.e., 0 and 1), the first TCI state could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In addition, the first TCI state in the first pair could be a separate DL TCI state provided by DLorJointTCIState, a separate UL TCI state provided by UL-TCIState or a joint DL and UL TCI state provided by DLorJointTCIState, and the second TCI state in the first pair could be a separate DL TCI state provided by DLorJointTCIState, a separate UL TCI state provided by UL-TCIState or a joint DL and UL TCI state provided by DLorJointTCIState. For instance, one TCI state in the first pair could be for DL channels/signals, and the other TCI state in the first pair could be for UL channels/signals.

Furthermore, if the UE is provided in PDCCH-Config two values of CORESETPoolIndex (i.e., 0 and 1), the first and second TCI states in the first pair could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs or value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI states indicated by the first set of TCI state codepoints could be activated/selected by the MAC CE from the first (or second) TCI state pool (specified in the examples of the present disclosure) or the first (or second) TCI state group (specified in the examples of the present disclosure), and the TCI states indicated by the second set of TCI state codepoints could be activated/selected by the MAC CE from the second (or first) TCI state pool (specified in the examples of the present disclosure) or the second (or first) TCI state group (specified in the examples of the present disclosure).

For another example, the TCI states indicated by the first (or second) set of TCI state codepoints could be associated with the entity ID associated with the serving cell PCI/PCI index or the lowest entity ID value or the first entity ID value in the higher layer configured list of entity IDs, and the TCI states indicated by the second (or first) set of TCI state codepoints could be associated with the entity ID associated with a PCI/PCI index other than the serving cell PCI/PCI index or the highest entity ID value or the last entity ID value in the higher layer configured list of entity IDs.

Alternatively, the TCI states indicated by the first (or second) set of TCI state codepoints could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the TCI states indicated by the first (or second) set of TCI state codepoints could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the TCI states indicated by the second (or first) set of TCI state codepoints could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, the first MAC CE subselection/activation command could include/indicate a first entity ID, and the second MAC CE subselection/activation command could include/indicate a second entity ID. In the present disclosure, the first entity ID or the second entity ID could correspond to at least one of: a PCI value, a PCI index pointing to an entry/PCI in a list of PCI that are higher layer configured to the UE, a value of CORESETPoolIndex, a value of CORESETGroupIndex, a TRP ID, a TRP-specific higher layer signaling index, a CORESET ID, a resource ID/index, a resource set ID/index and etc. For this case, the TCI states indicated by the first set of TCI state codepoints activated/selected by the first MAC CE subselection/activation command could be associated with the first entity ID, and the TCI states indicated by the second set of TCI state codepoints activated/selected by the second MAC CE subselection/activation command could be associated with the second entity ID.

For DCI based beam indication, DCI format 1_1 with or without DL assignment or DCI format 1_2 with or without DL assignment could indicate/include a first “transmission configuration indication” field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein.

In another example, the first TCI field or the second TCI field could correspond to the existing “transmission configuration indication” field in the DCI format 1_1 or 1_2 (with or without DL assignment). In yet another example, the first TCI field or the second TCI field could be configured by repurposing one or more of the existing DCI fields in the DCI format 1_1 or 1_2 (with or without DL assignment). In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, the TCI state(s) indicated by the first TCI state codepoint/the first TCI field could be activated/selected by the MAC CE from the first (or second) TCI state pool (specified in the examples of the present disclosure) or the first (or second) TCI state group (specified in the examples of the present disclosure), and the TCI state(s) indicated by the second TCI state codepoint/the second TCI field could be activated/selected by the MAC CE from the second (or first) TCI state pool (specified in the examples of the present disclosure) or the second (or first) TCI state group (specified in the examples of the present disclosure).

For another example, the first (or second) TCI state codepoint/the first (or second) TCI field could be associated with the entity ID associated with the serving cell PCI/PCI index or the lowest entity ID value or the first entity ID value in the higher layer configured list of entity IDs, and the second (or first) TCI state codepoint/the second (or first) TCI field could be associated with the entity ID associated with a PCI/PCI index other than the serving cell PCI/PCI index or the highest entity ID value or the last entity ID value in the higher layer configured list of entity IDs.

Alternatively, the first (or second) TCI state codepoint/the first (or second) TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1), the first (or second) TCI state codepoint/the first (or second) TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and the second (or first) TCI state codepoint/the second (or first) TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In one example, the first TCI field could indicate the first TCI state codepoint from the first set of TCI state codepoints, and the second TCI field could indicate the second TCI state codepoint from the second set of TCI state codepoints.

In another example, the first TCI field could indicate the first TCI state codepoint from the second set of TCI state codepoints, and the second TCI field could indicate the second TCI state codepoint from the first set of TCI state codepoints.

In yet another example, the UE could receive a first one-bit flag for the first TCI field with “0” indicating that the first TCI state codepoint is indicated from the first (or second) set of TCI state codepoints and “1” indicating that the first TCI state codepoint is indicated from the second (or first) set of TCI state codepoints; furthermore, the UE could receive a second one-bit flag for the second TCI field with “0” indicating that the second TCI state codepoint is indicated from the first (or second) set of TCI state codepoints and “1” indicating that the second TCI state codepoint is indicated from the second (or first) set of TCI state codepoints. The UE could be configured by the network via higher layer RRC signaling or MAC CE command or DCI based signaling the first or second one-bit flag indicators.

If DCI format 1_1 or 1_2 for beam indication is with DL assignment or the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the DCI format 1_1 or 1_2 could only indicate a single TCI field (e.g., either the first or the second TCI field), and the TCI state codepoint (e.g., either the first or the second TCI state codepoint) indicated in the TCI field could only correspond to/indicate a single TCI state or a single pair of TCI states - e.g., selected from either the first set or the second set of TCI state codepoints - for single-TRP operation. In the present disclosure, the threshold could be (1) fixed, e.g., 8, 16, 32 or 64, or (2) configured by the network via higher layer RRC signaling or/and MAC CE command or/and DCI based signaling.

For DCI based beam indication, DCI format 1_1 with or without DL assignment or DCI format 1_2 with or without DL assignment could indicate/include a single “transmission configuration indication” field indicating a TCI state codepoint. A new one-bit flag indicator could be indicated/added in the DCI format 1_1 or 1_2 with or without DL assignment; the one-bit flag indicator is used to indicate mapping/association between the TCI field and a TRP. Alternatively, the new data indicator (NDI) field in the DCI format 1_1 or 1_2 with or without DL assignment could be used to indicate mapping/association between the TCI field and a TRP, and the NDI is toggled with every new transmission. Note that other existing one-bit flag indicator(s) in the DCI format 1_1 or 1_2 with or without DL assignment could also be repurposed to indicate mapping/association between the TCI field and a TRP. In the present disclosure, the UE could be higher layer configured by the network a list of entity IDs or a list of PCIs or a set of PCI indexes with each PCI index pointing to an entry/PCI in the list of PCIs that are higher layer configured to the UE.

For example, if the one-bit flag indicator/NDI is set to “0” or the NDI is toggled, the TCI state(s) indicated by the TCI state codepoint/the TCI field could be activated/selected by the MAC CE from the first (or second) TCI state pool (specified in the examples of the present disclosure) or the first (or second) TCI state group (specified in the examples of the present disclosure), and if the one-bit flag indicator/NDI is set to “1” or the NDI is not toggled, the TCI state(s) indicated by the TCI state codepoint/the TCI field could be activated/selected by the MAC CE from the second (or first) TCI state pool (specified in the examples of the present disclosure) or the second (or first) TCI state group (specified in the examples).

For another example, if the one-bit flag indicator/NDI is set to “0” (or “1”) or the NDI is toggled (or is not toggled), the TCI state codepoint/the TCI field could be associated with the entity ID associated with the serving cell PCI/PCI index or the lowest entity ID value or the first entity ID value in the higher layer configured list of entity IDs, and if the one-bit flag indicator/NDI is set to “1” (or “0”) or the NDI is not toggled (or is toggled), the TCI state codepoint/the TCI field could be associated with the entity ID associated with a PCI/PCI index other than the serving cell PCI/PCI index or the highest entity ID value or the last entity ID value in the higher layer configured list of entity IDs.

Alternatively, if the one-bit flag indicator/NDI is set to “0” (or “1”) or the NDI is toggled (or is not toggled), the TCI state codepoint/the TCI field could be associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

Yet for another example, if the UE is provided in PDCCH-Config two values of CORESETPoolIndex (i.e., 0 and 1): if the one-bit flag indicator/NDI is set to “0” (or “1”) or the NDI is toggled (or is not toggled), the TCI state codepoint/the TCI field could be associated with value 0 of CORESETPoolIndex or CORESETPoolIndex value associated with the serving cell PCI/PCI index or the lowest PCI value or the first PCI value in the higher layer configured list of PCIs or the lowest PCI index or the first PCI index in the set of PCI indexes or the PCI index pointing to the lowest PCI value in the higher layer configured list of PCIs, and if the one-bit flag indicator/NDI is set to “1” (or “0”) or the NDI is not toggled (or is toggled), the TCI state codepoint/the TCI field could be associated with value 1 of CORESETPoolIndex or CORESETPoolIndex value associated with a PCI/PCI index other than the serving cell PCI/PCI index or the highest PCI value or the last PCI value in the higher layer configured list of PCIs or the highest PCI index or the last PCI index in the set of PCI indexes or the PCI index pointing to the highest PCI value in the higher layer configured list of PCIs.

In the present disclosure, the UE could be higher layer configured by the network a list of entity IDs or a list of PCIs or a set of PCI indexes with each PCI index pointing to an entry/PCI in the list of PCIs that are higher layer configured to the UE.

In one example, a new one-bit flag indicator could be indicated/added in the DCI format 1_1 or 1_2 with or without DL assignment; the one-bit flag indicator is used to indicate mapping/association between the TCI field/TCI codepoint and a set of codepoints (e.g., the first or second set of codepoints). Alternatively, the new data indicator (NDI) field in the DCI format 1_1 or 1_2 with or without DL assignment could be used to indicate mapping/association between the TCI field/TCI state codepoint and a set of codepoints (e.g., the first or second set of codepoints), and the NDI is toggled with every new transmission. Note that other existing one-bit flag indicator(s) in the DCI format 1_1 or 1_2 with or without DL assignment could also be repurposed to indicate mapping/association between the TCI field/TCI state codepoint and a set of codepoints (e.g., the first or second set of codepoints). For this case, if the one-bit flag indicator/NDI is set to “0” (or “1”) or the NDI is toggled (or is not toggled), the TCI field could indicate the TCI state codepoint from the first set of TCI state codepoints, and if the one-bit flag indicator/NDI is set to “1” (or “0”) or the NDI is not toggled (or is toggled), the TCI field could indicate the TCI state codepoint from the second set of TCI state codepoints.

In another example, the TCI field could indicate the TCI state codepoint from a third set of TCI state codepoints, wherein the third set of TCI state codepoints comprises one or more TCI state codepoints from the first set of TCI state codepoints and one or more TCI state codepoints from the second set of TCI state codepoints. For instance, the first set of TCI state codepoints could comprise 8 TCI state codepoints, denoted by TCI_0, TCI_1, TCI_2, TCI_3, TCI_4, TCI_5, TCI_6, or TCI_7, and the second set of TCI state codepoints could comprise 8 TCI state codepoints, denoted by TCI_A, TCI_B, TCI_C, TCI_D, TCI_E, TCI_F, TCI_G, or TCI_H. The third set of TCI state codepoints could then comprise TCI_0, TCI_1, TCI_2, TCI_3, TCI_A, TCI_B, TCI_C, and TCI_D. The third set of TCI state codepoints could comprise any combinations of TCI state codepoints from the first or the second sets. The TCI state codepoints configured in the first or the second sets can be determined/selected into the third set according to at least one of: (1) fixed in the system specifications or (2) configured by the network via higher layer RRC signaling, MAC CE command or dynamic DCI based signaling.

If DCI format 1_1 or 1_2 for beam indication is with DL assignment or the number of TCI state codepoints Nc1 in the first set of TCI state codepoints to be activated by MAC CE or the number of TCI state codepoints Nc2 in the second set of TCI state codepoints to be activated by MAC CE or the total number of TCI state codepoints Nc1+Nc2 in the first and second sets of TCI state codepoints to be activated by MAC CE is smaller than a threshold, the TCI state codepoint indicated in the “transmission configuration indication” field could only correspond to/indicate a single TCI state or a single pair of TCI states - e.g., selected from either the first set or the second set of TCI state codepoints - for single-TRP operation. In the present disclosure, the threshold could be (1) fixed, e.g., 8, 16, 32 or 64, or (2) configured by the network via higher layer RRC signaling or/and MAC CE command or/and DCI based signaling.

In the present disclosure, the UE could be indicated by the network, e.g., via higher layer RRC signaling and/or MAC CE command and/or dynamic DCI based signaling, whether a single TCI field (e.g., the existing “transmission configuration indication” field) is configured in the DCI (e.g., DCI format 1_1 or 1_2 with or without downlink assignment) to indicate the M=2 (or N=2) TCI states/pairs of TCI states or two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions.

Alternatively, if one or more of the following conditions are satisfied/achieved, the UE could (implicitly) know/expect/assume that two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions; otherwise, the UE could (implicitly) know/expect/assume that a single TCI field (e.g., the existing “transmission configuration indication” field) is configured in the DCI (e.g., DCI format 1_1 or 1_2 with or without downlink assignment) to indicate the M=2 (or N=2) TCI states/pairs of TCI states.

Separate (e.g., M=2 or N=2) pools/lists/groups of TCI states are higher layer RRC configured to the UE.

A single pool/list/group of TCI states are higher layer RRC configured to the UE, and the size of the pool/list/group of TCI states or the number of TCI states in the pool/list/group is greater (or smaller) than a threshold, wherein the threshold could be (i) fixed, e.g., in the system specifications, and (ii) configured to the UE via higher layer RRC signaling and/or MAC CE command and/or dynamic DCI based signaling.

The UE receives from the network a MAC CE subselection/activation command activating two sets of TCI state codepoints. Or the UE receives from the network a first MAC CE subselection/activation command activating a first set of Nc1≥1 (e.g., 8, 16, 32 or 64) TCI state codepoints, and a second MAC CE subselection/activation command activating a second set of Nc2≥1 (e.g., 8, 16, 32 or 64) TCI state codepoints.

The DCI format for beam indication does not indicate/carry downlink PDSCH assignment.

The DCI format for beam indication also indicates/carriers downlink PDSCH assignment.

The number of TCI state codepoints activated by a MAC CE (e.g., Nc, Nc1 or Nc2 as discussed above in the present disclosure) or the total number of TCI state codepoints (e.g., Nc1+Nc2 as discussed above in the present disclosure) activated by one or more MAC CEs is greater (or smaller) than a threshold, wherein the threshold could be (i) fixed, e.g., in the system specifications, and (ii) configured to the UE via higher layer RRC signaling and/or MAC CE command and/or dynamic DCI based signaling.

Optionally, if one or more of the following conditions are satisfied/achieved, the UE could (implicitly) know/expect/assume that a single TCI field (e.g., the existing “transmission configuration indication” field) is configured in the DCI (e.g., DCI format 1_1 or 1_2 with or without downlink assignment) to indicate the M=2 (or N=2) TCI states/pairs of TCI states; otherwise, the UE could (implicitly) know/expect/assume that two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions.

Separate (e.g., M=2 or N=2) pools/lists/groups of TCI states are higher layer RRC configured to the UE.

A single pool/list/group of TCI states are higher layer RRC configured to the UE, and the size of the pool/list/group of TCI states or the number of TCI states in the pool/list/group is smaller (or greater) than a threshold, wherein the threshold could be (i) fixed, e.g., in the system specifications, and (ii) configured to the UE via higher layer RRC signaling and/or MAC CE command and/or dynamic DCI based signaling.

The UE receives from the network a MAC CE subselection/activation command activating two sets of TCI state codepoints. Or the UE receives from the network a first MAC CE subselection/activation command activating a first set of Nc1≥1 (e.g., 8, 16, 32 or 64) TCI state codepoints, and a second MAC CE subselection/activation command activating a second set of Nc2≥1 (e.g., 8, 16, 32 or 64) TCI state codepoints.

The UE receives from the network a MAC CE subselection/activation command activating a single set of Nc≥1 (e.g., 8, 16, 32 or 64) TCI state codepoints.

The DCI format for beam indication does not indicate/carry downlink PDSCH assignment.

The DCI format for beam indication also indicates/carriers downlink PDSCH assignment.

The number of TCI state codepoints activated by a MAC CE (e.g., Nc, Nc1 or Nc2 as discussed above in the present disclosure) or the total number of TCI state codepoints (e.g., Nc1+Nc2 as discussed above in the present disclosure) activated by one or more MAC CEs is smaller (or greater) than a threshold, wherein the threshold could be (i) fixed, e.g., in the system specifications, and (ii) configured to the UE via higher layer RRC signaling and/or MAC CE command and/or dynamic DCI based signaling.

A one-bit flag indicator or NDI is indicated in the DCI for beam indication (e.g., DCI format 1_1 or 1_2 with or without downlink assignment) to indicate the association/mapping between the TCI field(s) and a set of TCI state codepoints activated by the MAC CE(s) or a TRP as discussed in the examples of the present disclosure.

As discussed above, a UE could receive in a DCI (e.g., DCI format 1_1 or 1_2 with or without DL assignment) M>1 (or N>1) TCI states/pairs of TCI states indicated/updated for the multi-TRP operation. In one embodiment of this disclosure, the DCI format for beam indication could also include/indicate one or more (e.g., M>1 or N>1) CORESET IDs, each associated with an indicated TCI state/pair of TCI states. For example, the one or more (e.g., M>1 or N>1) CORESET IDs could be indicated by a DCI field “CORESET IDs for beam indication” in the corresponding DCI format. For another example, the one or more (e.g., M>1 or N>1) CORESET IDs could be indicated by repurposing one or more bits of one or more existing/reserved DCI fields in the corresponding DCI format. When the one or more CORESET IDs are indicated in the DCI format for beam indication, the UE could apply an indicated TCI state/pair of TCI states associated with a CORESET ID for receiving a PDCCH candidate in the CORESET associated with the same CORESET ID.

In one example, in the DCI format for beam indication, the first indicated CORESET ID among the indicated M>1 (or N>1) CORESET IDs could be associated with the first (or last) indicated TCI state/pair of TCI states among the indicated M>1 (or N>1) TCI states/pairs of TCI states, the second indicated CORESET ID among the indicated M>1 (or N>1) CORESET IDs could be associated with the second (or second last) indicated TCI state/pair of TCI states among the indicated M>1 (or N>1) TCI states/pairs of TCI states, and so on, and the last indicated CORESET ID among the indicated M>1 (or N>1) CORESET IDs could be associated with the last (or first) indicated TCI state/pair of TCI states among the indicated M>1 (or N>1) TCI states/pairs of TCI states. For M=2 (or N=2), the first indicated CORESET ID could be associated with the first (or second) indicated TCI state/pair of TCI states, and the second indicated CORESET ID could be associated with the second (or first) indicated TCI state/pair of TCI states.

In another example, in the DCI format for beam indication, the lowest (or highest) CORESET ID among the indicated M>1 (or N>1) CORESET IDs could be associated with the first indicated TCI state/pair of TCI states among the indicated M>1 (or N>1) TCI states/pairs of TCI states, the second lowest (or second highest) CORESET ID among the indicated M>1 (or N>1) CORESET IDs could be associated with the second indicated TCI state/pair of TCI states among the indicated M>1 (or N>1) TCI states/pairs of TCI states, and so on, and the highest (or lowest) CORESET ID among the indicated M>1 (or N>1) CORESET IDs could be associated with the last indicated TCI state/pair of TCI states among the indicated M>1 (or N>1) TCI states/pairs of TCI states. For M=2 (or N=2), the lowest (or highest) CORESET ID could be associated with the first indicated TCI state/pair of TCI states, and the highest (or lowest) CORESET ID could be associated with the second indicated TCI state/pair of TCI states.

In yet another example, in the DCI format for beam indication, the first indicated CORESET ID among the indicated M>1 (or N>1) CORESET IDs could be associated with the TCI state/pair of TCI states having the lowest (or highest) TCI state ID among the indicated M>1 (or N>1) TCI states/pairs of TCI states, the second indicated CORESET ID among the indicated M>1 (or N>1) CORESET IDs could be associated with the TCI state/pair of TCI states having the second lowest (or second highest) TCI state ID among the indicated M>1 (or N>1) TCI states/pairs of TCI states, and so on, and the last indicated CORESET ID among the indicated M>1 (or N>1) CORESET IDs could be associated with the TCI state/pair of TCI states having the highest (or lowest) TCI state ID among the indicated M>1 (or N>1) TCI states/pairs of TCI states. For M=2 (or N=2), the first indicated CORESET ID could be associated with the TCI state/pair of TCI states having the lowest (or highest) TCI state ID, and the second indicated CORESET ID could be associated with the TCI state/pair of TCI states having the highest (or lowest) TCI state ID.

In yet another example, in the DCI format for beam indication, the lowest CORESET ID among the indicated M>1 (or N>1) CORESET IDs could be associated with the TCI state/pair of TCI states having the lowest (or highest) TCI state ID among the indicated M>1 (or N>1) TCI states/pairs of TCI states, the second lowest CORESET ID among the indicated M>1 (or N>1) CORESET IDs could be associated with the TCI state/pair of TCI states having the second lowest (or second highest) TCI state ID among the indicated M>1 (or N>1) TCI states/pairs of TCI states, and so on, and the highest CORESET ID among the indicated M>1 (or N>1) CORESET IDs could be associated with the TCI state/pair of TCI states having the highest (or lowest) TCI state ID among the indicated M>1 (or N>1) TCI states/pairs of TCI states. For M=2 (or N=2), the lowest CORESET ID could be associated with the TCI state/pair of TCI states having the lowest (or highest) TCI state ID, and the highest CORESET ID could be associated with the TCI state/pair of TCI states having the highest (or lowest) TCI state ID.

In a multi-TRP system, a UE may receive two PDCCH candidates (denoted by a first PDCCH candidate and a second PDCCH candidate) from two respective search space sets linked via higher layer configuration (e.g., by a RRC parameter SearchSpaceLinking), wherein the two search space sets are in two CORESETs. As discussed above, the UE could receive in a DCI (e.g., DCI format 1_1 or 1_2 with or without DL assignment) M=2 TCI states indicated by a TCI state codepoint of a TCI field or separate TCI fields. For this case, the UE could apply a first TCI state out of the indicated M=2 TCI states to receive the first PDCCH candidate in a first CORESET, and a second TCI state out of the indicated M=2 TCI states to receive the second PDCCH candidate in a second CORESET, wherein the first TCI state could be associated with the first CORESET, and the second TCI state could be associated with the second CORESET, following those specified in the examples of the present disclosure.

Alternatively, in one example, the UE could apply the first (or second) indicated TCI state to receive the first or second PDCCH candidate in a CORESET with the lowest CORESET ID, and the second (or first) indicated TCI state to receive the first or second PDCCH candidate in a CORESET with the highest CORESET ID.

In another example, the UE could apply the indicated TCI state with the lowest (or highest) TCI state ID to receive the first or second PDCCH candidate in a CORESET with the lowest CORESET ID, and the indicated TCI state with the highest (or lowest) TCI state ID to receive the first or second PDCCH candidate in a CORESET with the highest CORESET ID.

In yet another example, the UE could apply the first (or second) indicated TCI state to receive the first or second PDCCH candidate that starts earlier in time, and the second (or first) indicated TCI state to receive the first or second PDCCH candidate that starts later in time.

In yet another example, the UE could apply the indicated TCI state with the lowest (or highest) TCI state ID to receive the first or second PDCCH candidate that starts earlier in time, and the indicated TCI state with the highest (or lowest) TCI state ID to receive the first or second PDCCH candidate that starts later in time.

In another embodiment of the present disclosure, a UE could be provided by the network (e.g., in PDCCH-Config) different values (e.g., two - “0” and “1”) of CORESET group index, wherein one or more CORESETs could be associated/configured with the same CORESET group index value.

For example, the UE could be configured by the network (e.g., via higher layer RRC signaling) the association/mapping relationship between different values of CORESET group index and one or more CORESETs. For instance, for each value of CORESET group index (e.g., 0 or 1), the UE could be higher layer configured by the network a list of CORESET IDs associated with the corresponding CORESET group index value.

For another example, a CORESET group index value, e.g., provided by higher layer parameter CORESETGroupIndex, could be included/indicated in the higher layer parameter ControlResourceSet that configures a CORESET.

In a multi-TRP system, a UE could receive in a DCI (e.g., DCI format 1_1 or 1_2 with or without DL assignment) - in a CORESET associated with a value of CORESET group index according to those specified in the examples of the present disclosure - M>1 (or N>1) TCI states/pairs of TCI states by a TCI state codepoint of a TCI field or separate TCI fields. For M=2 (or N=2), if the CORESET group index value is “0” (or “1”), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the CORESET group index value is “1” (or “0”), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

Alternatively, a one-bit flag indicator could be included/indicated in the higher layer parameter ControlResourceSet that configures a CORESET. In a multi-TRP system, a UE could receive in a DCI (e.g., DCI format 1_1 or 1_2 with or without DL assignment) - in a CORESET configured with the one-bit flag indicator - M>1 (or N>1) TCI states/pairs of TCI states by a TCI state codepoint of a TCI field or separate TCI fields. For M=2 (or N=2), if the one-bit flag indicator is set to “0” (or “1”), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the one-bit flag indicator is set to “1” (or “0”), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

Optionally, in a multi-TRP system, a UE could receive in a DCI (e.g., DCI format 1_1 or 1_2 with or without DL assignment) M>1 (or N>1) TCI states/pairs of TCI states by a TCI state codepoint of a TCI field or separate TCI fields, wherein the DCI format also includes/indicates/configures a new data indicator (NDI) field. For M=2 (or N=2), if the NDI field is set to “0” (or “1”) or the NDI is toggled (or not toggled), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the NDI field is set to “1” (or “0”) or the NDI is not toggled (or toggled), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

As discussed above, a UE could receive in a DCI (e.g., DCI format 1_1 or 1_2 with or without DL assignment) M>1 (or N>1) TCI states/pairs of TCI states indicated by, e.g., a TCI state codepoint of a TCI field or separate TCI fields. Later in time, the UE could be indicated by the network one or more TCI states/pairs of TCI states that update one or more of the previously indicated M>1 (or N>1) TCI states/pairs of TCI states. For instance, for M = 2 (or N=2),

In one example, the UE could first receive in a first DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive in a second DCI (e.g., DCI format 1_1 or 1_2 with or without DL assignment) M=1 (or N=1) TCI state/pair of TCI states indicated by, e.g., a TCI state codepoint of a TCI field or separate TCI fields or repurposing one or more bits of one or more existing/reserved DCI fields in the corresponding DCI format.

A first one-bit flag indicator could be used to indicate to the UE whether the (M=1 or N=1) TCI state(s)/pair(s) of TCI states indicated in the corresponding (second) DCI format is for single-TRP operation or to update one of the previously indicated (M=2 or N=2) TCI states/pairs of TCI states in the corresponding (first) DCI format. The first one-bit flag indicator could be included/indicated/configured in a DCI format (e.g., DCI format 1_1 or 1_2 with or without DL assignment for beam indication) by a DCI field “TCI state for single-TRP.”

Alternatively, one or more bits of one or more existing/reserved DCI fields - e.g., a NDI field - could be repurposed/used to indicate the first one-bit flag indicator. For example, if the first one-bit flag indicator is set to “0” (or “1”) or not toggled (or toggled) - when the first one-bit flag indicator is indicated by NDI, the UE may apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format. Otherwise, i.e., if the first one-bit flag indicator is set to “1” (or “0”) or toggled (or not toggled) - when the first one-bit flag indicator is indicated by NDI, the UE may apply the M=1 (or N=1) TCI state/pair of TCI states indicated in the second DCI to update/replace one of the M=2 (or N=2) TCI states/pairs of TCI states indicated in the first DCI. The first one-bit flag indicator could be applied to one or more of the following design examples.

For example, when the first one-bit flag indicator is set to “1” (or “0”) or toggled (or not toggled) - if the first one-bit flag indicator is indicated by NDI - according to the above discussions, a second one-bit flag indicator could be used to indicate to the UE which one of the M=2 (or N=2) TCI states/pairs of TCI states indicated in the first DCI may be replaced/updated by the M=1 (or N=1) TCI state/pair of TCI states indicated in the second DCI. The second one-bit flag indicator could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields - e.g., a NDI field - could be repurposed/used to indicate the second one-bit flag indicator. If the second one-bit flag indicator is set to “0” (or “1”) or not toggled (or toggled) - when the second one-bit flag indicator is indicated by NDI, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the second one-bit flag indicator is set to “1” (or “0”) or toggled (or not toggled) - when the second one-bit flag indicator is indicated by NDI, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

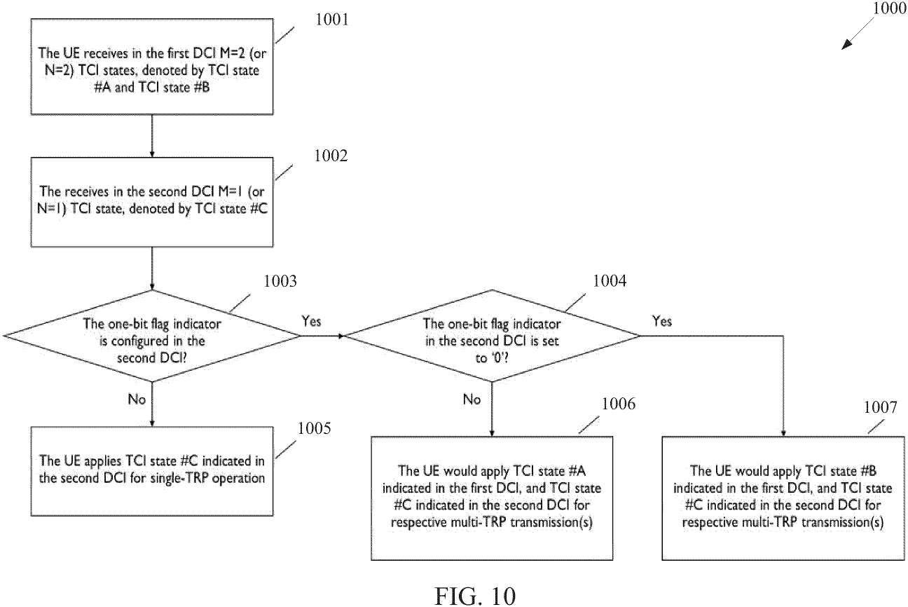

FIG. 10 illustrates a flowchart of a method 1000 for TCI states indication and application according to embodiments of the present disclosure. The method 1000 as may be performed by UEs (e.g., 111-116 as illustrated in FIG. 1). An embodiment of the method 1000 shown in FIG. 10 is for illustration only.

For another example, a one-bit flag indicator could be included/indicated/configured in a DCI format (e.g., DCI format 1_1 or 1_2 with or without DL assignment for beam indication), e.g., by a DCI field “TCI state update for multi-TRP.” Alternatively, one or more bits of one or more existing/reserved DCI fields - e.g., a NDI field - could be repurposed/used to indicate the one-bit flag indicator. If the one-bit flag indicator is not configured/enabled, the UE may apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format.

Otherwise, if the one-bit flag indicator is set to “0” (or “1”) or not toggled (or toggled) - when the one-bit flag indicator is indicated by NDI, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the one-bit flag indicator is set to “1” (or “0”) or toggled (not toggled) - when the one-bit flag indicator is indicated by NDI, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI. In FIG. 10, an example of the above discussed signaling flow/procedure is provided.

As illustrated in FIG. 10, in 1001, the UE receives in the first DCI two TCI states TCI state #A and TCI state #B. In 1002, later in time, the UE receives in the second DCI a single TCI state #C. In 1003, the condition of whether the one-bit flag indicator is enabled/configured in the second DCI or not is checked. If the one-bit flag indicator is not enabled/configured, the signaling procedure goes to 1005. Otherwise, the signaling procedure proceeds to 1004. In 1004, the condition of whether the one-bit flag indicator is set to “0” or “1” is checked. If the one-bit flag indicator is set to “1,” the signaling flow goes to 1006. Otherwise, the signaling procedure proceeds to 1007. In 1005, the UE may apply TCI state #C indicated in the second DCI for the single-TRP operation. In 1006, the UE may apply TCI state #C indicated in the second DCI to replace/update TCI state #B indicated in the first DCI. That is, the UE may apply TCI state #A indicated in the first DCI and TCI state #C indicated in the second DCI for the multi-TRP operation. In 1007, the UE may apply TCI state #C indicated in the second DCI to replace/update TCI state #A indicated in the first DCI. That is, the UE may apply TCI state #B indicated in the first DCI and TCI state #C indicated in the second DCI for the multi-TRP operation.

Yet for another example, a two-bit indicator could be included/indicated/configured in a DCI format (e.g., DCI format 1_1 or 1_2 with or without DL assignment for beam indication), e.g., by a DCI field “TCI state indication or update.” Alternatively, one or more bits of one or more existing/reserved DCI fields could be repurposed/used to indicate the two-bit indicator. If the 2-bit indicator is set to “00” (or “01” or “10,” or “11”), the UE may apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format. If the 2-bit indicator is set to “01” (or “00,” “10,” or “11”), the UE may apply the M=1 (or N=1) TCI state/pair of TCI states indicated in the second DCI to update/replace one of the M=2 (or N=2) TCI states/pairs of TCI states indicated in the first DCI. If the 2-bit indicator is set to “10” (or “00” or “01” or “11”), the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the 2-bit indicator is set to “11” (or “00” or “01” or “10”), the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, a UE could receive the second DCI in a CORESET associated with a value of CORESETPoolIndex or a value of CORESET group index according to those specified in the examples of the present disclosure. When the first one-bit flag indicator is set to “1” (or “0”) or toggled (or not toggled) - if the first one-bit flag indicator is indicated by NDI -according to the above discussions: if the UE receives the second DCI in a CORESET associated with value 0 (or 1) of CORESETPoolIndex or value 0 (or 1) of CORESET group index, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; if the UE receives the second DCI in a CORESET associated with value 1 (or 0) of CORESETPoolIndex or value 1 (or 0) of CORESET group index, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, as discussed before, a DCI format (e.g., DCI format 1_1 or 1_2 with or without DL assignment) could indicate/include a first “transmission configuration indication” field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “transmission configuration indication” field in the DCI format 1_1 or 1_2 (with or without DL assignment). In yet another example, the first TCI field or the second TCI field could be configured by repurposing one or more bits of one or more of the existing/reserved DCI fields in the DCI format 1_1 or 1_2 (with or without DL assignment).

For this example, if the M=1 (or N=1) TCI state/pair of TCI states is indicated by the first (or second) TCI field, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the M=1 (or N=1) TCI state/pair of TCI states is indicated by the second (or first) TCI field, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

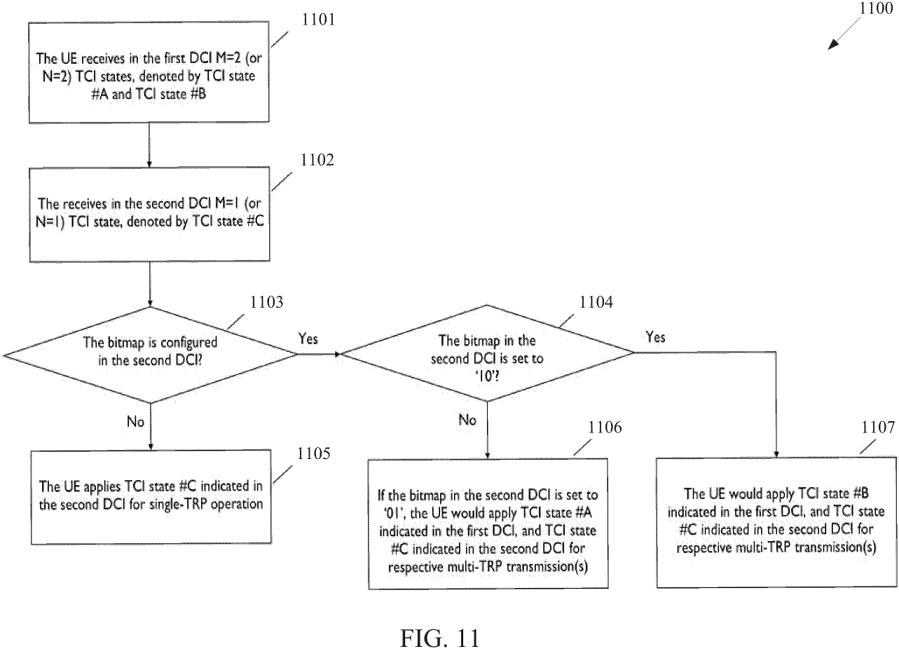

FIG. 11 illustrates another flowchart of a method 1100 for TCI states indication and application according to embodiments of the present disclosure. The method 1100 as may be performed by UEs (e.g., 111-116 as illustrated in FIG. 1). An embodiment of the method 1100 shown in FIG. 11 is for illustration only.

Yet for another example, a bitmap could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields could be repurposed/used to indicate the bitmap. The bitmap could be used to indicate to the UE which one of the M=2 (or N=2) TCI states/pairs of TCI states indicated in the first DCI may be replaced/updated by the M=1 (or N=1) TCI state/pair of TCI states indicated in the second DCI. In this example, the bitmap has two entries/bit positions. When the first one-bit flag indicator is set to “0” (or “1”) or not toggled (or toggled) - if the first one-bit flag indicator is indicated by NDI - according to the above discussions or the bitmap is not configured/enabled, the UE may apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format.

Otherwise, when the first one-bit flag indicator is set to “1” (or “0”) or toggled (or not toggled) - if the first one-bit flag indicator is indicated by NDI - according to the above discussions or the bitmap is configured/enabled: if the first entry/bit position of the bitmap is set to “1,” the UE may apply the M=1 (or N=1) TCI state/pair of TCI states indicated in the second DCI to update/replace the first (or second) TCI state/pair of TCI states or the TCI state/pair of TCI states with the lowest (or highest) TCI state ID among the M=2 (or N=2) TCI states/pairs of TCI states indicated in the first DCI, and if the second entry/bit position of the bitmap is set to “1,” the UE may apply the M=1 (or N=1) TCI state/pair of TCI states indicated in the second DCI to update/replace the second (or first) TCI state/pair of TCI states or the TCI state/pair of TCI states with the highest (or lowest) TCI state ID among the M=2 (or N=2) TCI states/pairs of TCI states indicated in the first DCI. In FIG. 11, an example of the above discussed signaling flow/procedure is provided.

As illustrated in FIG. 11, in 1101, the UE receives in the first DCI two TCI states TCI state #A and TCI state #B. In 1102, later in time, the UE receives in the second DCI a single TCI state #C. In 1103, the condition of whether the bitmap is enabled/configured in the second DCI or not is checked. If the bitmap is not enabled/configured, the signaling procedure goes to 1105. Otherwise, the signaling procedure proceeds to 1104. In 1104, the condition of whether the bitmap is set to “10” is checked. If the bitmap is set to “10,” the signaling flow proceeds to 1107. Otherwise, the signaling procedure goes to 1106. In 1105, the UE may apply TCI state #C indicated in the second DCI for the single-TRP operation. In 1106, if the bitmap is set to “01,” the UE may apply TCI state #C indicated in the second DCI to replace/update TCI state #B indicated in the first DCI. That is, the UE may apply TCI state #A indicated in the first DCI and TCI state #C indicated in the second DCI for the multi-TRP operation. In 1107, the UE may apply TCI state #C indicated in the second DCI to replace/update TCI state #A indicated in the first DCI. That is, the UE may apply TCI state #B indicated in the first DCI and TCI state #C indicated in the second DCI for the multi-TRP operation.

For this design example, the M=2 (or N=2) TCI states/pairs of TCI states indicated in the first DCI could be selected from Nc≥1 (e.g., Nc=8, 16, 32 and etc.) TCI state codepoints activated by a first MAC CE activation command, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc could be (1) fixed, e.g., in the system specifications or (2) provided by the network via higher layer RRC signaling and/or MAC CE command and/or dynamic DCI based signaling.

In one example, the M=1 (or N=1) TCI state/pair of TCI states indicated in the second DCI could correspond to a joint DL and UL TCI state or a pair of separate DL and UL TCI states of a TCI state codepoint activated by the first MAC CE command. For this example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In another example, the M=1 (or N=1) TCI state/pair of TCI states indicated in the second DCI could correspond to a TCI state/pair of TCI states selected as the first TCI state/pair of TCI states or the TCI state/pair of TCI states with the lowest TCI state ID among M=2 (or N=2) TCI states/pairs of TCI states of a TCI state codepoint activated by the first MAC CE command, or correspond to the second TCI state/pair of TCI states or the TCI state/pair of TCI states with the highest TCI state ID among M=2 (or N=2) TCI states/pairs of TCI states of a TCI state codepoint activated by the first MAC CE command.

For example, if the selected TCI state/pair of TCI states - as the M=1 (or N=1) TCI state/pair of TCI states indicated in the second DCI - has the same TCI state ID as one or more TCI states/pairs of TCI states of one or more TCI state codepoints activated by the first MAC CE command, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

For another example, if the selected TCI state/pair of TCI states - as the M=1 (or N=1) TCI state/pair of TCI states indicated in the second DCI - has a different TCI state ID from any of the TCI states/pairs of TCI states of all the TCI state codepoints activated by the first MAC CE command: if the M=1 (or N=1) TCI state/pair of TCI states indicated in the second DCI corresponds to the first (or second) TCI state/pair of TCI states or the TCI state/pair of TCI states with the lowest (or highest) TCI state ID among M=2 (or N=2) TCI states/pairs of TCI states of a TCI state codepoint activated by the first MAC CE command, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; else, if the M=1 (or N=1) TCI state/pair of TCI states indicated in the second DCI corresponds to the second (or first) TCI state/pair of TCI states or the TCI state/pair of TCI states with the highest (or lowest) TCI state ID among M=2 (or N=2) TCI states/pairs of TCI states of a TCI state codepoint activated by the first MAC CE command, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, the UE could be first indicated by the network whether the selected TCI state/pair of TCI states - as the M=1 (or N=1) TCI state/pair of TCI states indicated in the second DCI - corresponds the first TCI state/pair of TCI states or the TCI state/pair of TCI states with the lowest TCI state ID among M=2 (or N=2) TCI states/pairs of TCI states of a TCI state codepoint activated by the first MAC CE command, or corresponds to the second TCI state/pair of TCI states or the TCI state/pair of TCI states with the highest TCI state ID among M=2 (or N=2) TCI states/pairs of TCI states of a TCI state codepoint activated by the first MAC CE command (in case that the selected TCI state/pair of TCI states - as the M=1 (or N=1) TCI state/pair of TCI states indicated in the second DCI - has the same TCI state ID as one or more TCI states/pairs of TCI states of one or more TCI state codepoints activated by the first MAC CE command).

According to the network’s indication, if the M=1 (or N=1) TCI state/pair of TCI states indicated in the second DCI corresponds to the first (or second) TCI state/pair of TCI states or the TCI state/pair of TCI states with the lowest (or highest) TCI state ID among M=2 (or N=2) TCI states/pairs of TCI states of a TCI state codepoint activated by the first MAC CE command, the UE may apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; else, if the M=1 (or N=1) TCI state/pair of TCI states indicated in the second DCI corresponds to the second (or first) TCI state/pair of TCI states or the TCI state/pair of TCI states with the highest (or lowest) TCI state ID among M=2 (or N=2) TCI states/pairs of TCI states of a TCI state codepoint activated by the first MAC CE command, the UE may apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

In yet another example, the M=1 (or N=1) TCI state/pair of TCI states indicated in the second DCI could be selected from Nc′≥1 (e.g., Nc′=8, 16, 32 and etc.) TCI state codepoints activated by a MAC CE activation command different from the first MAC CE command, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc′ could be (1) fixed, e.g., in the system specifications or (2) provided by the network via higher layer RRC signaling and/or MAC CE command and/or dynamic DCI based signaling. For this example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

Alternatively, the first (or second) TCI state/pair of TCI states or the TCI state/pair of TCI states with the lowest (or highest) TCI state ID among the M=2 (or N=2) TCI states/pairs of TCI states indicated in the first DCI could be selected from Nc1≥1 (e.g., Nc1=8, 16, 32 and etc.) TCI state codepoints activated by a first MAC CE activation command, and the second (or first) TCI state/pair of TCI states or the TCI state/pair of TCI states with the highest (or lowest) TCI state ID among the M=2 (or N=2) TCI states/pairs of TCI states indicated in the first DCI could be selected from Nc2≥1 (e.g., Nc2=8, 16, 32 and etc.) TCI state codepoints activated by a second MAC CE activation command, where an activated TCI state codepoint in the first or second MAC CE commands could correspond to a joint DL and UL TCI state, a pair of separate DL and UL TCI states, M=2 (or N=2) joint DL and UL TCI states or pairs of separate DL and UL TCI states. The M=1 (or N=1) TCI state/pair of TCI states indicated in the second DCI could correspond to a joint DL and UL TCI state or a pair of separate DL and UL TCI states of a TCI state codepoint activated by the first MAC CE command, or a joint DL and UL TCI state or a pair of separate DL and UL TCI states of a TCI state codepoint activated by the second MAC CE command. In the present disclosure, the number/value of Nc1 or Nc2 could be (1) fixed, e.g., in the system specifications or (2) provided by the network via higher layer RRC signaling and/or MAC CE command and/or dynamic DCI based signaling.

In one example, if the M=1 (or N=1) TCI state/pair of TCI states indicated in the second DCI corresponds to a joint DL and UL TCI state or a pair of separate DL and UL TCI states of a TCI state codepoint activated by the first MAC CE command, the UE may apply the M=1 (or N=1) TCI state/pair of TCI states indicated in the second DCI to update/replace the first (or second) TCI state/pair of TCI states or the TCI state/pair of TCI states with the lowest (or highest) TCI state ID among the M=2 (or N=2) TCI states/pairs of TCI states indicated in the first DCI; if the M=1 (or N=1) TCI state/pair of TCI states indicated in the second DCI corresponds to a joint DL and UL TCI state or a pair of separate DL and UL TCI states of a TCI state codepoint activated by the second MAC CE command, the UE may apply the M=1 (or N=1) TCI state/pair of TCI states indicated in the second DCI to update/replace the second (or first) TCI state/pair of TCI states or the TCI state/pair of TCI states with the highest (or lowest) TCI state ID among the M=2 (or N=2) TCI states/pairs of TCI states indicated in the first DCI.

In another example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In yet another example, the M=1 (or N=1) TCI state/pair of TCI states indicated in the second DCI could be selected from Nc′≥1 (e.g., Nc′=8, 16, 32 and etc.) TCI state codepoints activated by a MAC CE activation command different from the first and second MAC CE commands, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc′ could be (1) fixed, e.g., in the system specifications or (2) provided by the network via higher layer RRC signaling and/or MAC CE command and/or dynamic DCI based signaling. For this example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In another example, the UE could first receive in a first DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive in a second DCI (e.g., DCI format 1_1 or 1_2 with or without DL assignment) M=2 (or N=2) TCI state/pair of TCI states indicated by, e.g., a TCI state codepoint of a TCI field or separate TCI fields or repurposing one or more bits of one or more existing/reserved DCI fields in the corresponding DCI format.

For example, a one-bit flag indicator could be used to indicate to the UE which one of the M=2 (or N=2) TCI states/pairs of TCI states indicated in the first DCI may be replaced/updated by one of the M=2 (or N=2) TCI states/pairs of TCI states indicated in the second DCI. The one-bit flag indicator could be included/indicated/configured in a DCI format (e.g., DCI format 1_1 or 1_2 with or without DL assignment for beam indication), e.g., by a DCI field “TCI state update for multi-TRP.” Alternatively, one or more bits of one or more existing/reserved DCI fields - e.g., a NDI field - could be repurposed/used to indicate the one-bit flag indicator. If the one-bit flag indicator is set to “0” (or “1”) or not toggled (or toggled) - when the one-bit flag indicator is indicated by NDI, the UE may apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the one-bit flag indicator is set to “1” (or “0”) or toggled (or not toggled) - when the one-bit flag indicator is indicated by NDI, the UE may apply the second (or first) TCI state/pair of TCI states or the TCI state/pair of TCI states with the highest (or lowest) TCI state ID among the M=2 (or N=2) TCI states/pairs of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

For another example, a UE could receive the second DCI in a CORESET associated with a value of CORESETPoolIndex or a value of CORESET group index according to those specified in the examples in the present disclosure. If the UE receives the second DCI in a CORESET associated with value 0 (or 1) of CORESETPoolIndex or value 0 (or 1) of CORESET group index, the UE may apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; if the UE receives the second DCI in a CORESET associated with value 1 (or 0) of CORESETPoolIndex or value 1 (or 0) of CORESET group index, the UE may apply the second (or first) TCI state/pair of TCI states or the TCI state/pair of TCI states with the highest (or lowest) TCI state ID among the M=2 (or N=2) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, a bitmap could be included/indicated/configured in a DCI format (e.g., DCI format 1_1 or 1_2 with or without DL assignment for beam indication), e.g., by a DCI field “TCI state update for multi-TRP.” Alternatively, one or more bits of one or more existing/reserved DCI fields could be repurposed/used to indicate the bitmap. The bitmap could be used to indicate to the UE which one of the M=2 (or N=2) TCI states/pairs of TCI states indicated in the first DCI may be replaced/updated by one of the M=2 (or N=2) TCI states/pairs of TCI states indicated in the second DCI. In this example, the bitmap has two entries/bit positions. If the first (or second) entry/bit position of the bitmap is set to “1,” the UE may apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI, and if the second (or first) entry/bit position of the bitmap is set to “1,” the UE may apply the second (or first) TCI state/pair of TCI states and the TCI state/pair of TCI states with the highest (or lowest) TCI state ID among the M=2 (or N=2) TCI states/pairs of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

In yet another example, as discussed before, a DCI format (e.g., DCI format 1_1 or 1_2 with or without DL assignment) could indicate/include a first “transmission configuration indication” field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “transmission configuration indication” field in the DCI format 1_1 or 1_2 (with or without DL assignment).

In yet another example, the first TCI field or the second TCI field could be configured by repurposing one or more bits of one or more of the existing/reserved DCI fields in the DCI format 1_1 or 1_2 (with or without DL assignment). The first TCI state codepoint of the first TCI field could be selected/determined from Nc1≥1 (e.g., Nc1=8, 16, 32 and etc.) TCI state codepoints activated by a first MAC CE activation command, wherein an activated TCI state codepoint could correspond to a joint DL and UL TCI state, a pair of separate DL and UL TCI states, M=2 (or N=2) joint DL and UL TCI states or pairs of separate DL and UL TCI states; and the first TCI state codepoint of the second TCI field could be selected/determined from Nc2≥1 (e.g., Nc2=8, 16, 32 and etc.) TCI state codepoints activated by a second MAC CE activation command, wherein an activated TCI state codepoint could correspond to a joint DL and UL TCI state, a pair of separate DL and UL TCI states, M=2 (or N=2) joint DL and UL TCI states or pairs of separate DL and UL TCI states. In the present disclosure, the number/value of Nc1 or Nc2 could be (1) fixed, e.g., in the system specifications or (2) provided by the network via higher layer RRC signaling and/or MAC CE command and/or dynamic DCI based signaling.

For example, the first TCI state codepoint of the first TCI field indicated by a first DCI is different from the first TCI state codepoint of the first TCI field indicated by a second DCI; while the second TCI state codepoint of the second TCI field indicated by the first DCI is the same as the second TCI state codepoint of the second TCI field indicated by the second DCI. The second DCI could be received later in time than the first DCI, e.g., the first DCI is the previous DCI received in time with respect to the second DCI.

For another example, the first TCI state codepoint of the first TCI field indicated by a first DCI is the same as the first TCI state codepoint of the first TCI field indicated by a second DCI; while the second TCI state codepoint of the second TCI field indicated by the first DCI is different from the second TCI state codepoint of the second TCI field indicated by the second DCI. The second DCI could be received later in time than the first DCI, e.g., the first DCI is the previous DCI received in time with respect to the second DCI.

Yet for another example, the first TCI state codepoint of the first TCI field indicated by a first DCI is different from the first TCI state codepoint of the first TCI field indicated by a second DCI; and the second TCI state codepoint of the second TCI field indicated by the first DCI is different from the second TCI state codepoint of the second TCI field indicated by the second DCI as well. The second DCI could be received later in time than the first DCI, e.g., the first DCI is the previous DCI received in time with respect to the second DCI.

In yet another example, the UE could first receive in a DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive a MAC CE indicating M=1 (or N=1) TCI state/pair of TCI states - selected/activated from one or more lists/pools of RRC configured TCI states/pairs of TCI states - to update one of the M=2 (N=2) TCI states/pairs of TCI states indicated in the DCI. A first one-bit flag indicator could be included/indicated/configured in the MAC CE activation command to indicate to the UE whether the (M=1 or N=1) TCI state(s)/pair(s) of TCI states indicated in the MAC CE activation command is for single-TRP operation or to update one of the previously indicated (M=2 or N=2) TCI states/pairs of TCI states in the corresponding DCI format.

For example, if the first one-bit flag indicator is set to “0” (or “1”), the UE may apply the M=1 (or N=1) TCI state/pair of TCI states indicated in the MAC CE activation command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. Otherwise, i.e., if the first one-bit flag indicator is set to “1” (or “0”), the UE may apply the M=1 (or N=1) TCI state/pair of TCI states indicated in the MAC CE command to update/replace one of the M=2 (or N=2) TCI states/pairs of TCI states indicated in the DCI. The first one-bit flag indicator could be applied to one or more of the following design examples.

For example, when the first one-bit flag indicator is set to “1” (or “0”) according to the above discussions, a second one-bit flag indicator could be included/indicated/configured in the MAC CE activation command to indicate to the UE which one of the M=2 (or N=2) TCI states/pairs of TCI states indicated in the DCI may be replaced/updated by the M=1 (or N=1) TCI state/pair of TCI states indicated in the MAC CE activation command. If the second one-bit flag indicator is set to “0” (or “1”), the UE may apply the M=1 (or N=1) TCI state/pair of TCI states indicated in the MAC CE activation command to update/replace the first TCI state/pair of TCI states or the TCI state/pair of TCI states with the lowest TCI state ID among the M=2 (or N=2) TCI states/pairs of TCI states indicated in the DCI. If the second one-bit flag indicator is set to “1” (or “0”), the UE may apply the M=1 (or N=1) TCI state/pair of TCI states indicated in the MAC CE activation command to update/replace the second TCI state/pair of TCI states or the TCI state/pair of TCI states with the highest TCI state ID among the M=2 (or N=2) TCI states/pairs of TCI states indicated in the DCI. For this design example, the second one-bit flag indicator could also correspond to a CORESETPoolIndex or a CORESET group index specified according to the examples in the present disclosure.

For another example, a one-bit flag indicator could be included/indicated/configured in the MAC CE activation command. If the one-bit flag indicator is not configured/enabled in the MAC CE command, the UE may apply the M=1 (or N=1) TCI state/pair of TCI states indicated in the MAC CE activation command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. Otherwise, if the one-bit flag indicator is set to “0” (or “1”), the UE may apply the M=1 (or N=1) TCI state/pair of TCI states indicated in the MAC CE activation command to update/replace the first TCI state/pair of TCI states or the TCI state/pair of TCI states with the lowest TCI state ID among the M=2 (or N=2) TCI states/pairs of TCI states indicated in the DCI. If the one-bit flag indicator is set to “1” (or “0”), the UE may apply the M=1 (or N=1) TCI state/pair of TCI states indicated in the MAC CE activation command to update/replace the second TCI state/pair of TCI states or the TCI state/pair of TCI states with the highest TCI state ID among the M=2 (or N=2) TCI states/pairs of TCI states indicated in the DCI. For this design example, the one-bit flag indicator could also correspond to a CORESETPoolIndex or a CORESET group index specified according to the examples in the present disclosure.

Yet for another example, a two-bit indicator could be included/indicated/configured in the MAC CE activation command. If the 2-bit indicator is set to “00” (or “01” or “10” or “11”), the UE may apply the M=1 (or N=1) TCI state/pair of TCI states indicated in the MAC CE command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. If the 2-bit indicator is set to “01” (or “00” or “10” or “11”), the UE may apply the M=1 (or N=1) TCI state/pair of TCI states indicated in the MAC CE command to update/replace one of the M=2 (or N=2) TCI states/pairs of TCI states indicated in the DCI. If the 2-bit indicator is set to “10” (or “00” or “01” or “11”), the UE may apply the M=1 (or N=1) TCI state/pair of TCI states indicated in the MAC CE command to update/replace the first TCI state/pair of TCI states or the TCI state/pair of TCI states with the lowest TCI state ID among the M=2 (or N=2) TCI states/pairs of TCI states indicated in the DCI. If the 2-bit indicator is set to “11” (or “00” or “01” or “10”), the UE may apply the M=1 (or N=1) TCI state/pair of TCI states indicated in the MAC CE command to update/replace the second TCI state/pair of TCI states or the TCI state/pair of TCI states with the highest TCI state ID among the M=2 (or N=2) TCI states/pairs of TCI states indicated in the DCI.

Yet for another example, a bitmap could be included/indicated/configured in the MAC CE activation command. The bitmap could be used to indicate to the UE which one of the M=2 (or N=2) TCI states/pairs of TCI states indicated in the DCI may be replaced/updated by the M=1 (or N=1) TCI state/pair of TCI states indicated in the MAC CE activation command. In this example, the bitmap has two entries/bit positions. When the first one-bit flag indicator is set to “0” (or “1”) according to the above discussions or the bitmap is not configured/enabled, the UE may apply the M=1 (or N=1) TCI state/pair of TCI states indicated in the MAC CE command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. Otherwise, when the first one-bit flag indicator is set to “1” (or “0”) according to the above discussions or the bitmap is configured/enabled: if the first entry/bit position of the bitmap is set to “1,” the UE may apply the M=1 (or N=1) TCI state/pair of TCI states indicated in the MAC CE command to update/replace the first (or second) TCI state/pair of TCI states or the TCI state/pair of TCI states with the lowest (or highest) TCI state ID among the M=2 (or N=2) TCI states/pairs of TCI states indicated in the DCI, and if the second entry/bit position of the bitmap is set to “1,” the UE may apply the M=1 (or N=1) TCI state/pair of TCI states indicated in the MAC CE command to update/replace the second (or first) TCI state/pair of TCI states or the TCI state/pair of TCI states with the highest (or lowest) TCI state ID among the M=2 (or N=2) TCI states/pairs of TCI states indicated in the DCI.

In the present disclosure, the UE could be indicated by the network, e.g., via higher layer RRC signaling and/or MAC CE command and/or dynamic DCI based signaling, whether a single TCI field (e.g., the existing ‘Transmission Configuration Indication’ field) is configured in the DCI (e.g., DCI format 1_1 or 1_2 with or without downlink assignment) to indicate the M=2 (or N=2) TCI states/pairs of TCI states or two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions.

Alternatively, if one or more of the following conditions are satisfied/achieved, the UE could (implicitly) know/expect/assume that two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions; otherwise, the UE could (implicitly) know/expect/assume that a single TCI field (e.g., the existing “transmission configuration indication” field) is configured in the DCI (e.g., DCI format 1_1 or 1_2 with or without downlink assignment) to indicate the M=2 (or N=2) TCI states/pairs of TCI states.

In one example, separate (e.g., M=2 or N=2) pools/lists/groups of TCI states are higher layer RRC configured to the UE.

In one example, a single pool/list/group of TCI states are higher layer RRC configured to the UE, and the size of the pool/list/group of TCI states or the number of TCI states in the pool/list/group is greater (or smaller) than a threshold, wherein the threshold could be (i) fixed, e.g., in the system specifications, and (ii) configured to the UE via higher layer RRC signaling and/or MAC CE command and/or dynamic DCI based signaling.

In one example, the UE receives from the network a MAC CE subselection/activation command activating two sets of TCI state codepoints. Or the UE receives from the network a first MAC CE subselection/activation command activating a first set of Nc1≥1 (e.g., 8, 16, 32 or 64) TCI state codepoints, and a second MAC CE subselection/activation command activating a second set of Nc2≥1 (e.g., 8, 16, 32 or 64) TCI state codepoints.

In one example, the DCI format for beam indication does not indicate/carry downlink PDSCH assignment.

In one example, the DCI format for beam indication also indicates/carriers downlink PDSCH assignment.

In one example, the number of TCI state codepoints activated by a MAC CE (e.g., Nc, Nc1 or Nc2 as discussed above in the present disclosure) or the total number of TCI state codepoints (e.g., Nc1+Nc2 as discussed above in the present disclosure) activated by one or more MAC CEs is greater (or smaller) than a threshold, wherein the threshold could be (i) fixed, e.g., in the system specifications, and (ii) configured to the UE via higher layer RRC signaling and/or MAC CE command and/or dynamic DCI based signaling.

Optionally, if one or more of the following conditions are satisfied/achieved, the UE could (implicitly) know/expect/assume that a single TCI field (e.g., the existing ‘Transmission Configuration Indication’ field) is configured in the DCI (e.g., DCI format 1_1 or 1_2 with or without downlink assignment) to indicate the M=2 (or N=2) TCI states/pairs of TCI states; otherwise, the UE could (implicitly) know/expect/assume that two separate TCI fields (e.g., the first TCI field/TCI field 1 and the second TCI field/TCI field 2 as discussed above) are configured in the DCI (e.g., DCI format 1_1 or 1_2 with or without downlink assignment) to respectively indicate the M=2 (or N=2) TCI states/pairs of TCI states according to the above discussions.

In one example, separate (e.g., M=2 or N=2) pools/lists/groups of TCI states are higher layer RRC configured to the UE.

In one example, a single pool/list/group of TCI states are higher layer RRC configured to the UE, and the size of the pool/list/group of TCI states or the number of TCI states in the pool/list/group is smaller (or greater) than a threshold, wherein the threshold could be (i) fixed, e.g., in the system specifications, and (ii) configured to the UE via higher layer RRC signaling and/or MAC CE command and/or dynamic DCI based signaling.

In one example, the UE receives from the network a MAC CE subselection/activation command activating two sets of TCI state codepoints. Or the UE receives from the network a first MAC CE subselection/activation command activating a first set of Nc1≥1 (e.g., 8, 16, 32 or 64) TCI state codepoints, and a second MAC CE subselection/activation command activating a second set of Nc2≥1 (e.g., 8, 16, 32 or 64) TCI state codepoints.

In one example, the UE receives from the network a MAC CE subselection/activation command activating a single set of Nc≥1 (e.g., 8, 16, 32 or 64) TCI state codepoints.

In one example, the DCI format for beam indication does not indicate/carry downlink PDSCH assignment.

In one example, the DCI format for beam indication also indicates/carriers downlink PDSCH assignment.

In one example, the number of TCI state codepoints activated by a MAC CE (e.g., Nc, Nc1 or Nc2 as discussed above in the present disclosure) or the total number of TCI state codepoints (e.g., Nc1+Nc2 as discussed above in the present disclosure) activated by one or more MAC CEs is smaller (or greater) than a threshold, wherein the threshold could be (i) fixed, e.g., in the system specifications, and (ii) configured to the UE via higher layer RRC signaling and/or MAC CE command and/or dynamic DCI based signaling.

In one example, a one-bit flag indicator or NDI is indicated in the DCI for beam indication (e.g., DCI format 1_1 or 1_2 with or without downlink assignment) to indicate the association/mapping between the TCI field(s) and a set of TCI state codepoints activated by the MAC CE(s) or a TRP as discussed in the examples in the present disclosure.

As discussed above, a UE could receive in a DCI (e.g., DCI format 1_1 or 1_2 with or without DL assignment) M>1 (or N>1) TCI states/pairs of TCI states indicated/updated for the multi-TRP operation. In one embodiment of this disclosure, the DCI format for beam indication could also include/indicate one or more (e.g., M>1 or N>1) CORESET IDs, each associated with an indicated TCI state/pair of TCI states. For example, the one or more (e.g., M>1 or N>1) CORESET IDs could be indicated by a DCI field “CORESET IDs for beam indication” in the corresponding DCI format. For another example, the one or more (e.g., M>1 or N>1) CORESET IDs could be indicated by repurposing one or more bits of one or more existing/reserved DCI fields in the corresponding DCI format. When the one or more CORESET IDs are indicated in the DCI format for beam indication, the UE could apply an indicated TCI state/pair of TCI states associated with a CORESET ID for receiving a PDCCH candidate in the CORESET associated with the same CORESET ID.

In one example, in the DCI format for beam indication, the first indicated CORESET ID among the indicated M>1 (or N>1) CORESET IDs could be associated with the first (or last) indicated TCI state/pair of TCI states among the indicated M>1 (or N>1) TCI states/pairs of TCI states, the second indicated CORESET ID among the indicated M>1 (or N>1) CORESET IDs could be associated with the second (or second last) indicated TCI state/pair of TCI states among the indicated M>1 (or N>1) TCI states/pairs of TCI states, and so on, and the last indicated CORESET ID among the indicated M>1 (or N>1) CORESET IDs could be associated with the last (or first) indicated TCI state/pair of TCI states among the indicated M>1 (or N>1) TCI states/pairs of TCI states. For M=2 (or N=2), the first indicated CORESET ID could be associated with the first (or second) indicated TCI state/pair of TCI states, and the second indicated CORESET ID could be associated with the second (or first) indicated TCI state/pair of TCI states.

In another example, in the DCI format for beam indication, the lowest (or highest) CORESET ID among the indicated M>1 (or N>1) CORESET IDs could be associated with the first indicated TCI state/pair of TCI states among the indicated M>1 (or N>1) TCI states/pairs of TCI states, the second lowest (or second highest) CORESET ID among the indicated M>1 (or N>1) CORESET IDs could be associated with the second indicated TCI state/pair of TCI states among the indicated M>1 (or N>1) TCI states/pairs of TCI states, and so on, and the highest (or lowest) CORESET ID among the indicated M>1 (or N>1) CORESET IDs could be associated with the last indicated TCI state/pair of TCI states among the indicated M>1 (or N>1) TCI states/pairs of TCI states. For M=2 (or N=2), the lowest (or highest) CORESET ID could be associated with the first indicated TCI state/pair of TCI states, and the highest (or lowest) CORESET ID could be associated with the second indicated TCI state/pair of TCI states.

In yet another example, in the DCI format for beam indication, the first indicated CORESET ID among the indicated M>1 (or N>1) CORESET IDs could be associated with the TCI state/pair of TCI states having the lowest (or highest) TCI state ID among the indicated M>1 (or N>1) TCI states/pairs of TCI states, the second indicated CORESET ID among the indicated M>1 (or N>1) CORESET IDs could be associated with the TCI state/pair of TCI states having the second lowest (or second highest) TCI state ID among the indicated M>1 (or N>1) TCI states/pairs of TCI states, and so on, and the last indicated CORESET ID among the indicated M>1 (or N>1) CORESET IDs could be associated with the TCI state/pair of TCI states having the highest (or lowest) TCI state ID among the indicated M>1 (or N>1) TCI states/pairs of TCI states. For M=2 (or N=2), the first indicated CORESET ID could be associated with the TCI state/pair of TCI states having the lowest (or highest) TCI state ID, and the second indicated CORESET ID could be associated with the TCI state/pair of TCI states having the highest (or lowest) TCI state ID.

In yet another example, in the DCI format for beam indication, the lowest CORESET ID among the indicated M>1 (or N>1) CORESET IDs could be associated with the TCI state/pair of TCI states having the lowest (or highest) TCI state ID among the indicated M>1 (or N>1) TCI states/pairs of TCI states, the second lowest CORESET ID among the indicated M>1 (or N>1) CORESET IDs could be associated with the TCI state/pair of TCI states having the second lowest (or second highest) TCI state ID among the indicated M>1 (or N>1) TCI states/pairs of TCI states, and so on, and the highest CORESET ID among the indicated M>1 (or N>1) CORESET IDs could be associated with the TCI state/pair of TCI states having the highest (or lowest) TCI state ID among the indicated M>1 (or N>1) TCI states/pairs of TCI states. For M=2 (or N=2), the lowest CORESET ID could be associated with the TCI state/pair of TCI states having the lowest (or highest) TCI state ID, and the highest CORESET ID could be associated with the TCI state/pair of TCI states having the highest (or lowest) TCI state ID.

In a multi-TRP system, a UE would receive two PDCCH candidates (denoted by a first PDCCH candidate and a second PDCCH candidate) from two respective search space sets linked via higher layer configuration (e.g., by a RRC parameter SearchSpaceLinking), wherein the two search space sets are in two CORESETs. As discussed above, the UE could receive in a DCI (e.g., DCI format 1_1 or 1_2 with or without DL assignment) M=2 TCI states indicated by a TCI state codepoint of a TCI field or separate TCI fields. For this case, the UE could apply a first TCI state out of the indicated M=2 TCI states to receive the first PDCCH candidate in a first CORESET, and a second TCI state out of the indicated M=2 TCI states to receive the second PDCCH candidate in a second CORESET, wherein the first TCI state could be associated with the first CORESET, and the second TCI state could be associated with the second CORESET, following those specified in the examples in the present disclosure.

In one example, the UE could apply the first (or second) indicated TCI state to receive the first or second PDCCH candidate in a CORESET with the lowest CORESET ID, and the second (or first) indicated TCI state to receive the first or second PDCCH candidate in a CORESET with the highest CORESET ID.

In another example, the UE could apply the indicated TCI state with the lowest (or highest) TCI state ID to receive the first or second PDCCH candidate in a CORESET with the lowest CORESET ID, and the indicated TCI state with the highest (or lowest) TCI state ID to receive the first or second PDCCH candidate in a CORESET with the highest CORESET ID.

In yet another example, the UE could apply the first (or second) indicated TCI state to receive the first or second PDCCH candidate that starts earlier in time, and the second (or first) indicated TCI state to receive the first or second PDCCH candidate that starts later in time.

In yet another example, the UE could apply the indicated TCI state with the lowest (or highest) TCI state ID to receive the first or second PDCCH candidate that starts earlier in time, and the indicated TCI state with the highest (or lowest) TCI state ID to receive the first or second PDCCH candidate that starts later in time.

In another embodiment of this disclosure, a UE could be provided by the network (e.g., in PDCCH-Config) different values (e.g., two - “0” and “1”) of CORESET group index, wherein one or more CORESETs could be associated/configured with the same CORESET group index value.

For example, the UE could be configured by the network (e.g., via higher layer RRC signaling) the association/mapping relationship between different values of CORESET group index and one or more CORESETs. For instance, for each value of CORESET group index (e.g., 0 or 1), the UE could be higher layer configured by the network a list of CORESET IDs associated with the corresponding CORESET group index value.

For another example, a CORESET group index value, e.g., provided by higher layer parameter CORESETGroupIndex, could be included/indicated in the higher layer parameter ControlResourceSet that configures a CORESET.

In a multi-TRP system, a UE could receive in a DCI (e.g., DCI format 1_1 or 1_2 with or without DL assignment) - in a CORESET associated with a value of CORESET group index according to those specified in the examples in the present disclosure - M>1 (or N>1) TCI states/pairs of TCI states by a TCI state codepoint of a TCI field or separate TCI fields. For M=2 (or N=2), if the CORESET group index value is “0” (or “1”), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the CORESET group index value is “1” (or “0”), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

Alternatively, a one-bit flag indicator could be included/indicated in the higher layer parameter ControlResourceSet that configures a CORESET. In a multi-TRP system, a UE could receive in a DCI (e.g., DCI format 1_1 or 1_2 with or without DL assignment) - in a CORESET configured with the one-bit flag indicator - M>1 (or N>1) TCI states/pairs of TCI states by a TCI state codepoint of a TCI field or separate TCI fields. For M=2 (or N=2), if the one-bit flag indicator is set to “0” (or “1”), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the one-bit flag indicator is set to “1” (or “0”), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

Optionally, in a multi-TRP system, a UE could receive in a DCI (e.g., DCI format 1_1 or 1_2 with or without DL assignment) M>1 (or N>1) TCI states/pairs of TCI states by a TCI state codepoint of a TCI field or separate TCI fields, wherein the DCI format also includes/indicates/configures a new data indicator (NDI) field. For M=2 (or N=2), if the NDI field is set to “0” (or “1”) or the NDI is toggled (or not toggled), the UE could apply the first indicated TCI state/pair of TCI states or the indicated TCI state/pair of TCI states having the lowest TCI state ID - out of the M=2 (or N=2) indicated TCI states/pairs of TCI states - to receive PDCCH candidate(s) in CORESET(s); if the NDI field is set to “1” (or “0”) or the NDI is not toggled (or toggled), the UE could apply the second indicated TCI state/pair of TCI states or the indicated TCI state/pair of TCI states having the highest TCI state ID - out of the M=2 (or N=2) indicated TCI states/pairs of TCI states - to receive PDCCH candidate(s) in CORESET(s).

As discussed above, a UE could receive in a DCI (e.g., DCI format 1_1 or 1_2 with or without DL assignment) M>1 (or N>1) TCI states/pairs of TCI states indicated by, e.g., a TCI state codepoint of a TCI field or separate TCI fields. Later in time, the UE could be indicated by the network one or more TCI states/pairs of TCI states that update one or more of the previously indicated M>1 (or N>1) TCI states/pairs of TCI states. For instance, for M = 2 (or N=2), following examples can be provided.

In one example, the UE could first receive in a first DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive in a second DCI (e.g., DCI format 1_1 or 1_2 with or without DL assignment) M=1 (or N=1) TCI state/pair of TCI states indicated by, e.g., a TCI state codepoint of a TCI field or separate TCI fields or repurposing one or more bits of one or more existing/reserved DCI fields in the corresponding DCI format.

A first one-bit flag indicator could be used to indicate to the UE whether the (M=1 or N=1) TCI state(s)/pair(s) of TCI states indicated in the corresponding (second) DCI format is for single-TRP operation or to update one of the previously indicated (M=2 or N=2) TCI states/pairs of TCI states in the corresponding (first) DCI format. The first one-bit flag indicator could be included/indicated/configured in a DCI format (e.g., DCI format 1_1 or 1_2 with or without DL assignment for beam indication) by a DCI field “TCI state for single-TRP.”

Alternatively, one or more bits of one or more existing/reserved DCI fields - e.g., a NDI field - could be repurposed/used to indicate the first one-bit flag indicator. For example, if the first one-bit flag indicator is set to “0” (or “1”) or not toggled (or toggled) - when the first one-bit flag indicator is indicated by NDI, the UE would apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format. Otherwise, i.e., if the first one-bit flag indicator is set to “1” (or “0”) or toggled (or not toggled) - when the first one-bit flag indicator is indicated by NDI, the UE would apply the M=1 (or N=1) TCI state/pair of TCI states indicated in the second DCI to update/replace one of the M=2 (or N=2) TCI states/pairs of TCI states indicated in the first DCI.

The first one-bit flag indicator could be applied to one or more of the following design examples.

For example, when the first one-bit flag indicator is set to “1” (or “0”) or toggled (or not toggled) - if the first one-bit flag indicator is indicated by NDI - according to the above discussions, a second one-bit flag indicator could be used to indicate to the UE which one of the M=2 (or N=2) TCI states/pairs of TCI states indicated in the first DCI may be replaced/updated by the M=1 (or N=1) TCI state/pair of TCI states indicated in the second DCI. The second one-bit flag indicator could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields - e.g., a NDI field - could be repurposed/used to indicate the second one-bit flag indicator. If the second one-bit flag indicator is set to “0” (or “1”) or not toggled (or toggled) - when the second one-bit flag indicator is indicated by NDI, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the second one-bit flag indicator is set to “1” (or “0”) or toggled (or not toggled) - when the second one-bit flag indicator is indicated by NDI, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

For another example, a one-bit flag indicator could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields - e.g., a NDI field - could be repurposed/used to indicate the one-bit flag indicator. If the one-bit flag indicator is not configured/enabled, the UE would apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format.

Otherwise, if the one-bit flag indicator is set to “0” (or “1”) or not toggled (or toggled) - when the one-bit flag indicator is indicated by NDI, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the one-bit flag indicator is set to “1” (or “0”) or toggled (not toggled) - when the one-bit flag indicator is indicated by NDI, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI. In FIG. 8, an example of the above discussed signaling flow/procedure is provided.

As illustrated in FIG. 10, in 1001, the UE receives in the first DCI two TCI states TCI state #A and TCI state #B. In 1002, later in time, the UE receives in the second DCI a single TCI state #C. In 1003, the condition of whether the one-bit flag indicator is enabled/configured in the second DCI or not is checked. If the one-bit flag indicator is not enabled/configured, the signaling procedure goes to 1005. Otherwise, the signaling procedure proceeds to 1004. In 1004, the condition of whether the one-bit flag indicator is set to “0” or “1” is checked. If the one-bit flag indicator is set to “1,” the signaling flow goes to 1006. Otherwise, the signaling procedure proceeds to 1007. In 1005, the UE would apply TCI state #C indicated in the second DCI for the single-TRP operation. In 1006, the UE would apply TCI state #C indicated in the second DCI to replace/update TCI state #B indicated in the first DCI. That is, the UE would apply TCI state #A indicated in the first DCI and TCI state #C indicated in the second DCI for the multi-TRP operation. In 1007, the UE would apply TCI state #C indicated in the second DCI to replace/update TCI state #A indicated in the first DCI. That is, the UE would apply TCI state #B indicated in the first DCI and TCI state #C indicated in the second DCI for the multi-TRP operation.

Yet for another example, a two-bit indicator could be included/indicated/configured in a DCI format (e.g., DCI format 1_1 or 1_2 with or without DL assignment for beam indication), e.g., by a DCI field “TCI state indication or update.”

Alternatively, one or more bits of one or more existing/reserved DCI fields could be repurposed/used to indicate the two-bit indicator. If the 2-bit indicator is set to “00” (or “01” or “10” or “11”), the UE would apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format.

If the 2-bit indicator is set to “01” (or “00” or “10” or “11”), the UE may apply the M=1 (or N=1) TCI state/pair of TCI states indicated in the second DCI to update/replace one of the M=2 (or N=2) TCI states/pairs of TCI states indicated in the first DCI. If the 2-bit indicator is set to “10” (or “00” or “01” or “11”), the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the 2-bit indicator is set to “11” (or “00” or “01” or “10”), the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, a UE could receive the second DCI in a CORESET associated with a value of CORESETPoolIndex or a value of CORESET group index according to those specified in the examples in the present disclosure. When the first one-bit flag indicator is set to “1” (or “0”) or toggled (or not toggled) - if the first one-bit flag indicator is indicated by NDI -according to the above discussions: if the UE receives the second DCI in a CORESET associated with value 0 (or 1) of CORESETPoolIndex or value 0 (or 1) of CORESET group index, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; if the UE receives the second DCI in a CORESET associated with value 1 (or 0) of CORESETPoolIndex or value 1 (or 0) of CORESET group index, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, as discussed before, a DCI format (e.g., DCI format 1_1 or 1_2 with or without DL assignment) could indicate/include a first ‘Transmission Configuration Indication’ field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein.

In another example, the first TCI field or the second TCI field could correspond to the existing ‘Transmission Configuration Indication’ field in the DCI format 1_1 or 1_2 (with or without DL assignment). In yet another example, the first TCI field or the second TCI field could be configured by repurposing one or more bits of one or more of the existing/reserved DCI fields in the DCI format 1_1 or 1_2 (with or without DL assignment). For this example, if the M=1 (or N=1) TCI state/pair of TCI states is indicated by the first (or second) TCI field, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the M=1 (or N=1) TCI state/pair of TCI states is indicated by the second (or first) TCI field, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, a bitmap could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields could be repurposed/used to indicate the bitmap. The bitmap could be used to indicate to the UE which one of the M=2 (or N=2) TCI states/pairs of TCI states indicated in the first DCI may be replaced/updated by the M=1 (or N=1) TCI state/pair of TCI states indicated in the second DCI. In this example, the bitmap has two entries/bit positions. When the first one-bit flag indicator is set to “0” (or “1”) or not toggled (or toggled) - if the first one-bit flag indicator is indicated by NDI - according to the above discussions or the bitmap is not configured/enabled, the UE would apply the M=1 (or N=1) TCI state/pair of TCI states indicated in the second DCI for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the second DCI format.

Otherwise, when the first one-bit flag indicator is set to “1” (or “0”) or toggled (or not toggled) - if the first one-bit flag indicator is indicated by NDI - according to the above discussions or the bitmap is configured/enabled: if the first entry/bit position of the bitmap is set to “1,” the UE would apply the M=1 (or N=1) TCI state/pair of TCI states indicated in the second DCI to update/replace the first (or second) TCI state/pair of TCI states or the TCI state/pair of TCI states with the lowest (or highest) TCI state ID among the M=2 (or N=2) TCI states/pairs of TCI states indicated in the first DCI, and if the second entry/bit position of the bitmap is set to “1,” the UE would apply the M=1 (or N=1) TCI state/pair of TCI states indicated in the second DCI to update/replace the second (or first) TCI state/pair of TCI states or the TCI state/pair of TCI states with the highest (or lowest) TCI state ID among the M=2 (or N=2) TCI states/pairs of TCI states indicated in the first DCI. In FIG. 11, an example of the above discussed signaling flow/procedure is provided.

As illustrated in FIG. 11, in 1101, the UE receives in the first DCI two TCI states TCI state #A and TCI state #B. In 1102, later in time, the UE receives in the second DCI a single TCI state #C. In 1103, the condition of whether the bitmap is enabled/configured in the second DCI or not is checked. If the bitmap is not enabled/configured, the signaling procedure goes to 1105. Otherwise, the signaling procedure proceeds to 1104. In 1104, the condition of whether the bitmap is set to “10” is checked. If the bitmap is set to “10,” the signaling flow proceeds to 1107. Otherwise, the signaling procedure goes to 1106. In 1105, the UE would apply TCI state #C indicated in the second DCI for the single-TRP operation. In 1106, if the bitmap is set to “01,” the UE would apply TCI state #C indicated in the second DCI to replace/update TCI state #B indicated in the first DCI. That is, the UE would apply TCI state #A indicated in the first DCI and TCI state #C indicated in the second DCI for the multi-TRP operation. In 1107, the UE would apply TCI state #C indicated in the second DCI to replace/update TCI state #A indicated in the first DCI. That is, the UE would apply TCI state #B indicated in the first DCI and TCI state #C indicated in the second DCI for the multi-TRP operation.

For this design example, the M=2 (or N=2) TCI states/pairs of TCI states indicated in the first DCI could be selected from Nc≥1 (e.g., Nc=8, 16, 32 and etc.) TCI state codepoints activated by a first MAC CE activation command, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc could be (1) fixed, e.g., in the system specifications or (2) provided by the network via higher layer RRC signaling and/or MAC CE command and/or dynamic DCI based signaling.

In one example, the M=1 (or N=1) TCI state/pair of TCI states indicated in the second DCI could correspond to a joint DL and UL TCI state or a pair of separate DL and UL TCI states of a TCI state codepoint activated by the first MAC CE command. For this example, the UE would follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In another example, the M=1 (or N=1) TCI state/pair of TCI states indicated in the second DCI could correspond to a TCI state/pair of TCI states selected as the first TCI state/pair of TCI states or the TCI state/pair of TCI states with the lowest TCI state ID among M=2 (or N=2) TCI states/pairs of TCI states of a TCI state codepoint activated by the first MAC CE command, or correspond to the second TCI state/pair of TCI states or the TCI state/pair of TCI states with the highest TCI state ID among M=2 (or N=2) TCI states/pairs of TCI states of a TCI state codepoint activated by the first MAC CE command.

For example, if the selected TCI state/pair of TCI states - as the M=1 (or N=1) TCI state/pair of TCI states indicated in the second DCI - has the same TCI state ID as one or more TCI states/pairs of TCI states of one or more TCI state codepoints activated by the first MAC CE command, the UE would follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

For another example, if the selected TCI state/pair of TCI states - as the M=1 (or N=1) TCI state/pair of TCI states indicated in the second DCI - has a different TCI state ID from any of the TCI states/pairs of TCI states of all the TCI state codepoints activated by the first MAC CE command: if the M=1 (or N=1) TCI state/pair of TCI states indicated in the second DCI corresponds to the first (or second) TCI state/pair of TCI states or the TCI state/pair of TCI states with the lowest (or highest) TCI state ID among M=2 (or N=2) TCI states/pairs of TCI states of a TCI state codepoint activated by the first MAC CE command, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; else, if the M=1 (or N=1) TCI state/pair of TCI states indicated in the second DCI corresponds to the second (or first) TCI state/pair of TCI states or the TCI state/pair of TCI states with the highest (or lowest) TCI state ID among M=2 (or N=2) TCI states/pairs of TCI states of a TCI state codepoint activated by the first MAC CE command, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, the UE could be first indicated by the network whether the selected TCI state/pair of TCI states - as the M=1 (or N=1) TCI state/pair of TCI states indicated in the second DCI - corresponds the first TCI state/pair of TCI states or the TCI state/pair of TCI states with the lowest TCI state ID among M=2 (or N=2) TCI states/pairs of TCI states of a TCI state codepoint activated by the first MAC CE command, or corresponds to the second TCI state/pair of TCI states or the TCI state/pair of TCI states with the highest TCI state ID among M=2 (or N=2) TCI states/pairs of TCI states of a TCI state codepoint activated by the first MAC CE command (in case that the selected TCI state/pair of TCI states - as the M=1 (or N=1) TCI state/pair of TCI states indicated in the second DCI - has the same TCI state ID as one or more TCI states/pairs of TCI states of one or more TCI state codepoints activated by the first MAC CE command).

According to the network’s indication, if the M=1 (or N=1) TCI state/pair of TCI states indicated in the second DCI corresponds to the first (or second) TCI state/pair of TCI states or the TCI state/pair of TCI states with the lowest (or highest) TCI state ID among M=2 (or N=2) TCI states/pairs of TCI states of a TCI state codepoint activated by the first MAC CE command, the UE would apply the M=1 (or N=1) TCI state/pair of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; else, if the M=1 (or N=1) TCI state/pair of TCI states indicated in the second DCI corresponds to the second (or first) TCI state/pair of TCI states or the TCI state/pair of TCI states with the highest (or lowest) TCI state ID among M=2 (or N=2) TCI states/pairs of TCI states of a TCI state codepoint activated by the first MAC CE command, the UE would apply the M=1 (or N=1) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

In yet another example, the M=1 (or N=1) TCI state/pair of TCI states indicated in the second DCI could be selected from Nc′≥1 (e.g., Nc′=8, 16, 32 and etc.) TCI state codepoints activated by a MAC CE activation command different from the first MAC CE command, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc′ could be (1) fixed, e.g., in the system specifications or (2) provided by the network via higher layer RRC signaling and/or MAC CE command and/or dynamic DCI based signaling. For this example, the UE would follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

Alternatively, the first (or second) TCI state/pair of TCI states or the TCI state/pair of TCI states with the lowest (or highest) TCI state ID among the M=2 (or N=2) TCI states/pairs of TCI states indicated in the first DCI could be selected from Nc1≥1 (e.g., Nc1=8, 16, 32 and etc.) TCI state codepoints activated by a first MAC CE activation command, and the second (or first) TCI state/pair of TCI states or the TCI state/pair of TCI states with the highest (or lowest) TCI state ID among the M=2 (or N=2) TCI states/pairs of TCI states indicated in the first DCI could be selected from Nc2≥1 (e.g., Nc2=8, 16, 32 and etc.) TCI state codepoints activated by a second MAC CE activation command, where an activated TCI state codepoint in the first or second MAC CE commands could correspond to a joint DL and UL TCI state, a pair of separate DL and UL TCI states, M=2 (or N=2) joint DL and UL TCI states or pairs of separate DL and UL TCI states. The M=1 (or N=1) TCI state/pair of TCI states indicated in the second DCI could correspond to a joint DL and UL TCI state or a pair of separate DL and UL TCI states of a TCI state codepoint activated by the first MAC CE command, or a joint DL and UL TCI state or a pair of separate DL and UL TCI states of a TCI state codepoint activated by the second MAC CE command.

In the present disclosure, the number/value of Nc1 or Nc2 could be (1) fixed, e.g., in the system specifications or (2) provided by the network via higher layer RRC signaling and/or MAC CE command and/or dynamic DCI based signaling.

In one example, if the M=1 (or N=1) TCI state/pair of TCI states indicated in the second DCI corresponds to a joint DL and UL TCI state or a pair of separate DL and UL TCI states of a TCI state codepoint activated by the first MAC CE command, the UE would apply the M=1 (or N=1) TCI state/pair of TCI states indicated in the second DCI to update/replace the first (or second) TCI state/pair of TCI states or the TCI state/pair of TCI states with the lowest (or highest) TCI state ID among the M=2 (or N=2) TCI states/pairs of TCI states indicated in the first DCI; if the M=1 (or N=1) TCI state/pair of TCI states indicated in the second DCI corresponds to a joint DL and UL TCI state or a pair of separate DL and UL TCI states of a TCI state codepoint activated by the second MAC CE command, the UE would apply the M=1 (or N=1) TCI state/pair of TCI states indicated in the second DCI to update/replace the second (or first) TCI state/pair of TCI states or the TCI state/pair of TCI states with the highest (or lowest) TCI state ID among the M=2 (or N=2) TCI states/pairs of TCI states indicated in the first DCI.

In another example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In yet another example, the M=1 (or N=1) TCI state/pair of TCI states indicated in the second DCI could be selected from Nc′≥1 (e.g., Nc′=8, 16, 32 and etc.) TCI state codepoints activated by a MAC CE activation command different from the first and second MAC CE commands, where an activated TCI state codepoint could correspond to a joint DL and UL TCI state, a pair of separate DL and UL TCI states, M=2 (or N=2) joint DL and UL TCI states or pairs of separate DL and UL TCI states, and the number/value of Nc′ could be (1) fixed, e.g., in the system specifications or (2) provided by the network via higher layer RRC signaling and/or MAC CE command and/or dynamic DCI based signaling. For this example, the UE may follow the examples of the present disclosure to determine which one of the M=2 (or N=2) TCI states/pairs of TCI states indicated in the first DCI may be replaced/updated by the M=1 (or N=1) TCI state/pair of TCI states indicated in the second DCI.

In another example, the UE could first receive in a first DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive in a second DCI (e.g., DCI format 1_1 or 1_2 with or without DL assignment) M=2 (or N=2) TCI state/pair of TCI states indicated by, e.g., a TCI state codepoint of a TCI field or separate TCI fields or repurposing one or more bits of one or more existing/reserved DCI fields in the corresponding DCI format.

For example, a one-bit flag indicator could be used to indicate to the UE which one of the M=2 (or N=2) TCI states/pairs of TCI states indicated in the first DCI may be replaced/updated by one of the M=2 (or N=2) TCI states/pairs of TCI states indicated in the second DCI. The one-bit flag indicator could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields — e.g., a NDI field — could be repurposed/used to indicate the one-bit flag indicator. If the one-bit flag indicator is set to “0” (or “1”) or not toggled (or toggled) — when the one-bit flag indicator is indicated by NDI, the UE would apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI. If the one-bit flag indicator is set to “1” (or “0”) or toggled (or not toggled) — when the one-bit flag indicator is indicated by NDI, the UE would apply the second (or first) TCI state/pair of TCI states or the TCI state/pair of TCI states with the highest (or lowest) TCI state ID among the M=2 (or N=2) TCI states/pairs of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

For another example, a UE could receive the second DCI in a CORESET associated with a value of CORESETPoolIndex or a value of CORESET group index according to those specified in the examples in the present disclosure. If the UE receives the second DCI in a CORESET associated with value 0 (or 1) of CORESETPoolIndex or value 0 (or 1) of CORESET group index, the UE would apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI; if the UE receives the second DCI in a CORESET associated with value 1 (or 0) of CORESETPoolIndex or value 1 (or 0) of CORESET group index, the UE would apply the second (or first) TCI state/pair of TCI states or the TCI state/pair of TCI states with the highest (or lowest) TCI state ID among the M=2 (or N=2) TCI state/pair of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

Yet for another example, a bitmap could be included/indicated/configured in a DCI format (e.g., DCI format 1_1 or 1_2 with or without DL assignment for beam indication), e.g., by a DCI field “TCI state update for multi-TRP.”

Alternatively, one or more bits of one or more existing/reserved DCI fields could be repurposed/used to indicate the bitmap. The bitmap could be used to indicate to the UE which one of the M=2 (or N=2) TCI states/pairs of TCI states indicated in the first DCI may be replaced/updated by one of the M=2 (or N=2) TCI states/pairs of TCI states indicated in the second DCI. In this example, the bitmap has two entries/bit positions. If the first (or second) entry/bit position of the bitmap is set to “1,” the UE would apply the first (or second) TCI state/pair of TCI states or the TCI state/pair of TCI states with the lowest (or highest) TCI state ID among the M=2 (or N=2) TCI states/pairs of TCI states indicated in the second DCI to update/replace the first TCI state/pair of TCI states or the TCI state/pair of TCI states with the lowest TCI state ID among the M=2 (or N=2) TCI states/pairs of TCI states indicated in the first DCI, and if the second (or first) entry/bit position of the bitmap is set to “1,” the UE may apply the second (or first) TCI state/pair of TCI states and the TCI state/pair of TCI states with the highest (or lowest) TCI state ID among the M=2 (or N=2) TCI states/pairs of TCI states indicated in the second DCI to update/replace the second TCI state/pair of TCI states or the TCI state/pair of TCI states with the highest TCI state ID among the M=2 (or N=2) TCI states/pairs of TCI states indicated in the first DCI.

In yet another example, as discussed before, a DCI format (e.g., DCI format 1_1 or 1_2 with or without DL assignment) could indicate/include a first ‘Transmission Configuration Indication’ field (or denoted by a first TCI field or TCI field 1) indicating a first TCI state codepoint, and a second “transmission configuration indication” field (denoted by a second TCI field or TCI field 2) indicating a second TCI state codepoint. In one example, the first TCI field or the second TCI field could be a new and dedicated TCI field added/configured in the DCI format 1_1 or 1_2 (with or without DL assignment), which is different from the existing DCI fields configured therein. In another example, the first TCI field or the second TCI field could correspond to the existing “transmission configuration indication” field in the DCI format 1_1 or 1_2 (with or without DL assignment).

In yet another example, the first TCI field or the second TCI field could be configured by repurposing one or more bits of one or more of the existing/reserved DCI fields in the DCI format 1_1 or 1_2 (with or without DL assignment). The first TCI state codepoint of the first TCI field could be selected/determined from Nel≥1 (e.g., Nc1=8, 16, 32 and etc.) TCI state codepoints activated by a first MAC CE activation command, wherein an activated TCI state codepoint could correspond to a joint DL and UL TCI state, a pair of separate DL and UL TCI states, M=2 (or N=2) joint DL and UL TCI states or pairs of separate DL and UL TCI states; and the first TCI state codepoint of the second TCI field could be selected/determined from Nc2≥1 (e.g., Nc2=8, 16, 32 and etc.) TCI state codepoints activated by a second MAC CE activation command, wherein an activated TCI state codepoint could correspond to a joint DL and UL TCI state, a pair of separate DL and UL TCI states, M=2 (or N=2) joint DL and UL TCI states or pairs of separate DL and UL TCI states. In the present disclosure, the number/value of Nc1 or Nc2 could be (1) fixed, e.g., in the system specifications or (2) provided by the network via higher layer RRC signaling and/or MAC CE command and/or dynamic DCI based signaling.

For example, the first TCI state codepoint of the first TCI field indicated by a first DCI is different from the first TCI state codepoint of the first TCI field indicated by a second DCI; while the second TCI state codepoint of the second TCI field indicated by the first DCI is the same as the second TCI state codepoint of the second TCI field indicated by the second DCI. The second DCI could be received later in time than the first DCI, e.g., the first DCI is the previous DCI received in time with respect to the second DCI.

For another example, the first TCI state codepoint of the first TCI field indicated by a first DCI is the same as the first TCI state codepoint of the first TCI field indicated by a second DCI; while the second TCI state codepoint of the second TCI field indicated by the first DCI is different from the second TCI state codepoint of the second TCI field indicated by the second DCI. The second DCI could be received later in time than the first DCI, e.g., the first DCI is the previous DCI received in time with respect to the second DCI.

Yet for another example, the first TCI state codepoint of the first TCI field indicated by a first DCI is different from the first TCI state codepoint of the first TCI field indicated by a second DCI; and the second TCI state codepoint of the second TCI field indicated by the first DCI is different from the second TCI state codepoint of the second TCI field indicated by the second DCI as well. The second DCI could be received later in time than the first DCI, e.g., the first DCI is the previous DCI received in time with respect to the second DCI.

In yet another example, the UE could first receive in a DCI (e.g., DCI format 1_1 or 1_2 with or without DL assignment) M=2 (or N=2) TCI states/pairs of TCI states indicated by, e.g., a TCI state codepoint of a TCI field or separate TCI fields or repurposing one or more bits of one or more existing/reserved DCI fields in the corresponding DCI format. Later in time, the UE could receive a MAC CE indicating M=1 (or N=1) TCI state/pair of TCI states — selected/activated from one or more lists/pools of RRC configured TCI states/pairs of TCI states — to update one of the M=2 (N=2) TCI states/pairs of TCI states indicated in the DCI. A first one-bit flag indicator could be included/indicated/configured in the MAC CE activation command to indicate to the UE whether the (M=1 or N=1) TCI state(s)/pair(s) of TCI states indicated in the MAC CE activation command is for single-TRP operation or to update one of the previously indicated (M=2 or N=2) TCI states/pairs of TCI states in the corresponding DCI format. For example, if the first one-bit flag indicator is set to “0” (or “1”), the UE would apply the M=1 (or N=1) TCI state/pair of TCI states indicated in the MAC CE activation command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. Otherwise, i.e., if the first one-bit flag indicator is set to “1” (or “0”), the UE would apply the M=1 (or N=1) TCI state/pair of TCI states indicated in the MAC CE command to update/replace one of the M=2 (or N=2) TCI states/pairs of TCI states indicated in the DCI. The first one-bit flag indicator could be applied to one or more of the following design examples.

For example, when the first one-bit flag indicator is set to “1” (or “0”) according to the above discussions, a second one-bit flag indicator could be included/indicated/configured in the MAC CE activation command to indicate to the UE which one of the M=2 (or N=2) TCI states/pairs of TCI states indicated in the DCI may be replaced/updated by the M=1 (or N=1) TCI state/pair of TCI states indicated in the MAC CE activation command. If the second one-bit flag indicator is set to “0” (or “1”), the UE would apply the M=1 (or N=1) TCI state/pair of TCI states indicated in the MAC CE activation command to update/replace the first TCI state/pair of TCI states or the TCI state/pair of TCI states with the lowest TCI state ID among the M=2 (or N=2) TCI states/pairs of TCI states indicated in the DCI. If the second one-bit flag indicator is set to “1” (or “0”), the UE would apply the M=1 (or N=1) TCI state/pair of TCI states indicated in the MAC CE activation command to update/replace the second TCI state/pair of TCI states or the TCI state/pair of TCI states with the highest TCI state ID among the M=2 (or N=2) TCI states/pairs of TCI states indicated in the DCI. For this design example, the second one-bit flag indicator could also correspond to a CORESETPoolIndex or a CORESET group index specified according to the examples in the present disclosure.

For another example, a one-bit flag indicator could be included/indicated/configured in the MAC CE activation command. If the one-bit flag indicator is not configured/enabled in the MAC CE command, the UE would apply the M=1 (or N=1) TCI state/pair of TCI states indicated in the MAC CE activation command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command.

Otherwise, if the one-bit flag indicator is set to “0” (or “1”), the UE would apply the M=1 (or N=1) TCI state/pair of TCI states indicated in the MAC CE activation command to update/replace the first TCI state/pair of TCI states or the TCI state/pair of TCI states with the lowest TCI state ID among the M=2 (or N=2) TCI states/pairs of TCI states indicated in the DCI. If the one-bit flag indicator is set to “1” (or “0”), the UE would apply the M=1 (or N=1) TCI state/pair of TCI states indicated in the MAC CE activation command to update/replace the second TCI state/pair of TCI states or the TCI state/pair of TCI states with the highest TCI state ID among the M=2 (or N=2) TCI states/pairs of TCI states indicated in the DCI. For this design example, the one-bit flag indicator could also correspond to a CORESETPoolIndex or a CORESET group index specified according to the examples in the present disclosure.

Yet for another example, a two-bit indicator could be included/indicated/configured in the MAC CE activation command. If the 2-bit indicator is set to “00” (or “01” or “10” or “11”), the UE would apply the M=1 (or N=1) TCI state/pair of TCI states indicated in the MAC CE command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command. If the 2-bit indicator is set to “01” (or “00” or “10” or “11”), the UE may apply the M=1 (or N=1) TCI state/pair of TCI states indicated in the MAC CE command to update/replace one of the M=2 (or N=2) TCI states/pairs of TCI states indicated in the DCI. If the 2-bit indicator is set to “10” (or “00” or “01” or “11”), the UE would apply the M=1 (or N=1) TCI state/pair of TCI states indicated in the MAC CE command to update/replace the first TCI state/pair of TCI states or the TCI state/pair of TCI states with the lowest TCI state ID among the M=2 (or N=2) TCI states/pairs of TCI states indicated in the DCI. If the 2-bit indicator is set to “11” (or “00” or “01” or “10”), the UE would apply the M=1 (or N=1) TCI state/pair of TCI states indicated in the MAC CE command to update/replace the second TCI state/pair of TCI states or the TCI state/pair of TCI states with the highest TCI state ID among the M=2 (or N=2) TCI states/pairs of TCI states indicated in the DCI.

Yet for another example, a bitmap could be included/indicated/configured in the MAC CE activation command. The bitmap could be used to indicate to the UE which one of the M=2 (or N=2) TCI states/pairs of TCI states indicated in the DCI may be replaced/updated by the M=1 (or N=1) TCI state/pair of TCI states indicated in the MAC CE activation command. In this example, the bitmap has two entries/bit positions. When the first one-bit flag indicator is set to “0” (or “1”) according to the above discussions or the bitmap is not configured/enabled, the UE would apply the M=1 (or N=1) TCI state/pair of TCI states indicated in the MAC CE command for the single-TRP operation, i.e., for all UE-dedicated reception on PDSCH/PDCCH, or dynamic-grant/configured-grant based PUSCH and all of dedicated PUCCH resources, or other channels/signals higher layer configured to follow/share the TCI state/pair of TCI states indicated in the MAC CE command.

Otherwise, when the first one-bit flag indicator is set to “1” (or “0”) according to the above discussions or the bitmap is configured/enabled: if the first entry/bit position of the bitmap is set to “1,” the UE would apply the M=1 (or N=1) TCI state/pair of TCI states indicated in the MAC CE command to update/replace the first (or second) TCI state/pair of TCI states or the TCI state/pair of TCI states with the lowest (or highest) TCI state ID among the M=2 (or N=2) TCI states/pairs of TCI states indicated in the DCI, and if the second entry/bit position of the bitmap is set to “1,” the UE would apply the M=1 (or N=1) TCI state/pair of TCI states indicated in the MAC CE command to update/replace the second (or first) TCI state/pair of TCI states or the TCI state/pair of TCI states with the highest (or lowest) TCI state ID among the M=2 (or N=2) TCI states/pairs of TCI states indicated in the DCI.

Throughout the present disclosure, unless otherwise specified, a TCI state could correspond a joint TCI state, a DL TCI state, an UL TCI state, or a pair of two TCI states each corresponding to a joint TCI state or a DL TCI state or an UL TCI state.

In one embodiment, the UE could be configured/provided/indicated, e.g., via higher layer RRC signaling and/or MAC CE command and/or dynamic DCI based L1 signaling, M≥1 or N ≥ 1 (e.g., M=2 or N=2) groups/lists of TCI states or TCI state IDs with each group/list comprising/containing/including one or more TCI states or TCI state IDs. The bitwidth of the TCI state ID in each group/list could be determined according to the total number of TCI states/TCI state IDs in the corresponding group/list. Alternatively, the bitwidth of the TCI state ID in each group/list could be determined according to the total number of TCI states/TCI state IDs across all the configured groups/lists. Furthermore, the TCI state ID(s) in different groups/lists may not overlap - i.e., different groups/lists may not comprise/include/contain the same TCI state(s) or TCI state ID(s). Additionally, each group/list of TCI states or TCI state IDs could be configured with a (unique) TCI state group/list ID.

For example, an entity index/ID could be provided in the higher layer parameter, e.g., TCI-State or DLorJointTCI-State or UL-TCIState, that configures a joint/DL/UL TCI state as specified herein in the present disclosure. The UE could determine/identify one or more TCI states/TCI state IDs in a (same) group of TCI states/TCI state IDs when/if the entity index(es)/ID(s) provided/configured in the higher layer parameter(s) that configures the one or more TCI states/TCI state IDs — as specified herein in the present disclosure — is the same or identical. In the present disclosure, the entity index/ID could correspond to at least one of: a PCI value, a PCI index pointing to an entry/PCI in a list of PCI that are higher layer configured to the UE, a value of CORESETPoolIndex, a value of CORESETGroupIndex, a one-bit flag indicator, a TRP ID, a TRP-specific higher layer signaling index, a CORESET ID, a resource ID/index, a resource set ID/index and etc. For instance, for M=2 or N=2, the entity index/ID could be a one-bit flag indicator; when/if the entity index/ID associated to a TCI state (e.g., by configuring/providing the entity ID in the higher layer parameter TCI-State that configures the TCI state) is set to ‘0’ (or ‘1’), the UE could determine/identify that the TCI state/TCI state ID belongs to the first group of TCI states/TCI state IDs, and when/if the entity index/ID associated to a TCI state (e.g., by configuring/providing the entity ID in the higher layer parameter TCI-State that configures the TCI state) is set to ‘1’ (or ‘0’), the UE could determine/identify that the TCI state/TCI state ID belongs to the second group of TCI states/TCI state IDs.

For another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the number of TCI states/TCI state IDs (e.g., denoted by Ngroup1) of the first group of TCI states/TCI state IDs in the list and/or the number of TCI states/TCI state IDs (e.g., denoted by Ngroup2) of the second group of TCI states/TCI state IDs in the list. For this design example, the UE could identify/determine that the first Ngroup1 TCI states/TCI state IDs in the list of joint/DL (or UL) TCI states belong to the first group of TCI states/TCI state IDs, and the rest (or last Ngroup2) TCI states/TCI state IDs in the list of joint/DL (or UL) TCI states belong to the second group of TCI states/TCI state IDs. Alternatively, the UE could identify/determine that the last Ngroup2 TCI states/TCI state IDs in the list of joint/DL (or UL) TCI states belong to the second group of TCI states/TCI state IDs, and the rest (or first Ngroup1) TCI states/TCI state IDs in the list of joint/DL (or UL) TCI states belong to the first group of TCI states/TCI state IDs. The above described UE operations/behaviors could be extended/applied to when N>2 (or M>2) groups of TCI states/TCI state IDs are configured.

Yet for another example, for N=2 or M=2, the UE could be first provided/configured/indicated by the network, e.g., via higher layer RRC signaling/parameter, a list of joint/DL (or UL) TCI states. In the higher layer RRC signaling/parameter that configures/provides the list of joint/DL (or UL) TCI states, the UE could be further configured/provided/indicated by the network the TCI state indexes/IDs or indexes of the TCI state indexes/IDs of the first group of TCI states/TCI state IDs in the list and/or the TCI state indexes/IDs or indexes of the TCI state indexes/IDs of the second group of TCI states/TCI state IDs in the list. The above described UE operations/behaviors could be extended/applied to when N>2 (or M>2) groups of TCI states/TCI state IDs are configured.

When the UE is higher layer provided/configured by the network M≥1 or N≥1 (e.g., M=2 or N=2) groups of TCI states in a list of joint/DL (or UL) TCI states, and when the UE receives from the network a fallback DCI, e.g., in DCI format 1_0 or 0_1, that schedules PDSCH or PUSCH, the UE could assume/determine/identify that all the TCI states that are activated/indicated by the beam indication/activation MAC CE or DCI are from the first group of TCI states or the second group of TCI states or the list of joint/DL (or UL) TCI states.

For M=2 or N=2, the UE could be configured/provided/indicated by the network, e.g., via higher layer RRC signaling and/or MAC CE command and/or dynamic DCI based L1 signaling, a first group/list of I≥1 TCI states/TCI state IDs and a second group/list of J≥1 TCI states/TCI state IDs as specified herein in the present disclosure. The first group/list could be configured with a first TCI state group/list ID while the second group/list could be configured with a second TCI state group/list ID. For example, when the bitwidth of the TCI state ID in each group/list is determined according to the total number of TCI states/TCI state IDs in the corresponding group/list, the TCI state IDs in the first group/list could be {0, 1, ..., I - 1}, and the TCI state IDs in the second group/list could be {0, 1, ..., J — 1}. For another example, when the bitwidth of the TCI state ID in each group/list is determined according to the total number of TCI states/TCI state IDs across both of the configured groups/lists, the TCI state IDs in the first group/list could be {0, 1, ..., I — 1}, while the TCI state IDs in the second group/list could be {I, I + 1, ..., I+J-1}.

As specified herein in the present disclosure, a (unified) TCI states activation/indication MAC CE could provide/indicate/include/contain/configure/activate up to K ≥ 1 sets of TCI states/pairs of TCI states used to map up to K≥ 1 TCI codepoints of one or more TCI fields in a beam indication DCI (e.g., DCI format 1_1/1_2 with or without DL assignment). The UE could receive one or multiple such (unified) TCI states activation/indication MAC CEs, e.g., in a slot or in a configured time period/window. Additionally, the UE could maintain/track a first TCI state and a second TCI state for at least UE-dedicated reception on PDSCH/PDCCH and dynamic-grant/configured-grant PUSCH transmission and all of PUCCH transmission in a multi-TRP system. For a set of TCI states/pairs of TCI states (e.g., provided/indicated/configured in the beam indication/activation MAC CE or by one or more TCI codepoints of one or more TCI fields in the beam indication DCI) that contains/includes/comprises a single TCI state/pair of TCI states (referred to as TCI state(s) in the below examples).

In one example, a one-bit indicator could be provided/indicated/configured in the beam activation/indication MAC CE and associated to the set of TCI state/pair of TCI states, and therefore, the corresponding TCI state(s) (and therefore, the corresponding Octet(s) in the MAC CE) as specified herein in the present disclosure. When the one-bit indicator is set to “0” (or “1”), the UE could identify/determine that the associated/corresponding TCI state(s) is from the first group/list of TCI states/TCI state IDs and/or apply the associated/corresponding TCI state(s) to update the first TCI state, and when the one-bit indicator is set to “1” (or “0”), the UE could identify/determine that the associated/corresponding TCI state(s) is from the second group/list of TCI states/TCI state IDs and/or apply the associated/corresponding TCI state(s) to update the second TCI state.

When the set of TCI state/pair of TCI states, and therefore, the corresponding TCI state(s) is indicated by one or more TCI codepoints of one or more TCI fields in a beam indication DCI (e.g., DCI format 1_1/1_2 with or without DL assignment), the one-bit indicator could also be provided/indicated/configured in a DCI — e.g., the beam indication DCI (a new/dedicated DCI field or by repurposing one or more bits of one or more existing DCI fields) and associated to the set of TCI state/pair of TCI states, and therefore, the corresponding TCI state(s). The UE could identify/determine, according to/based on the one-bit indicator in the DCI, which of the first group/list of TCI states/TCI state IDs and/or the second group/list of TCI states/TCI state IDs the TCI state(s) is selected/determined from and/or which of the first TCI state and/or the second TCI state is updated by the TCI state(s) following those described/specified herein in the present disclosure. This design example can be for when the bitwidth of the TCI state ID in each group/list is determined according to the total number of TCI states/TCI state IDs in the corresponding group/list.

In another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. For this case, a one-bit indicator could be provided/indicated/configured in the beam activation/indication MAC CE and associated to the set of TCI state/pair of TCI states, and therefore, the corresponding TCI state(s) (and therefore, the corresponding Octet(s) in the MAC CE) as specified herein in the present disclosure, and each value of the one-bit indicator could correspond a PCI or PCI index pointing to an entry/PCI in the list/set/pool of PCIs. When the one-bit indicator is set to “0” (or “1”), the UE could identify/determine that the associated/corresponding TCI state(s) is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) to update the first TCI state and/or for at least UE-dedicated reception(s) on PDCCH/PDSCH and/or dynamic-grant/configured-grant PUSCH and all of PUCCH transmission(s) associated with the serving cell PCI, and when the one-bit indicator is set to “1” (or “0”), the UE could identify/determine that the associated/corresponding TCI state(s) is from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. When the set of TCI state/pair of TCI states, and therefore, the corresponding TCI state(s) is indicated by one or more TCI codepoints of one or more TCI fields in a beam indication DCI (e.g., DCI format 1_1/1_2 with or without DL assignment), the one-bit indicator as specified herein in the present disclosure could also be provided/indicated/configured in a DCI — e.g., the beam indication DCI (a new/dedicated DCI field or by repurposing one or more bits of one or more existing DCI fields) and associated to the set of TCI state/pair of TCI states, and therefore, the corresponding TCI state(s).

The UE could identify/determine, according to/based on the one-bit indicator in the DCI, which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the TCI state(s) is selected/determined from and/or which of the first TCI state and/or the second TCI state is updated by the TCI state(s) following those described/specified herein in the present disclosure. This design example can be for when the bitwidth of the TCI state ID in each group/list is determined according to the total number of TCI states/TCI state IDs in the corresponding group/list.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. For this design example, a PCI value or a PCI index (pointing to an entry/PCI in the list/set/pool of PCIs) could be provided/indicated/configured in the beam activation/indication MAC CE and associated to the set of TCI state/pair of TCI states, and therefore, the corresponding TCI state(s) (and therefore, the corresponding Octet(s) in the MAC CE) as specified herein in the present disclosure. When the PCI value corresponds to the serving cell PCI or the PCI index corresponds to the serving cell PCI index (e.g., pointing to the serving cell PCI in the list/set/pool of PCIs), the UE could identify/determine that the associated/corresponding TCI state(s) is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) to update the first TCI state and/or for at least UE-dedicated reception(s) on PDCCH/PDSCH and/or dynamic-grant/configured-grant PUSCH and all of PUCCH transmission(s) associated with the serving cell PCI, and when the PCI value corresponds to a PCI other than the serving cell PCI or a PCI index corresponds to a PCI other than the serving cell PCI index (e.g., pointing to a PCI other than the serving cell PCI in the list/set/pool of PCIs), the UE could identify/determine that the associated/corresponding TCI state(s) is from the PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI.

When the set of TCI state/pair of TCI states, and therefore, the corresponding TCI state(s) is indicated by one or more TCI codepoints of one or more TCI fields in a beam indication DCI (e.g., DCI format 1_1/1_2 with or without DL assignment), a/the PCI value or PCI index pointing to an entry/PCI in the set/list/pool of PCIs could also be provided/indicated/configured in a DCI — e.g., the beam indication DCI (a new/dedicated DCI field or by repurposing one or more bits of one or more existing DCI fields) and associated to the set of TCI state/pair of TCI states, and therefore, the corresponding TCI state(s). The UE could identify/determine, according to/based on the PCI/PCI index in the DCI, which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the TCI state(s) is selected/determined from and/or which of the first TCI state and/or the second TCI state is updated by the TCI state(s) following those described/specified herein in the present disclosure. This design example can be for when the bitwidth of the TCI state ID in each group/list is determined according to the total number of TCI states/TCI state IDs in the corresponding group/list.

In another example, a TCI state group/list ID could be provided/indicated/configured in the beam activation/indication MAC CE and associated to the set of TCI state/pair of TCI states, and therefore, the corresponding TCI state(s) (and therefore, the corresponding Octet(s) in the MAC CE) as specified herein in the present disclosure. When the TCI state group/list ID corresponds to the first TCI state group/list ID as specified herein in the present disclosure, the UE could identify/determine that the associated/corresponding TCI state(s) is from the first group/list of TCI states/TCI state IDs and/or apply the associated/corresponding TCI state(s) to update the first TCI state, and when the TCI state group/list ID corresponds to the second TCI state group/list ID as specified herein in the present disclosure, the UE could identify/determine that the associated/corresponding TCI state(s) is from the second group/list of TCI states/TCI state IDs and/or apply the associated/corresponding TCI state(s) to update the second TCI state. When the set of TCI state/pair of TCI states, and therefore, the corresponding TCI state(s) is indicated by one or more TCI codepoints of one or more TCI fields in a beam indication DCI (e.g., DCI format 1_1/1_2 with or without DL assignment), the TCI state group/list ID could also be provided/indicated/configured in a DCI - e.g., the beam indication DCI (a new/dedicated DCI field or by repurposing one or more bits of one or more existing DCI fields) and associated to the set of TCI state/pair of TCI states, and therefore, the corresponding TCI state(s).

The UE could identify/determine, according to/based on the TCI state group/list ID in the DCI, which of the first group/list of TCI states/TCI state IDs and/or the second group/list of TCI states/TCI state IDs the TCI state(s) is selected/determined from and/or which of the first TCI state and/or the second TCI state is updated by the TCI state(s) following those described/specified herein in the present disclosure. This design example can be for when the bitwidth of the TCI state ID in each group/list is determined according to the total number of TCI states/TCI state IDs in the corresponding group/list. Here, a TCI state group/list ID could correspond to a PCI or a PCI index (pointing to an entry/PCI in the list/set/pool of PCIs). When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that the TCI state group/list ID(s) in each group/list of TCI state(s) corresponds to a PCI or PCI index pointing to an entry/PCI in the list/set/pool of PCIs, the UE could follow those specified herein in the present disclosure, e.g., those specified in the examples of the present disclosure to use/apply the configured/activated/indicated TCI state(s) for SDCI based inter-cell MTRP operation.

In yet another example, a bitmap of length two — e.g., denoted by [x y] with x=0 or 1 and y=0 or 1 — could be provided/indicated/configured in the beam activation/indication MAC CE and associated to the set of TCI state/pair of TCI states, and therefore, the corresponding TCI state(s) (and therefore, the corresponding Octet(s) in the MAC CE) as specified herein in the present disclosure. When the bitmap is set to [1 0], the UE could identify/determine that the associated/corresponding TCI state(s) is from the first group/list of TCI states/TCI state IDs and/or apply the associated/corresponding TCI state(s) to update the first TCI state, and when the bitmap is set to [0 1], the UE could identify/determine that the associated/corresponding TCI state(s) is from the second group/list of TCI states/TCI state IDs and/or apply the associated/corresponding TCI state(s) to update the second TCI state. When the set of TCI state/pair of TCI states, and therefore, the corresponding TCI state(s) is indicated by one or more TCI codepoints of one or more TCI fields in a beam indication DCI (e.g., DCI format 1_1/1_2 with or without DL assignment), the bitmap could also be provided/indicated/configured in a DCI — e.g., the beam indication DCI (a new/dedicated DCI field or by repurposing one or more bits of one or more existing DCI fields) and associated to the set of TCI state/pair of TCI states, and therefore, the corresponding TCI state(s).

The UE could identify/determine, according to/based on the bitmap in the DCI, which of the first group/list of TCI states/TCI state IDs and/or the second group/list of TCI states/TCI state IDs the TCI state(s) is selected/determined from and/or which of the first TCI state and/or the second TCI state is updated by the TCI state(s) following those described/specified herein in the present disclosure. This design example can be for when the bitwidth of the TCI state ID in each group/list is determined according to the total number of TCI states/TCI state IDs in the corresponding group/list. Here, the bitmap of [1 0] could correspond to a PCI or a PCI index (pointing to an entry/PCI in the list/set/pool of PCIs) — e.g., the serving cell PCI/PCI index, and the bitmap of [0 1] could correspond to another PCI or another PCI index (pointing to another entry/PCI in the list/set/pool of PCIs) — e.g., a PCI/PCI index other than the serving cell PCI/PCI index. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that the bitmap value(s) of [1 0] or [0 1] corresponds to a PCI or PCI index pointing to an entry/PCI in the list/set/pool of PCIs, the UE could follow those specified herein in the present disclosure, e.g., those specified in the examples of the present disclosure to use/apply the configured/activated/indicated TCI state(s) for SDCI based inter-cell MTRP operation.

In yet another example, a set of TCI state(s)/pair(s) of TCI states in the beam indication/activation MAC CE could correspond to or could be indicated/provided/configured by a group of two or more (consecutive) MAC CE entries (e.g., Octets in the corresponding MAC CE). Here, the set of TCI state/pair of TCI states as specified herein in the present disclosure could correspond to or could be indicated/provided/configured by a group of a first MAC CE entry (e.g., a first Octet) and a second MAC CE entry (e.g., a second Octet); the first MAC CE entry (or the first Octet) and the second MAC CE entry (or the second Octet) could be consecutive in the corresponding beam indication/activation MAC CE. When the first MAC CE entry (or the first Octet) contains/provides/indicates the ID(s) of the TCI state(s) as specified herein in the present disclosure while the second MAC CE entry (or the second Octet) does not contain/provide/indicate any TCI state ID or contains/provides/indicates “null” or invalid value(s), the UE could identify/determine that the TCI state(s) is from the first group/list of TCI states/TCI state IDs and/or apply the associated/corresponding TCI state(s) to update the first TCI state, and when the second MAC CE entry (or the second Octet) contains/provides/indicates the ID(s) of the TCI state(s) as specified herein in the present disclosure while the first MAC CE entry (or the first Octet) does not contain/provide/indicate any TCI state ID or contains/provides/indicates “null” or invalid value(s), the UE could identify/determine that the TCI state(s) is from the second group/list of TCI states/TCI state IDs and/or apply the associated/corresponding TCI state(s) to update the second TCI state.

This design example can be for when the bitwidth of the TCI state ID in each group/list is determined according to the total number of TCI states/TCI state IDs in the corresponding group/list. This design example can be for when the bitwidth of the TCI state ID in each group/list is determined according to the total number of TCI states/TCI state IDs in the corresponding group/list. For this design example, the first group/list of TCI states/TCI state IDs could be associated to a PCI or PCI index pointing to an entry/PCI in the list/set/pool of PCIs — e.g., the serving cell PCI/PCI index as specified herein in the present disclosure, and the second group/list of TCI states/TCI state IDs could be associated to another PCI or PCI index pointing to another entry/PCI in the list/set/pool of PCIs — e.g., a PCI/PCI index other than the serving cell PCI/PCI index as specified herein in the present disclosure. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the configured/activated/indicated TCI state(s) for SDCI based inter-cell MTRP operation.

In yet another example, when, e.g., the bitwidth of the TCI state ID in each group/list is determined according to the total number of TCI states/TCI state IDs across both of the configured groups/lists, the UE could identify, according to/based on the ID(s) of the TCI state(s) as specified herein in the present disclosure, which of the first group/list of TCI states/TCI state IDs and/or the second group/list of TCI states/TCI state IDs the TCI state(s) is selected/determined from and/or which of the first TCI state and/or the second TCI state is updated by the TCI state(s). For instance, the first group/list could contain/include/comprise TCI state IDs ranging from #0 — #7, while the second group/list could contain/include/comprise TCI state IDs ranging from #8 — #15. If the ID(s) of the TCI state(s) as specified herein in the present disclosure is #4, the UE could identify that the TCI state(s) as specified herein in the present disclosure is selected/determined from the first group/list of TCI states/TCI state IDs.

When/if the UE could identify, according to/based on the ID(s) of the TCI state(s) as specified herein in the present disclosure, that the TCI state(s) as specified herein in the present disclosure is selected/determined from the first group/list of TCI states/TCI state IDs, the UE could apply the TCI state(s) to update the first TCI state. When/if the UE could identify, according to/based on the ID(s) of the TCI state(s) as specified herein in the present disclosure, that the TCI state(s) as specified herein in the present disclosure is selected/determined from the second group/list of TCI states/TCI state IDs, the UE could apply the TCI state(s) to update the second TCI state. For this design example, the first group/list of TCI states/TCI state IDs could be associated to a PCI or PCI index pointing to an entry/PCI in the list/set/pool of PCIs — e.g., the serving cell PCI/PCI index as specified herein in the present disclosure, and the second group/list of TCI states/TCI state IDs could be associated to another PCI or PCI index pointing to another entry/PCI in the list/set/pool of PCIs — e.g., a PCI/PCI index other than the serving cell PCI/PCI index as specified herein in the present disclosure.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the configured/activated/indicated TCI state(s) for SDCI based inter-cell MTRP operation.

For a set of TCI states/pairs of TCI states (e.g., provided/indicated/configured in the beam indication/activation MAC CE or by one or more TCI codepoints of one or more TCI fields in the beam indication DCI) that contains/includes/comprises a TCI state/pair of TCI states (referred to as TCI state(s) I in the below examples) and another TCI state/pair of TCI states (referred to as TCI state(s) II in the below examples).

In one example, the UE could identify/determine, according to/based on fixed/predefined rule(s) or those provided in system specifications, that the TCI state(s) I (or TCI state(s) II) is from the first group/list of TCI states/TCI state IDs and/or apply the TCI state(s) I (or TCI state(s) II) to update the first TCI state, and the UE could identify/determine, according to/based on fixed/predefined rule(s) or those provided in the system specifications, that the TCI state(s) II (or TCI state(s) I) is from the second group/list of TCI states/TCI state IDs and/or apply the TCI state(s) II (or TCI state(s) I) to update the second TCI state. For this design example, the first group/list of TCI states/TCI state IDs could be associated to a PCI or PCI index pointing to an entry/PCI in the list/set/pool of PCIs — e.g., the serving cell PCI/PCI index as specified herein in the present disclosure, and the second group/list of TCI states/TCI state IDs could be associated to another PCI or PCI index pointing to another entry/PCI in the list/set/pool of PCIs — e.g., a PCI/PCI index other than the serving cell PCI/PCI index as specified herein in the present disclosure.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the TCI state(s) I and/or the TCI state(s) II for SDCI based inter-cell MTRP operation.

In another example, a one-bit indicator could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure. When the one-bit indicator is set to “0” (or “1”), the UE could identify/determine that the TCI state(s) I is from the first group/list of TCI states/TCI state IDs and/or apply the TCI state(s) I to update the first TCI state, and the UE could identify/determine that the TCI state(s) II is from the second group/list of TCI states/TCI state IDs and/or apply the TCI state(s) II to update the second TCI state. When the one-bit indicator is set to “1” (or “0”), the UE could identify/determine that the TCI state(s) II is from the first group/list of TCI states/TCI state IDs and/or apply the TCI state(s) II to update the first TCI state, and the UE could identify/determine that the TCI state(s) I is from the second group/list of TCI states/TCI state IDs and/or apply the TCI state(s) I to update the second TCI state.

When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the one-bit indicator could also be provided/indicated/configured in a DCI — e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II. The UE could identify/determine, according to/based on the one-bit indicator in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. Furthermore, a one-bit indicator could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure, and each value of the one-bit indicator could be associated to one or more PCIs or PCI indexes each pointing to an entry/PCI in the list/set/pool of PCIs.

When the one-bit indicator is set to “0” (or “1”), the UE could identify/determine that the TCI state(s) I is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) I to update the first TCI state and/or for at least UE-dedicated reception(s) on PDCCH/PDSCH and/or dynamic-grant/configured-grant PUSCH and all of PUCCH transmission(s) associated with the serving cell PCI, and the UE could identify/determine that the TCI state(s) II is from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) II to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI.

When the one-bit indicator is set to “1” (or “0”), the UE could identify/determine that the TCI state(s) II is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) II to update the first TCI state and/or for at least UE-dedicated reception(s) on PDCCH/PDSCH and/or dynamic-grant/configured-grant PUSCH and all of PUCCH transmission(s) associated with the serving cell PCI, and the UE could identify/determine that the TCI state(s) Iis from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) II to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the one-bit indicator as specified herein in the present disclosure could also be provided/indicated/configured in a DCI — e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II.

The UE could identify/determine, according to/based on the one-bit indicator in the DCI, which of the serving cell PCI/PCI index and the PCI/PCI index other than the serving cell PCI/PCI index the TCI state(s) I and/or TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a first one-bit indicator and a second one-bit indicator could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure, respectively. When the first (or second) one-bit indicator is set to “0” (or “1”), the UE could identify/determine that the TCI state(s) I (or TCI state(s) II) is from the first group/list of TCI states/TCI state IDs and/or apply the TCI state(s) I (or TCI state(s) II) to update the first TCI state.

When the first (or second) one-bit indicator is set to “1” (or “0”), the UE could identify/determine that the TCI state(s) I (or TCI state(s) II) is from the second group/list of TCI states/TCI state IDs and/or apply the TCI state(s) I (or TCI state(s) II) to update the second TCI state. When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the first and second one-bit indicators as specified herein in the present disclosure could also be provided/indicated/configured in a DCI - e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II, respectively. The UE could identify/determine, according to/based on the first and second one-bit indicators in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI.

Furthermore, a first one-bit indicator and a second one-bit indicator could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure, respectively; in addition, each value of the first/second indicator could identify/indicate a PCI or PCI index pointing to an entry/PCI in the list/set/pool of PCIs. When the first (or second) one-bit indicator is set to “0” (or “1”), the UE could identify/determine that the TCI state(s) I (or TCI state(s) II) is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) I (or TCI state(s) II) to update the first TCI state and/or for at least UE-dedicated reception(s) on PDCCH/PDSCH and/or dynamic-grant/configured-grant PUSCH and all of PUCCH transmission(s) associated with the serving cell PCI.

When the first (or second) one-bit indicator is set to “1” (or “0”), the UE could identify/determine that the TCI state(s) I (or TCI state(s) II) is from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) I (or TCI state(s) II) to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the first and second one-bit indicators as specified herein in the present disclosure could also be provided/indicated/configured in a DCI - e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II, respectively.

The UE could identify/determine, according to/based on the first and second one-bit indicators in the DCI, which of the serving cell PCI/PCI index and the PCI/PCI index other than the serving cell PCI/PCI index the TCI state(s) I and/or TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. For this case, a first PCI or a first PCI index (pointing to an entry/PCI in the list/set/pool of PCIs) and a second PCI or a second PCI index (pointing to another entry/PCI in the list/set/pool of PCIs) could be provided/indicated/configured in the beam activation/indication MAC CE and respectively associated to the TCI state(s) I and TCI state(s) II in the set (and therefore, the corresponding Octet(s) in the MAC CE) as specified herein in the present disclosure.

When the first PCI value corresponds to the serving cell PCI or the first PCI index corresponds to the serving cell PCI index (e.g., pointing to the serving cell PCI in the list/set/pool of PCIs), the UE could identify/determine that the associated/corresponding TCI state(s) I is from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and/or apply the associated/corresponding TCI state(s) I to update the first TCI state and/or for at least UE-dedicated reception(s) on PDCCH/PDSCH and/or dynamic-grant/configured-grant PUSCH and all of PUCCH transmission(s) associated with the serving cell PCI.

When the second PCI value corresponds to a PCI other than the serving cell PCI or the second PCI index corresponds to the PCI index other than the serving cell PCI index (e.g., pointing to the PCI other than the serving cell PCI in the list/set/pool of PCIs), the UE could identify/determine that the associated/corresponding TCI state(s) II is from the PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs), and/or apply the associated/corresponding TCI state(s) II to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI.

When the set of TCI state/pair of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the first PCI/PCI index and the second PCI/PCI index as specified herein in the present disclosure could also be provided/indicated/configured in a DCI — e.g., the beam indication DCI (a new/dedicated DCI field or by repurposing one or more bits of one or more existing DCI fields) and respectively associated to the corresponding TCI state(s) I and TCI state(s) II. The UE could identify/determine, according to/based on the first PCI/PCI index and/or the second PCI/PCI index in the DCI, which of the serving cell PCI/PCI index and the PCI/PCI index other than the serving cell PCI/PCI index the indicated TCI state(s) I and the indicated TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state is updated by the TCI state(s) I and/or TCI state(s) II following those described/specified herein in the present disclosure.

In yet another example, a set of two TCI state group/list IDs (denoted by TCI state group/list ID 1 and TCI state group/list ID 2) could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure. When the TCI state group/list ID 1 corresponds to the first TCI state group/list ID and the TCI state group/list ID 2 corresponds to the second TCI state group/list ID as specified herein in the present disclosure, the UE could identify/determine that the TCI state(s) I is from the first group/list of TCI states/TCI state IDs and/or apply the TCI state(s) I to update the first TCI state, and the TCI state(s) II is from the second group/list of TCI states/TCI state IDs and/or apply the TCI state(s) II to update the second TCI state.

When the TCI state group/list ID 1 corresponds to the second TCI state group/list ID and the TCI state group/list ID 1 corresponds to the first TCI state group/list ID as specified herein in the present disclosure, the UE could identify/determine that the TCI state(s) I is from the second group/list of TCI states/TCI state IDs and/or apply the TCI state(s) I to update the second TCI state, and the TCI state(s) II is from the first group/list of TCI states/TCI state IDs and/or apply the TCI state(s) II to update the first TCI state.

When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the set of two TCI state group/list IDs (denoted by TCI state group/list ID 1 and TCI state group/list ID 2) could also be provided/indicated/configured in a DCI — e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II. The UE could identify/determine, according to/based on the set of two TCI state group/list IDs in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

Here, the TCI state group/list ID 1 or the first TCI state group/list ID could correspond to a PCI or a PCI index (pointing to an entry/PCI in the list/set/pool of PCIs) — e.g., the serving cell PCI/PCI index, and the TCI state group/list ID 2 or the second TCI state group/list ID could correspond another PCI or another PCI index (pointing to another entry/PCI in the list/set/pool of PCIs) — e.g., the PCI/PCI index other than the serving cell PCI/PCI index. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the TCI state group/list ID 1 and TCI state group/list ID 2 (or equivalently, the first and the second TCI state group/list IDs) corresponds to a PCI or PCI index pointing to an entry/PCI in the list/set/pool of PCIs, the UE could follow those specified herein in the present disclosure, e.g., those specified in the examples of the present disclosure, to use/apply the TCI state(s) I and/or TCI state(s) II for SDCI based inter-cell MTRP operation.

In yet another example, a bitmap of length two — e.g., denoted by [x y] with x=0 or 1 and y=0 or 1 — could be provided/indicated/configured in the beam activation/indication MAC CE and associated to the set of TCI states/pairs of TCI states, and therefore, the corresponding TCI state(s) I and TCI state(s) II (and therefore, the corresponding Octet(s) in the MAC CE) as specified herein in the present disclosure. When the bitmap is set to [0 1], the UE could identify/determine that the TCI state(s) I is from the first group/list of TCI states/TCI state IDs and/or apply the TCI state(s) I to update the first TCI state, and the TCI state(s) II is from the second group/list of TCI states/TCI state IDs and/or apply the TCI state(s) II to update the second TCI state. When the bitmap is set to [1 0], the UE could identify/determine that the TCI state(s) I is from the second group/list of TCI states/TCI state IDs and/or apply the TCI state(s) I to update the second TCI state, and the TCI state(s) II is from the first group/list of TCI states/TCI state IDs and/or apply the TCI state(s) II to update the first TCI state.

When the set of TCI states/pairs of TCI states, and therefore, the corresponding TCI state(s) I and TCI state(s) II are indicated by one or more TCI codepoints of one or more TCI fields in a beam indication DCI (e.g., DCI format 1_1/1_2 with or without DL assignment), the bitmap could also be provided/indicated/configured in a DCI — e.g., the beam indication DCI (a new/dedicated DCI field or by repurposing one or more bits of one or more existing DCI fields) and associated to the set of TCI states/pairs of TCI states, and therefore, the corresponding TCI state(s) I and TCI state(s) II. The UE could identify/determine, according to/based on the bitmap in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

Here, each value, i.e., 0 and/or 1, of an entry/bit position of the bitmap of [x y], i.e., x or y, could correspond to a PCI or a PCI index (pointing to an entry/PCI in the list/set/pool of PCIs) - e.g., the serving cell PCI/PCI index or a PCI/PCI index other than the serving cell PCI/PCI index. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each value of an entry/bit position of the bitmap corresponds to a PCI or PCI index pointing to an entry/PCI in the list/set/pool of PCIs, the UE could follow those specified herein in the present disclosure, e.g., those specified in the examples of the present disclosure, to use/apply the TCI state(s) I and/or TCI state(s) II for SDCI based inter-cell MTRP operation.

In yet another example, when, e.g., the bitwidth of the TCI state ID in each group/list is determined according to the total number of TCI states/TCI state IDs across both of the configured groups/lists, the UE could identify, according to/based on the IDs of the TCI state(s) I and TCI state(s) II as specified herein in the present disclosure, which of the first group/list of TCI states/TCI state IDs and/or the second group/list of TCI states/TCI state IDs the TCI state(s) I and/or the TCI state(s) II are selected/determined from and/or which of the first TCI state and/or the second TCI state are updated by the TCI state(s) I and/or the TCI state(s) II.

For instance, the first group/list could contain/include/comprise TCI state IDs ranging from #0 — #7, while the second group/list could contain/include/comprise TCI state IDs ranging from #8 — #15. If the IDs of the TCI state(s) I and TCI state(s) II as specified herein in the present disclosure are #4 and #9, the UE could identify that the TCI state(s) I as specified herein in the present disclosure is selected/determined from the first group/list of TCI states/TCI state IDs, and the TCI state(s) II as specified herein in the present disclosure is selected/determined from the second group/list of TCI states/TCI state IDs. When/if the UE could identify, according to/based on the ID of the TCI state(s) I as specified herein in the present disclosure, that the TCI state(s) I as specified herein in the present disclosure is selected/determined from the first (or second) group/list of TCI states/TCI state IDs, the UE could apply the TCI state(s) I to update the first (or second) TCI state.

When/if the UE could identify, according to/based on the ID of the TCI state(s) II as specified herein in the present disclosure, that the TCI state(s) II as specified herein in the present disclosure is selected/determined from the second (or first) group/list of TCI states/TCI state IDs, the UE could apply the TCI state(s) II to update the second (or first) TCI state. For this design example, the first group/list of TCI states/TCI state IDs could be associated to a PCI or PCI index pointing to an entry/PCI in the list/set/pool of PCIs — e.g., the serving cell PCI/PCI index as specified herein in the present disclosure, and the second group/list of TCI states/TCI state IDs could be associated to another PCI or PCI index pointing to another entry/PCI in the list/set/pool of PCIs — e.g., a PCI/PCI index other than the serving cell PCI/PCI index as specified herein in the present disclosure.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the TCI state(s) I and/or TCI state(s) II for SDCI based inter-cell MTRP operation.

A beam indication/activation MAC CE, e.g., (enhanced) unified TCI state(s) activation/deactivation MAC CE, could provide/comprise/contain/include/indicate one or more (e.g., two) subsets of activated TCI states (e.g., a first and a second subsets of activated TCI states). The UE could be indicated/configured/provided by the network, e.g., via higher layer RRC signaling/parameter and/or MAC CE command and/or dynamic DCI based L1 signaling, which of the TCI state(s) activated/indicated by/in the beam indication/activation MAC CE could be in the first subset and/or which of the TCI state(s) activated/indicated by/in the beam indication/activation MAC CE could be in the second subset. In addition, the first subset of activated TCI states and the second subset of activated TCI states may not overlap - i.e., any of the TCI states/TCI state IDs comprised/included/contained/provided/indicated in the first subset may not be the same or identical to any of the TCI states/TCI state IDs comprised/included/contained/provided/indicated in the second subset.

For example, each of the first and second subsets of activated TCI states in the beam indication/activation MAC CE could be configured/indicated/associated with/to a subset index/ID (e.g., a first subset index/ID and a second subset index/ID), wherein the subset index(es)/ID(s) could be provided/indicated/configured in the same beam indication/activation MAC CE.

For another example, the beam indication/activation MAC CE, e.g., (enhanced) unified TCI state(s) activation/deactivation MAC CE, could provide/indicate/configure a bitmap with each entry/bit position of the bitmap corresponding to a MAC CE entry/Octet that comprises/contains/includes/provides/indicates one or more TCI states/TCI state IDs. For this design example, the MAC CE entry(s)/Octet(s) that is associated/corresponding to the bitmap entry(s)/bit position(s) set to “0”(s) (or “1”(s)) could indicate/provide/contain/comprise/include TCI state(s)/TCI state ID(s) for the first subset of activated TCI states, and the MAC CE entry(s)/Octet(s) that is associated/corresponding to the bitmap entry(s)/bit position(s) set to “1″(s) (or “0”(s)) could indicate/provide/contain/comprise/include TCI state(s)/TCI state ID(s) for the second subset of activated TCI states.

Yet for another example, the beam indication/activation MAC CE, e.g., (enhanced) unified TCI state(s) activation/deactivation MAC CE, could provide/indicate/configure two sets of MAC CE entries/octets (e.g., a first set of MAC CE entries/Octets and a second set of MAC CE entries/Octets); here, positions/orderings of the two sets of MAC CE entries/octets in the beam indication/activation MAC CE could be fixed and known to the UE a period; optionally, positions/orderings of the two sets of MAC CE entries/Octets in the beam indication/activation MAC CE could be provided/indicated/configured to the UE, e.g., via higher layer RRC signaling/parameter and/or MAC CE command and/or dynamic DCI based L1 signaling.

Furthermore, positions/orderings of the two sets of MAC CE entries/Octets in the beam indication/activation MAC CE may not overlap. Each of the two sets of MAC CE entries/Octets could indicate/provide/contain/comprise/include one or more TCI states/TCI state IDs. For instance, the first (or second) set of MAC CE entries/Octets could indicate/provide/contain/comprise/include TCI state(s)/TCI state ID(s) for the first subset of activated TCI states, and the second (or first) set of MAC CE entries/Octets could indicate/provide/contain/comprise/include TCI state(s)/TCI state ID(s) for the second subset of activated TCI states.

Furthermore, as specified herein in the present disclosure, the beam indication/activation MAC CE, e.g., (enhanced) unified TCI state(s) activation/deactivation MAC CE, could provide/indicate/contain/configure one or more sets of TCI states/pairs of TCI states with each set of TCI state(s)/pair(s) TCI states comprising/containing/including/providing/indicating one or more TCI states/pairs of TCI states and mapped to a TCI codepoint of a TCI field in a beam indication DCI (e.g., DCI format 1_1/1_2 with or without DL assignment). A set of TCI state(s)/pair(s) of TCI states as specified herein in the present disclosure could contain/include/comprise/provide/indicate one or more TCI states/pairs of TCI states, wherein the one or more TCI states/pairs of TCI states could be from the first subset of activated TCI states and/or the second subset of activated TCI states in the beam indication/activation MAC CE.

In one example, one or more (or each) of the activated TCI states in the first subset could be associated to one or more first entity IDs, and one or more (or each) of the activated TCI states in the second subset could be associated to one or more second entity IDs, wherein the first and/or second entity IDs could be indicated/provided/configured in the same beam indication/activation MAC CE. For this design example, each set of TCI state(s)/pair(s) of TCI states as specified herein in the present disclosure could contain/include/comprise/provide/indicate/configure one or more TCI states from the first subset and/or one or more TCI states from the second subset that are associated to the same entity ID value(s).

For example, a TCI state/pair of TCI states from/in the first subset of TCI states — denoted by TCI state(s) I in this example — could be associated to a first entity ID, and a TCI state/pair of TCI states from/in the second subset of TCI states — denoted by TCI state(s) II in this example — could be associated to a second entity ID, wherein the first and second entity IDs could be indicated/provided/configured in the beam indication/activation MAC CE. When/if the first and second entity IDs are the same or identical — or equivalently, the first and second entity IDs correspond to the same entity ID value(s), the UE could identify/determine from the beam indication/activation MAC CE that the TCI state(s) I and the TCI state(s) II could be in the same set of TCI state(s) that may be mapped to a TCI codepoint of a TCI field in the corresponding beam indication DCI; for this case, when the set of TCI states - i.e., TCI state(s) I and TCI state(s) II — is indicated by one or more TCI codepoints of one or more TCI fields in the beam indication DCI, the UE could apply the TCI state(s) I to update the first (or second) TCI state, and the TCI state(s) II to update the second (or first) TCI state. Otherwise, when the first entity ID and the second entity ID are different, the UE may not consider/treat/interpret/determine the TCI state(s) I and the TCI state(s) II in the same set.

For another example, a TCI state/pair of TCI states from/in the first subset of activated TCI states — denoted by TCI state(s) I in this example — could be associated to a first entity ID, wherein the first entity ID could be indicated/provided/configured in the beam indication/activation MAC CE. When/if there is no TCI state(s) from/in the second subset of activated TCI states associated to second entity ID(s) having the same value(s) as the first entity ID here, the UE could identify/determine from the beam indication/activation MAC CE that a (same) set of TCI state(s) that may be mapped to a TCI codepoint of a TCI field in the corresponding beam indication DCI could only contain/comprise/include/indicate/provide the TCI state(s) I; for this case, when the set of TCI state(s) — i.e., only the TCI state(s) I — is indicated by one or more TCI codepoints of one or more TCI fields in the beam indication DCI, the UE could apply the TCI state(s) I to update the first (or second) TCI state.

Yet for another example, a TCI state/pair of TCI states from/in the second subset of activated TCI states — denoted by TCI state(s) II in this example — could be associated to a second entity ID, wherein the second entity ID could be indicated/provided/configured in the beam indication/activation MAC CE. When/if there is no TCI state(s) from/in the first subset of activated TCI states associated to first entity ID(s) having the same value(s) as the second entity ID here, the UE could identify/determine from the beam indication/activation MAC CE that a (same) set of TCI state(s) that may be mapped to a TCI codepoint of a TCI field in the corresponding beam indication DCI could only contain/comprise/include/indicate/provide the TCI state(s) II; for this case, when the set of TCI state(s) - i.e., only the TCI state(s) II - is indicated by one or more TCI codepoints of one or more TCI fields in the beam indication DCI, the UE could apply the TCI state(s) II to update the second (or first) TCI state.

Yet for another example, a TCI state/pair of TCI states from/in the first subset of activated TCI states — denoted by TCI state(s) I in this example — may not be associated to any valid (first) entity ID(s). For this case, the UE could identify/determine from the beam indication/activation MAC CE that a (same) set of TCI state(s) that may be mapped to a TCI codepoint of a TCI field in the corresponding beam indication DCI could only contain/comprise/include/indicate/provide the TCI state(s) I; for this case, when the set of TCI state(s) — i.e., only the TCI state(s) I — is indicated by one or more TCI codepoints of one or more TCI fields in the beam indication DCI, the UE could apply the TCI state(s) I to update the first (or second) TCI state.

Yet for another example, a TCI state/pair of TCI states from/in the second subset of activated TCI states — denoted by TCI state(s) II in this example — may not be associated to any valid (second) entity ID(s). For this case, the UE could identify/determine from the beam indication/activation MAC CE that a (same) set of TCI state(s) that may be mapped to a TCI codepoint of a TCI field in the corresponding beam indication DCI could only contain/comprise/include/indicate/provide the TCI state(s) II; for this case, when the set of TCI state(s) - i.e., only the TCI state(s) II - is indicated by one or more TCI codepoints of one or more TCI fields in the beam indication DCI, the UE could apply the TCI state(s) II to update the second (or first) TCI state.

Here, a (first/second) entity ID could be one or more of: (1) a one-bit indicator having value(s) of 0 or 1, (2) a TCI state group/list ID/index, (3) a PCI or a PCI index pointing to an entry/PCI in a higher layer configured list/set/pool of PCIs, (4) a CORESETPoolIndex value (index/ID configured/associated to a pool of CORESETs), (5) a CORESETGroupIndex value (index/ID configured/associated to a group of CORESETs), (6) a CORESET index/ID, (7) a RS index/ID, (8) a RS resource pair index/ID, (9) a RS resource set index/ID, (10) a RS resource setting index/ID, (11) a RS reporting setting index/ID, (12) a TRP-specific higher layer signaling index/ID, (13) a bitmap, and/or etc.

In another example, one or more (or all) of the activated TCI states in the first subset could be associated to a first bitmap, and one or more (or all) of the activated TCI states in the second subset could be associated to a second bitmap, wherein the first and/or second bitmaps could be indicated/provided/configured in the same beam indication/activation MAC CE. Each entry/bit position in the first (or second) bitmap could be 0 or 1, and associated to one or more of the activated TCI states in the first (or second) subset.

For this design example, when/if an entry/bit position in the first (or second) bitmap is set to “0” (or “1”), the activated TCI state(s) in the first (or second) subset that is associated/corresponding to the entry/bit position could be in a (same) set of TCI state(s) comprising one or more activated TCI states from the second (or first) subset, and the set of TCI state(s) could be mapped to a TCI codepoint of a TCI field in a beam indication DCI. When/if an entry/bit position in the first (or second) bitmap is set to “1” (or “0”), the activated TCI state(s) in the first (or second) subset that is associated/corresponding to the entry/bit position could be the only components/entries of a set of TCI state(s), which could be mapped to a TCI codepoint of a TCI field in a beam indication DCI. More specifically,

For example, one or more activated TCI states in the first subset and one or more activated TCI states in the second subset could be in a (same) set of TCI states (mapped to a TCI codepoint) when/if the entry/bit position in the first bitmap associated/corresponding to the one or more activated TCI states in the first subset is set to “0” (or “1”), the entry/bit position in the second bitmap associated/corresponding to the one or more activated TCI states in the second subset is set to “0” (or “1”), and the ordering/order/index/position of the entry/bit position — set to “0” (or “1”) — in the first bitmap associated/corresponding to the one or more activated TCI states in the first subset among all the entries/bit positions in the first bitmap that are set to “0”s (or “1”s) is the same as the ordering/order/index/position of the entry/bit position — set to “0” (or “1”) — in the second bitmap associated/corresponding to the one or more activated TCI states in the second subset among all the entries/bit positions in the second bitmap that are set to “0”s (or “1”s).

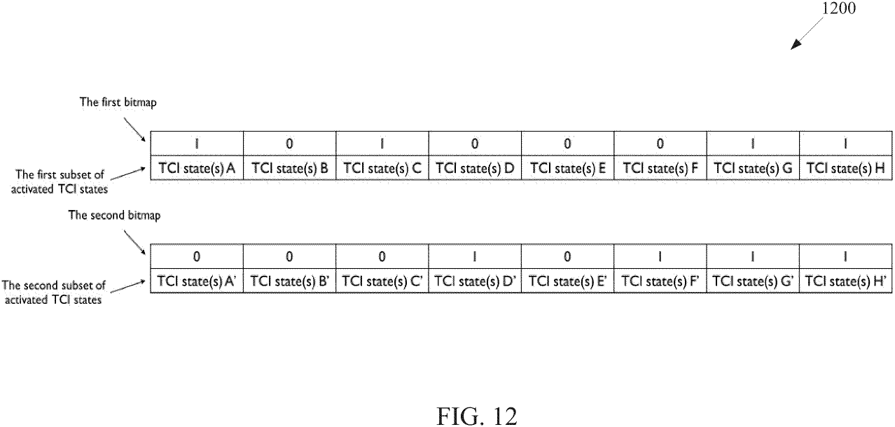

For instance, as illustrated in the example shown in FIG. 12, the entry/bit position of the first bitmap associated to the TCI state(s) B in/from the first subset of activated TCI states in the beam indication/activation MAC CE is set to “0,” and is the first among all the entries/bit positions in the first bitmap that are set to “0”s; furthermore, the entry/bit position of the second bitmap associated to the TCI state(s) A′ in/from the second subset of activated TCI states in the beam indication/activation MAC CE is set to “0,” and is the first among all the entries/bit positions in the second bitmap that are set to “0.”

FIG. 12 illustrates an example of TCI states grouping via bitmaps 1200 according to embodiments of the present disclosure. An embodiment of the TCI states grouping via the bitmaps 1200 shown in FIG. 12 is for illustration only.

Hence, upon receiving the beam indication/activation MAC CE, the UE could identify/determine that the TCI state(s) B and the TCI state(s) A′ could be in a (same) set of TCI states — e.g., denoted by TCI state set 1 = {TCI state(s) B, TCI state(s) A′} — that could be mapped to a TCI codepoint of a TCI field in the beam indication DCI. For this case, when the set of TCI states which comprises the TCI state(s) B and the TCI state(s) A′ is indicated by a TCI codepoint of one or more TCI fields in the corresponding beam indication DCI, the UE could apply the TCI state(s) B to update the first (or second) TCI state, and the TCI state(s) A′ to update the second (or first) TCI state. Similarly, in the example shown in FIG. 12, the UE could also identify/determine three other sets of TCI states, which are TCI state set 2 = {TCI state(s) D, TCI state(s) B′}, TCI state set 3 = {TCI state(s) E, TCI state(s) C′} and TCI state set 4 = {TCI state(s) F, TCI state(s) E′}, and update the first and second TCI states as specified herein in the present disclosure accordingly.

For another example, a (same) set of TCI state(s) (mapped to a TCI codepoint) could only contain/comprise/include/indicate/provide one or more activated TCI states in/from the first subset when/if the entry/bit position in the first bitmap associated/corresponding to the one or more activated TCI states in the first subset is set to “1” (or “0”). For instance, as illustrated in the example shown in FIG. 12, the entry/bit position of the first bitmap associated to the TCI state(s) A in/from the first subset of activated TCI states in the beam indication/activation MAC CE is set to “1.” Hence, upon receiving the beam indication/activation MAC CE, the UE could identify/determine that a (same) set of TCI state(s) could only contain/comprise/include/indicate/provide the TCI state(s) A - e.g., denoted by TCI state set 1 = {TCI state(s) A} — that could be mapped to a TCI codepoint of a TCI field in the beam indication DCI. For this case, when the set of TCI state(s) which only comprises the TCI state(s) A is indicated by a TCI codepoint of one or more TCI fields in the corresponding beam indication DCI, the UE could apply the TCI state(s) A to update the first (or second) TCI state. Similarly, in the example shown in FIG. 12, the UE could also identify/determine three other sets of TCI states, which are TCI state set 2 = {TCI state(s) C}, TCI state set 3 = {TCI state(s) G} and TCI state set 4 = {TCI state(s) H}, and update the first (or second) TCI state as specified herein in the present disclosure.

Yet for another example, a (same) set of TCI state(s) (mapped to a TCI codepoint) could only contain/comprise/include/indicate/provide one or more activated TCI states in/from the second subset when/if the entry/bit position in the first bitmap associated/corresponding to the one or more activated TCI states in the second subset is set to “1” (or “0”). For instance, as illustrated in the example shown in FIG. 12, the entry/bit position of the second bitmap associated to the TCI state(s) D′ in/from the second subset of activated TCI states in the beam indication/activation MAC CE is set to “1.” Hence, upon receiving the beam indication/activation MAC CE, the UE could identify/determine that a (same) set of TCI state(s) could only contain/comprise/include/indicate/provide the TCI state(s) D′ - e.g., denoted by TCI state set 1 = {TCI state(s) D′} — that could be mapped to a TCI codepoint of a TCI field in the beam indication DCI. For this case, when the set of TCI state(s) which only comprises the TCI state(s) D′ is indicated by a TCI codepoint of one or more TCI fields in the corresponding beam indication DCI, the UE could apply the TCI state(s) D′ to update the second (or first) TCI state. Similarly, in the example shown in FIG. 12, the UE could also identify/determine three other sets of TCI states, which are TCI state set 2 = {TCI state(s) F′}, TCI state set 3 = {TCI state(s) G′} and TCI state set 4 = {TCI state(s) H′}, and update the second (or first) TCI state as specified herein in the present disclosure.

For this design example, the first (or second) bitmap could be (replaced by/with) a first (or second) set of entity IDs indicated/provided in the beam indication/activation MAC CE, wherein an entity ID could correspond to one or more of: (1) a one-bit indicator having value(s) of 0 or 1, (2) a TCI state group/list ID/index, (3) a PCI or a PCI index pointing to an entry/PCI in a higher layer configured list/set/pool of PCIs, (4) a CORESETPoolIndex value (index/ID configured/associated to a pool of CORESETs), (5) a CORESETGroupIndex value (index/ID configured/associated to a group of CORESETs), (6) a CORESET index/ID, (7) a RS index/ID, (8) a RS resource pair index/ID, (9) a RS resource set index/ID, (10) a RS resource setting index/ID, (11) a RS reporting setting index/ID, (12) a TRP-specific higher layer signaling index/ID, (13) a bitmap, and/or etc.

Upon receiving the beam indication/activation MAC CE, the UE could determine/identify, from the first/second sets of entity IDs, which of the activated TCI state(s) in the first and/or second subset(s) could be in the same set(s) of TCI state(s), which could be mapped to a TCI codepoint of a TCI field in a beam indication DCI, following those specified herein in the present disclosure — e.g., those described in the design examples of the present disclosure. For instance, the first (or second) bitmap could also be (replaced by/with) a first (or second) set of PCIs or PCI indexes each pointing to an entry/PCI in a higher layer configured list/set/pool of PCIs indicated/provided in the beam indication/activation MAC CE. For instance, when/if an entry in the first (or second) set of PCIs/PCI indexes is set to a PCI/PCI index, the activated TCI state(s) in the first (or second) subset that is associated/corresponding to the entry could be in a (same) set of TCI state(s) comprising one or more activated TCI states from the second (or first) subset, and the set of TCI state(s) could be mapped to a TCI codepoint of a TCI field in a beam indication DCI.

When/if an entry position in the first (or second) set of PCIs/PCI indexes is set to “1” or “0” or other value(s) than a PCI/PCI index, the activated TCI state(s) in the first (or second) subset that is associated/corresponding to the entry could be the only components/entries of a set of TCI state(s), which could be mapped to a TCI codepoint of a TCI field in a beam indication DCI. Upon receiving the beam indication/activation MAC CE, the UE could determine/identify, from the first/second sets of PCIs/PCI indexes, which of the activated TCI state(s) in the first and/or second subset(s) could be in the same set(s) of TCI state(s), which could be mapped to a TCI codepoint of a TCI field in a beam indication DCI, following those specified herein in the present disclosure — e.g., those described in the design examples of the present disclosure.

In another example, the beam indication/activation MAC CE could provide/indicate/activate one or more TCI states or TCI state IDs each denoted by TCI state IDᵢ,ⱼ, wherein i is the index of the TCI codepoint of the TCI field in the beam indication DCI, and TCI state IDᵢ,ⱼ could denote the j-th or (j-1)-th or (j+1)-th TCI state indicated for the i-th TCI codepoint of the TCI field in the beam indication DCI. The TCI codepoint to which the TCI states are mapped could be determined by its ordinal position among all the TCI codepoints with sets of TCI state IDᵢ,ⱼ fields, i.e., the first TCI codepoint with TCI state ID₀,₁ and TCI state ID₀,₂ may be mapped to the codepoint value 0, the second TCI codepoint with TCI state ID₁,₁ and TCI state ID₁,₂ may be mapped to the codepoint value 1 and so on. The TCI state IDi,₂ is optional based on the indication of the Cᵢ field, and whether the TCI state IDᵢ,₁ denotes the 1-st or 2-nd TCI state indicated for the i-th TCI codepoint of the TCI field in the beam indication DCI, and/or whether the TCI state IDi,₂ denotes the 1-st or 2-nd TCI state indicated for the i-th TCI codepoint of the TCI field in the beam indication DCI, could also be based on the indication of the Cᵢ field. The Cᵢ field indicates whether the octet containing TCI state IDi,₂ is present, and whether the TCI state IDᵢ,₁ (or the TCI state IDᵢ,₂) denotes the 1-st or 2-nd TCI state indicated for the i-th TCI codepoint of the TCI field in the beam indication DCI.

If the Cᵢ field is set to 0 (or 1 or 2), the octet containing TCI state IDi,₂ is not present. Furthermore, for this case, the TCI state IDᵢ,₁ could correspond to the 1-st TCI state indicated for the i-th TCI codepoint of the TCI field in the beam indication DCI. Optionally, the TCI state IDᵢ,₁ could be from or belong to the first (or second) group/list of TCI states/TCI state IDs (via RRC configuration) as specified herein in the present disclosure, or could be from or belong to the first (or second) subset of TCI states (in the beam indication/activation MAC CE) as specified herein in the present disclosure, and the UE could use/apply the TCI state IDᵢ,₁ to update the first TCI state as specified herein in the present disclosure.

If the Cᵢ field is set to 1 (or 0 or 2), the octet containing TCI state IDi,₂ is not present. Furthermore, for this case, the TCI state IDᵢ,₁ could correspond to the 2-nd TCI state indicated for the i-th TCI codepoint of the TCI field in the beam indication DCI. Optionally, the TCI state IDᵢ,₁ could be from or belong to the second (or first) group/list of TCI states/TCI state IDs (via RRC configuration) as specified herein in the present disclosure, or could be from or belong to the second (or first) subset of TCI states (in the beam indication/activation MAC CE) as specified herein in the present disclosure, and the UE could use/apply the TCI state IDᵢ,₁ to update the second TCI state as specified herein in the present disclosure.

If the Cᵢ field is set to 2 (or 0 or 1), the octet containing TCI state IDi,₂ is present. Furthermore, for this case, following examples can be provided.

For example, the TCI state IDᵢ,₁ could correspond to the 1-st TCI state indicated for the i-th TCI codepoint of the TCI field in the beam indication DCI, and the TCI state IDi,₂ could correspond to the 2-nd TCI state indicated for the i-th TCI codepoint of the TCI field in the beam indication DCI. Optionally, (1) the TCI state IDᵢ,₁ could be from or belong to the first (or second) group/list of TCI states/TCI state IDs (via RRC configuration) as specified herein in the present disclosure, or could be from or belong to the first (or second) subset of TCI states (in the beam indication/activation MAC CE) as specified herein in the present disclosure, and the UE could use/apply the TCI state IDᵢ,₁ to update the first TCI state as specified herein in the present disclosure; and (2) the TCI state IDi,₂ could be from or belong to the second (or first) group/list of TCI states/TCI state IDs (via RRC configuration) as specified herein in the present disclosure, or could be from or belong to the second (or first) subset of TCI states (in the beam indication/activation MAC CE) as specified herein in the present disclosure, and the UE could use/apply the TCI state IDi,₂ to update the second TCI state as specified herein in the present disclosure.

For another example, the TCI state IDᵢ,₁ could correspond to the 2-nd TCI state indicated for the i-th TCI codepoint of the TCI field in the beam indication DCI, and the TCI state IDi,₂ could correspond to the 1-st TCI state indicated for the i-th TCI codepoint of the TCI field in the beam indication DCI. Optionally, (1) the TCI state IDᵢ,₁ could be from or belong to the second (or first) group/list of TCI states/TCI state IDs (via RRC configuration) as specified herein in the present disclosure, or could be from or belong to the second (or first) subset of TCI states (in the beam indication/activation MAC CE) as specified herein in the present disclosure, and the UE could use/apply the TCI state IDᵢ,₁ to update the second TCI state as specified herein in the present disclosure; and (2) the TCI state IDi,₂ could be from or belong to the first (or second) group/list of TCI states/TCI state IDs (via RRC configuration) as specified herein in the present disclosure, or could be from or belong to the first (or second) subset of TCI states (in the beam indication/activation MAC CE) as specified herein in the present disclosure, and the UE could use/apply the TCI state IDi,₂ to update the first TCI state as specified herein in the present disclosure.

As specified herein in the present disclosure, the UE could maintain/track a first TCI state and a second TCI state for at least UE-dedicated reception on PDSCH/PDCCH and dynamic-grant/configured-grant PUSCH transmission and all of PUCCH transmission in a multi-TRP system. Throughout the present disclosure, when the UE would apply one or more indicated TCI states to only update the first TCI state, the UE could keep the second TCI state unchanged or maintain the second TCI state; for this case, the UE could maintain/track the updated first TCI state and the second TCI state for at least UE-dedicated reception on PDSCH/PDCCH and dynamic-grant/configured-grant PUSCH transmission and all of PUCCH transmission in a multi-TRP system.

Similarly, when the UE would apply one or more indicated TCI states to only update the second TCI state, the UE could keep the first TCI state unchanged or maintain the first TCI state; for this case, the UE could maintain/track the first TCI state and the updated second TCI state for at least UE-dedicated reception on PDSCH/PDCCH and dynamic-grant/configured-grant PUSCH transmission and all of PUCCH transmission in a multi-TRP system. In addition, when the UE would apply one or more indicated TCI states to update both of the first and second TCI states, the UE could maintain/track the updated first TCI state and the updated second TCI state for at least UE-dedicated reception on PDSCH/PDCCH and dynamic-grant/configured-grant PUSCH transmission and all of PUCCH transmission in a multi-TRP system.

Throughout the present disclosure, the first (or second) TCI state could correspond to a joint DL and UL TCI state provided by DLorJointTCI-State, a separate DL TCI state provided by DLorJointTCI-State, a separate UL TCI state provided by ULTCI-State or a pair of a separate DL TCI state and a separate UL TCI state.

In one example, when the first (or second) TCI state as specified herein in the present disclosure is a joint DL and UL TCI state provided by DLorJointTCI-State — denoted by a first joint DL and UL TCI state in the present disclosure, and the indicated TCI state to update the first (or second) TCI state is another joint DL and UL TCI state provided by DLorJointTCI-State — denoted by a second joint DL and UL TCI state in the present disclosure, the UE could apply the second joint DL and UL TCI state to update/replace the first joint DL and UL TCI state, and the UE could use/apply at least the second joint DL and UL TCI state for at least UE-dedicated reception on PDSCH/PDCCH and dynamic-grant/configured-grant PUSCH transmission and all of PUCCH transmission in a multi-TRP system.

In another example, when the first (or second) TCI state as specified herein in the present disclosure is a separate DL TCI state provided by DLorJointTCI-State — denoted by a first separate DL TCI state in the present disclosure, and when the indicated TCI state to update the first (or second) TCI state is a separate DL TCI state provided by DLorJointTCI-State — denoted by a second separate DL TCI state in the present disclosure, the UE could apply the second separate DL TCI state to update/replace the first separate DL TCI state, and the UE could use/apply at least the second separate DL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a separate DL TCI state provided by DLorJointTCI-State — denoted by a first separate DL TCI state in the present disclosure, and when the indicated TCI state to update the first (or second) TCI state is a separate UL TCI state provided by UL-TCIState — denoted by a first separate UL TCI state in the present disclosure.

For example, the UE could apply the first separate UL TCI state to update/replace the first separate DL TCI state, and the UE could use/apply at least the first separate UL TCI state for at least UE-dedicated reception on PDSCH/PDCCH and dynamic-grant/configured-grant PUSCH transmission and all of PUCCH transmission in a multi-TRP system.

For another example, the UE could still keep the first separate DL TCI state unchanged (i.e., not updated/replaced by the first separate UL TCI state), and the UE could use/apply at least the first separate DL TCI state for at least UE-dedicated reception on PDSCH/PDCCH and dynamic-grant/configured-grant PUSCH transmission and all of PUCCH transmission in a multi-TRP system.

Yet for another example, the UE could pair the first separate UL TCI state and the first separate DL TCI state, and the UE could use/apply at least the pair of the first separate UL TCI state and the first separate DL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a separate DL TCI state provided by DLorJointTCI-State — denoted by a first separate DL TCI state in the present disclosure, and when the indicated TCI state(s) to update the first (or second) TCI state is a pair of a separate DL TCI state provided by DLorJointTCI-State — denoted by a second separate DL TCI state and an UL TCI state provided by UL-TCIState — denoted by a first separate UL TCI state in the present disclosure.

For example, the UE could apply the pair of the second separate DL TCI state and the first separate UL TCI state to update/replace the first separate DL TCI state, and the UE could use/apply at least the pair of the second separate DL TCI state and the first separate UL TCI state for at least UE-dedicated reception on PDSCH/PDCCH and dynamic-grant/configured-grant PUSCH transmission and all of PUCCH transmission in a multi-TRP system.

For another example, the UE could apply the second separate DL TCI state in the pair to update/replace the first separate DL TCI state, and the UE could use/apply at least the second separate DL TCI state in the pair for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a separate UL TCI state provided by UL-TCIState — denoted by a first separate UL TCI state in the present disclosure, and when the indicated TCI state to update the first (or second) TCI state is a separate UL TCI state provided by UL-TCIState — denoted by a second separate UL TCI state in the present disclosure, the UE could apply the second separate UL TCI state to update/replace the first separate UL TCI state, and the UE could use/apply at least the second separate UL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a separate UL TCI state provided by UL-TCIState — denoted by a first separate UL TCI state in the present disclosure, and when the indicated TCI state to update the first (or second) TCI state is a separate DL TCI state provided by DLorJointTCI-State — denoted by a first separate DL TCI state in the present disclosure.

For example, the UE could apply the first separate DL TCI state to update/replace the first separate UL TCI state, and the UE could use/apply at least the first separate DL TCI state for at least UE-dedicated reception on PDSCH/PDCCH and dynamic-grant/configured-grant PUSCH transmission and all of PUCCH transmission in a multi-TRP system.

For another example, the UE could still keep the first separate UL TCI state unchanged (i.e., not updated/replaced by the first separate DL TCI state), and the UE could use/apply at least the first separate UL TCI state for at least UE-dedicated reception on PDSCH/PDCCH and dynamic-grant/configured-grant PUSCH transmission and all of PUCCH transmission in a multi-TRP system.

Yet for another example, the UE could pair the first separate UL TCI state and the first separate DL TCI state, and the UE could use/apply at least the pair of the first separate UL TCI state and the first separate DL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a separate UL TCI state provided by UL-TCIState — denoted by a first separate UL TCI state in the present disclosure, and when the indicated TCI state(s) to update the first (or second) TCI state is a pair of a separate DL TCI state provided by DLorJointTCI-State — denoted by a first separate DL TCI state — and an UL TCI state provided by UL-TCIState — denoted by a second separate UL TCI state in the present disclosure.

For example, the UE could apply the pair of the first separate DL TCI state and the second separate UL TCI state to update/replace the first separate UL TCI state, and the UE could use/apply at least the pair of the first separate DL TCI state and the second separate UL TCI state for at least UE-dedicated reception on PDSCH/PDCCH and dynamic-grant/configured-grant PUSCH transmission and all of PUCCH transmission in a multi-TRP system.

For another example, the UE could apply the second separate UL TCI state in the pair to update/replace the first separate UL TCI state, and the UE could use/apply at least the second separate UL TCI state in the pair for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a pair of a separate DL TCI state provided by DLorJointTCI-State — denoted by a first separate DL TCI state in the present disclosure — and an UL TCI state provided by UL-TCIState — denoted by a first separate UL TCI state in the present disclosure, and when the indicated TCI state(s) to update the first (or second) TCI state is a pair of a separate DL TCI state provided by DLorJointTCI-State — denoted by a second separate DL TCI state — and an UL TCI state provided by UL-TCIState — denoted by a second separate UL TCI state in the present disclosure, the UE could apply the pair of the second separate DL TCI state and the second separate UL TCI state to update/replace the pair of the first separate DL TCI state and the first separate UL TCI state, and the UE could use/apply at least the pair of the second separate DL TCI state and the second separate UL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a pair of a separate DL TCI state provided by DLorJointTCI-State — denoted by a first separate DL TCI state in the present disclosure — and an UL TCI state provided by UL-TCIState — denoted by a first separate UL TCI state in the present disclosure, and when the indicated TCI state to update the first (or second) TCI state is a separate DL TCI state provided by DLorJointTCI-State — denoted by a second separate DL TCI state in the present disclosure.

For example, the UE could apply the second separate DL TCI state to update/replace the pair of the first separate DL TCI state and the first separate UL TCI state, and the UE could use/apply at least the second separate DL TCI state for at least UE-dedicated reception on PDSCH/PDCCH and dynamic-grant/configured-grant PUSCH transmission and all of PUCCH transmission in a multi-TRP system.

For another example, the UE could apply the second separate DL TCI state to update/replace the first separate DL TCI state in the pair, and the UE could use/apply at least the pair of the second separate DL TCI state and the first separate UL TCI state for at least UE-dedicated reception on PDSCH/PDCCH and dynamic-grant/configured-grant PUSCH transmission and all of PUCCH transmission in a multi-TRP system.

In yet another example, when the first (or second) TCI state as specified herein in the present disclosure is a pair of a separate DL TCI state provided by DLorJointTCI-State — denoted by a first separate DL TCI state in the present disclosure — and an UL TCI state provided by UL-TCIState — denoted by a first separate UL TCI state in the present disclosure, and when the indicated TCI state to update the first (or second) TCI state is a separate UL TCI state provided by UL-TCIState — denoted by a second separate UL TCI state in the present disclosure.

For example, the UE could apply the second separate UL TCI state to update/replace the pair of the first separate DL TCI state and the first separate UL TCI state, and the UE could use/apply at least the second separate UL TCI state for at least UE-dedicated reception on PDSCH/PDCCH and dynamic-grant/configured-grant PUSCH transmission and all of PUCCH transmission in a multi-TRP system.

For another example, the UE could apply the second separate UL TCI state to update/replace the first separate UL TCI state in the pair, and the UE could use/apply at least the pair of the first separate DL TCI state and the second separate UL TCI state for at least UE-dedicated reception on PDSCH/PDCCH and dynamic-grant/configured-grant PUSCH transmission and all of PUCCH transmission in a multi-TRP system.

Throughout the present disclosure, the TCI state(s) I and TCI state(s) II as specified herein in the present disclosure could respectively correspond to the TCI state IDᵢ,₁ and the TCI state IDi,₂ in the beam indication/activation MAC CE, wherein as specified herein in the present disclosure i is the index of the TCI codepoint of the TCI field in the beam indication DCI, and TCI state IDᵢ,ⱼ could denote the j-th or (j-1)-th or (j+1)-th TCI state indicated for the i-th TCI codepoint of the TCI field in the beam indication DCI based on the indication of the Cᵢ field.

For the design examples specified herein in the present disclosure, the first and second subsets of activated TCI states in the beam indication/activation MAC CE could be associated to one or more PCIs or PCI indexes each pointing to an entry/PCI in a higher layer RRC configured list/set/pool of PCIs; e.g., the first and second subset indexes/IDs as specified herein in the present disclosure could correspond to PCIs/PCI indexes and indicated/provided in the beam indication/activation MAC CE.

For instance, the first subset index/ID of the first subset of activated TCI states in the beam indication/activation MAC CE could correspond to the serving cell PCI/PCI index, hence, the first subset of activated TCI states could be associated to the serving cell PCI/PCI index. And the second subset index/ID of the second subset of activated TCI states in the beam indication/activation MAC CE could correspond to a PCI/PCI index other than the serving cell PCI/PCI index, hence, the second subset of activated TCI states could be associated to the PCI/PCI index other than the serving cell PCI/PCI index. When one or more TCI states associated to the serving cell PCI/PCI index are indicated in the beam indication DCI, the UE could use/apply the one or more indicated TCI states for at least UE-dedicated reception on PDSCH/PDCCH and dynamic-grant/configured-grant PUSCH transmission and all of PUCCH transmission associated to the serving cell PCI/PCI index; when one or more TCI states associated to a PCI/PCI index other than the serving cell PCI/PCI index are indicated in the beam indication DCI, the UE could use/apply the one or more indicated TCI states for at least UE-dedicated reception on PDSCH/PDCCH and dynamic-grant/configured-grant PUSCH transmission and all of PUCCH transmission associated to the PCI other than the serving cell PCI/PCI index.

In one embodiment, the UE could be configured/provided/indicated, e.g., via higher layer RRC signaling and/or MAC CE command and/or dynamic DCI based L1 signaling, M≥1 or N ≥ 1 (e.g., M=2 or N=2) groups/lists of TCI states or TCI state IDs with each group/list comprising/containing/including one or more TCI states or TCI state IDs. The bitwidth of the TCI state ID in each group/list could be determined according to the total number of TCI states/TCI state IDs in the corresponding group/list. Alternatively, the bitwidth of the TCI state ID in each group/list could be determined according to the total number of TCI states/TCI state IDs across all the configured groups/lists. Furthermore, the TCI state ID(s) in different groups/lists may not overlap - i.e., different groups/lists may not comprise/include/contain the same TCI state(s) or TCI state ID(s). Additionally, each group/list of TCI states or TCI state IDs could be configured with a (unique) TCI state group/list ID.

For M=2 or N=2, the UE could be configured/provided/indicated by the network, e.g., via higher layer RRC signaling and/or MAC CE command and/or dynamic DCI based L1 signaling, a first group/list of I≥1 TCI states/TCI state IDs and a second group/list of J≥1 TCI states/TCI state IDs as specified herein in the present disclosure. The first group/list could be configured with a first TCI state group/list ID while the second group/list could be configured with a second TCI state group/list ID. For example, when the bitwidth of the TCI state ID in each group/list is determined according to the total number of TCI states/TCI state IDs in the corresponding group/list, the TCI state IDs in the first group/list could be {0, 1, ..., I - 1}, and the TCI state IDs in the second group/list could be {0, 1, ..., J - 1}.

For another example, when the bitwidth of the TCI state ID in each group/list is determined according to the total number of TCI states/TCI state IDs across both of the configured groups/lists, the TCI state IDs in the first group/list could be {0, 1, ..., I - 1}, while the TCI state IDs in the second group/list could be {I, I + 1, ..., I + J — 1}. As specified herein in the present disclosure, a (unified) TCI states activation/indication MAC CE could provide/indicate/include/contain/configure/activate up to K ≥ 1 sets of TCI states/pairs of TCI states used to map up to K≥ 1 TCI codepoints of one or more TCI fields in a beam indication DCI (e.g., DCI format 1_1/1_2 with or without DL assignment). The UE could receive one or multiple such (unified) TCI states activation/indication MAC CEs, e.g., in a slot or in a configured time period/window. Additionally, the UE could maintain/track a first TCI state and a second TCI state for at least UE-dedicated reception on PDSCH/PDCCH and dynamic-grant/configured-grant PUSCH transmission and all of PUCCH transmission in a multi-TRP system. When, e.g., each of the K sets of TCI states/pairs of TCI states contains/includes/comprises a single TCI state/pair of TCI states.

In one example, a one-bit indicator could be provided/indicated/configured in the beam activation/indication MAC CE, and therefore, associated to the K sets of TCI states/pairs of TCI states indicated/provided therein (and therefore, the corresponding Octet(s) in the MAC CE). When the one-bit indicator is set to “0” (or “1”), the UE could identify/determine that the K sets of TCI states/pairs of TCI states in the MAC CE are from the first group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the first TCI state. When the one-bit indicator is set to “1” (or “0”), the UE could identify/determine that the K sets of TCI states/pairs of TCI states in the MAC CE are from the second group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the second TCI state.

The one-bit indicator could also be provided/indicated/configured in a DCI — e.g., the beam indication DCI (a new/dedicated DCI field or by repurposing one or more bits of one or more existing DCI fields). The UE could identify/determine, according to/based on the one-bit indicator in the DCI, which of the first group/list of TCI states/TCI state IDs and/or the second group/list of TCI states/TCI state IDs the indicated set of TCI state/pair of TCI states is selected/determined from and/or which of the first TCI state and/or the second TCI state is updated by the indicated set of TCI state/pair of TCI states following those described/specified herein in the present disclosure. This design example can be for when the bitwidth of the TCI state ID in each group/list is determined according to the total number of TCI states/TCI state IDs in the corresponding group/list.

In another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. For this case, a one-bit indicator could be provided/indicated/configured in the beam activation/indication MAC CE, and therefore, associated to the K sets of TCI states/pairs of TCI states indicated/provided therein (and therefore, the corresponding Octet(s) in the MAC CE), and each value of the one-bit indicator could correspond to a PCI or PCI index pointing to an entry/PCI in the list/set/pool of PCIs.

When the one-bit indicator is set to “0” (or “1”), the UE could identify/determine that the K sets of TCI states/pairs of TCI states in the MAC CE are from the serving cell PCI and/or the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs); when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the first TCI state and/or for at least UE-dedicated reception(s) on PDCCH/PDSCH and/or dynamic-grant/configured-grant PUSCH and all of PUCCH transmission(s) associated with the serving cell PCI.

When the one-bit indicator is set to “1” (or “0”), the UE could identify/determine that the K sets of TCI states/pairs of TCI states in the MAC CE are from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs); when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. The one-bit indicator could also be provided/indicated/configured in a DCI — e.g., the beam indication DCI (a new/dedicated DCI field or by repurposing one or more bits of one or more existing DCI fields). The UE could identify/determine, according to/based on the one-bit indicator in the DCI, which of the serving cell PCI/PCI index and the PCI/PCI index other than the serving cell PCI/PCI index the indicated set of TCI state/pair of TCI states is associated with/from and/or which of the first group/list of TCI states/TCI state IDs and/or the second group/list of TCI states/TCI state IDs the indicated set of TCI state/pair of TCI states is selected/determined from and/or which of the first TCI state and/or the second TCI state is updated by the indicated set of TCI state/pair of TCI states following those described/specified herein in the present disclosure. This design example can be for when the bitwidth of the TCI state ID in each group/list is determined according to the total number of TCI states/TCI state IDs in the corresponding group/list.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. For this design example, a PCI value or a PCI index (pointing to an entry/PCI in the list/set/pool of PCIs) could be provided/indicated/configured in the beam activation/indication MAC CE, and therefore, associated to the K sets of TCI states/pairs of TCI states indicated/provided therein (and therefore, the corresponding Octet(s) in the MAC CE). When the PCI value corresponds to the serving cell PCI or the PCI index corresponds to the serving cell PCI index (e.g., pointing to the serving cell PCI in the list/set/pool of PCIs), the UE could identify/determine that the K sets of TCI states/pairs of TCI states in the MAC CE are from the serving cell PCI and/or the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs); when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the first TCI state and/or for at least UE-dedicated reception(s) on PDCCH/PDSCH and/or dynamic-grant/configured-grant PUSCH and all of PUCCH transmission(s) associated with the serving cell PCI.

When the PCI value corresponds to a PCI other than the serving cell PCI or a PCI index corresponds to a PCI other than the serving cell PCI index (e.g., pointing to a PCI other than the serving cell PCI in the list/set/pool of PCIs), the UE could identify/determine that the K sets of TCI states/pairs of TCI states in the MAC CE are from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs); when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. A/the PCI value or PCI index pointing to an entry/PCI in the set/list/pool of PCIs could also be provided/indicated/configured in a DCI — e.g., the beam indication DCI (a new/dedicated DCI field or by repurposing one or more bits of one or more existing DCI fields).

The UE could identify/determine, according to/based on the PCI/PCI index in the DCI, which of the serving cell PCI/PCI index and the PCI/PCI index other than the serving cell PCI/PCI index the indicated set of TCI state/pair of TCI states is associated with/from and/or which of the first group/list of TCI states/TCI state IDs and/or the second group/list of TCI states/TCI state IDs the indicated set of TCI state/pair of TCI states is selected/determined from and/or which of the first TCI state and/or the second TCI state is updated by the indicated set of TCI state/pair of TCI states following those described/specified herein in the present disclosure. This design example can be for when the bitwidth of the TCI state ID in each group/list is determined according to the total number of TCI states/TCI state IDs in the corresponding group/list.

In another example, a TCI state group/list ID could be provided/indicated/configured in the beam activation/indication MAC CE, and therefore, associated to the K sets of TCI states/pairs of TCI states indicated/provided therein (and therefore, the corresponding Octet(s) in the MAC CE). When the TCI state group/list ID corresponds to the first TCI state group/list ID as specified herein in the present disclosure, the UE could identify/determine that the K sets of TCI states/pairs of TCI states in the MAC CE are from the first group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the first TCI state. When the TCI state group/list ID corresponds to the second TCI state group/list ID as specified herein in the present disclosure, the UE could identify/determine that the K sets of TCI states/pairs of TCI states in the MAC CE are from the second group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the second TCI state.

The TCI state group/list ID could also be provided/indicated/configured in a DCI —e.g., the beam indication DCI (a new/dedicated DCI field or by repurposing one or more bits of one or more existing DCI fields). The UE could identify/determine, according to/based on the TCI state group/list ID in the DCI, which of the first group/list of TCI states/TCI state IDs and/or the second group/list of TCI states/TCI state IDs the indicated set of TCI state/pair of TCI states is selected/determined from and/or which of the first TCI state and/or the second TCI state is updated by the indicated set of TCI state/pair of TCI states following those described/specified herein in the present disclosure. This design example can be for when the bitwidth of the TCI state ID in each group/list is determined according to the total number of TCI states/TCI state IDs in the corresponding group/list. Here, a TCI state group/list ID could correspond to a PCI or a PCI index (pointing to an entry/PCI in the list/set/pool of PCIs).

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that the TCI state group/list ID(s) in each group/list of TCI state(s) corresponds to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s) of TCI state(s) for SDCI based inter-cell MTRP operation.

In yet another example, a bitmap of length two — e.g., denoted by [x y] with x=0 or 1 and y=0 or 1 — could be provided/indicated/configured in the beam activation/indication MAC CE, and therefore, associated to the K sets of TCI states/pairs of TCI states indicated/provided therein (and therefore, the corresponding Octet(s) in the MAC CE). When the bitmap is set to [1 0], the UE could identify/determine that the K sets of TCI states/pairs of TCI states are from the first group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the first TCI state.

When the bitmap is set to [0 1], the UE could identify/determine that the K sets of TCI states/pairs of TCI states are from the second group/list of TCI states/TCI state IDs; when one of the K sets is indicated by one or more TCI codepoints of one or more TCI fields in the beam indication DCI (e.g., DCI format 1_1/1_2 with or without DL assignment), the UE could apply the indicated set of TCI state/pair of TCI states to update the second TCI state. The bitmap could also be provided/indicated/configured in a DCI — e.g., the beam indication DCI (a new/dedicated DCI field or by repurposing one or more bits of one or more existing DCI fields). The UE could identify/determine, according to/based on the bitmap in the DCI, which of the first group/list of TCI states/TCI state IDs and/or the second group/list of TCI states/TCI state IDs the indicated set of TCI state/pair of TCI states is selected/determined from and/or which of the first TCI state and/or the second TCI state is updated by the indicated set of TCI state/pair of TCI states following those described/specified herein in the present disclosure.

This design example can be for when the bitwidth of the TCI state ID in each group/list is determined according to the total number of TCI states/TCI state IDs in the corresponding group/list. Here, the bitmap of [1 0] could correspond to a PCI or a PCI index (pointing to an entry/PCI in the list/set/pool of PCIs) - e.g., the serving cell PCI/PCI index, and the bitmap of [0 1] could correspond to another PCI or another PCI index (pointing to another entry/PCI in the list/set/pool of PCIs) - e.g., a PCI/PCI index other than the serving cell PCI/PCI index. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that the bitmap value(s) of [10] or [0 1] corresponds to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s) of TCI state(s) for SDCI based inter-cell MTRP operation.

In yet another example, when, e.g., the bitwidth of the TCI state ID in each group/list is determined according to the total number of TCI states/TCI state IDs across both of the configured groups/lists, the UE could identify, according to/based on the IDs of the K sets of TCI states/pairs of TCI states in the MAC CE, which of the first group/list of TCI states/TCI state IDs and/or the second group/list of TCI states/TCI state IDs the K sets of TCI states/pairs of TCI states in the MAC CE are selected/determined from.

For instance, the first group/list could contain/include/comprise TCI state IDs ranging from #0 - #7, while the second group/list could contain/include/comprise TCI state IDs ranging from #8 - #15. If the IDs of the TCI states in the MAC CE as specified herein in the present disclosure are #4 and #5, the UE could identify that the TCI states in the MAC CE are selected/determined from the first group/list of TCI states/TCI state IDs. When one of the K sets is indicated by one or more TCI codepoints of one or more TCI fields in the beam indication DCI (e.g., DCI format 1_1/1_2 with or without DL assignment), the UE could also identify, according to/based on the ID(s) of the indicated set of TCI state/pair of TCI states, which of the first TCI state and/or the second TCI state is updated by the indicated set of TCI state/pair of TCI states.

For instance, when/if the UE could identify, according to/based on the ID(s) of the indicated set of TCI state/pair of TCI states, that the indicated set of TCI state/pair of TCI states is selected/determined from the first group/list of TCI states/TCI state IDs, the UE could apply the indicated set of TCI state/pair of TCI states to update the first TCI state. When/if the UE could identify, according to/based on the ID(s) of the indicated set of TCI state/pair of TCI states, that the indicated set of TCI state/pair of TCI states is selected/determined from the second group/list of TCI states/TCI state IDs, the UE could apply the indicated set of TCI state/pair of TCI states to update the second TCI state. For this design example, the first group/list of TCI states/TCI state IDs could be associated to a PCI or PCI index pointing to an entry/PCI in the list/set/pool of PCIs - e.g., the serving cell PCI/PCI index as specified herein in the present disclosure, and the second group/list of TCI states/TCI state IDs could be associated to another PCI or PCI index pointing to another entry/PCI in the list/set/pool of PCIs - e.g., a PCI/PCI index other than the serving cell PCI/PCI index as specified herein in the present disclosure.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s) of TCI state(s) for SDCI based inter-cell MTRP operation.

When, e.g., each of the K sets of TCI states/pairs of TCI states contains/includes/comprises a first TCI state/pair of TCI states (referred to as first subset of TCI states/pairs of TCI states for all the K sets in the below examples) and a second TCI state/pair of TCI states (referred to as second subset of TCI states/pairs of TCI states for all the K sets in the below examples) - upon receiving the beam indication/activation MAC CE, the UE could follow those specified herein in the present disclosure, e.g., follow those described/specified in the design examples and their corresponding sub-examples, to determine or identify which of the activated TCI state(s) in the beam indication/activation MAC CE could be the first TCI state(s)/pair(s) of TCI states and/or the second TCI state(s)/pair(s) of TCI states in each of the K sets.

In one example, the UE could identify/determine, according to/based on fixed/predefined rule(s) or those provided in system specifications, that the first (or second) subset of TCI states/pairs of TCI states are from the first group/list of TCI states/TCI state IDs, and the second (or first) subset of TCI states/pairs of TCI states are from the second group/list of TCI states/TCI state IDs. When one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I (or TCI state(s) II) to update the first TCI state, and the TCI state(s) II (or TCI state(s) I) to update the second TCI state.

For this design example, the first group/list of TCI states/TCI state IDs could be associated to a PCI or PCI index pointing to an entry/PCI in the list/set/pool of PCIs - e.g., the serving cell PCI/PCI index as specified herein in the present disclosure, and the second group/list of TCI states/TCI state IDs could be associated to another PCI or PCI index pointing to another entry/PCI in the list/set/pool of PCIs - e.g., a PCI/PCI index other than the serving cell PCI/PCI index as specified herein in the present disclosure.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure to use/apply the configured/activated/indicated set(s)/subset(s) of TCI state(s) such as the TCI state(s) I and/or the TCI state(s) II for SDCI based inter-cell MTRP operation.

In another example, a one-bit indicator could be provided/indicated/configured in the beam activation/indication MAC CE, and therefore, associated to the K sets of TCI states/pairs of TCI states indicated/provided therein (and therefore, the corresponding Octet(s) in the MAC CE). When the one-bit indicator is set to “0” (or “1”), the UE could identify/determine that the first subset of TCI states/pairs of TCI states are from the first group/list of TCI states/TCI state IDs, and the second subset of TCI states/pairs of TCI states are from the second group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the first TCI state, and the TCI state(s) II to update the second TCI state.

When the one-bit indicator is set to “1” (or “0”), the UE could identify/determine that the first subset of TCI states/pairs of TCI states are from the second group/list of TCI states/TCI state IDs, and the second subset of TCI states/pairs of TCI states are from the first group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the second TCI state, and the TCI state(s) II to update the first TCI state. The one-bit indicator could also be provided/indicated/configured in a DCI - e.g., the beam indication DCI (a new/dedicated DCI field or by repurposing one or more bits of one or more existing DCI fields). The UE could identify/determine, according to/based on the one-bit indicator in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI.

Furthermore, a one-bit indicator could be provided/indicated/configured in the beam activation/indication MAC CE, and therefore, associated to the K sets of TCI states/pairs of TCI states (and therefore, the corresponding Octet(s) in the MAC CE), and each value of the one-bit indicator could be associated to one or more PCIs or PCI indexes each pointing to an entry/PCI in the list/set/pool of PCIs. When the one-bit indicator is set to “0” (or “1”), the UE could identify/determine that the first subset of TCI states/pairs of TCI states are from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and the UE could identify/determine that the second subset of TCI states/pairs of TCI states are from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs).

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the first TCI state and/or for at least UE-dedicated reception(s) on PDCCH/PDSCH and/or dynamic-grant/configured-grant PUSCH and all of PUCCH transmission(s) associated with the serving cell PCI, and the TCI state(s) II to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. When the one-bit indicator is set to “1” (or “0”), the UE could identify/determine that the second subset of TCI states/pairs of TCI states are from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs), and the UE could identify/determine that the first subset of TCI states/pairs of TCI states are from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs).

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI, and the TCI state(s) II to update the first TCI state and/or for at least UE-dedicated reception(s) on PDCCH/PDSCH and/or dynamic-grant/configured-grant PUSCH and all of PUCCH transmission(s) associated with the serving cell PCI. The one-bit indicator as specified herein in the present disclosure could also be provided/indicated/configured in a DCI - e.g., the beam indication DCI (a new/dedicated DCI field or by repurposing one or more bits of one or more existing DCI fields).

The UE could identify/determine, according to/based on the one-bit indicator in the DCI, which of the serving cell PCI/PCI index and the PCI/PCI index other than the serving cell PCI/PCI index the TCI state(s) I and/or TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a first one-bit indicator and a second one-bit indicator could be provided/indicated/configured in the beam activation/indication MAC CE, and therefore, respectively associated to the first subset of TCI states/pairs of TCI states and the second subset of TCI states/pairs of TCI states in the K sets of TCI states/pairs of TCI states indicated/provided therein (and therefore, the corresponding Octet(s) in the MAC CE). When the first (or second) one-bit indicator is set to “0” (or “1”), the UE could identify/determine that the first (or the second) subset of TCI states/pairs of TCI states are from the first group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I (or TCI state(s) II) to update the first TCI state.

When the first (or second) one-bit indicator is set to “1” (or “0”), the UE could identify/determine that the first (or second) subset of TCI states/pairs of TCI states are from the second group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I (or TCI state(s) II) to update the second TCI state. The first and second one-bit indicators as specified herein could also be provided/indicated/configured in a DCI - e.g., the beam indication DCI (a new/dedicated DCI field or by repurposing one or more bits of one or more existing DCI fields). The UE could identify/determine, according to/based on the first and second one-bit indicators in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. Furthermore, a first one-bit indicator and a second one-bit indicator could be provided/indicated/configured in the beam activation/indication MAC CE, and therefore, respectively associated to the first subset of TCI states/pairs of TCI states and the second subset of TCI states/pairs of TCI states in the K sets of TCI states/pairs of TCI states indicated/provided therein (and therefore, the corresponding Octet(s) in the MAC CE); in addition, each value of the first/second indicator could identify/indicate a PCI or PCI index pointing to an entry/PCI in the list/set/pool of PCIs.

When the first (or second) one-bit indicator is set to “0” (or “1”), the UE could identify/determine that the first (or the second) subset of TCI states/pairs of TCI states are from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs). For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I (or TCI state(s) II) to update the first TCI state and/or for at least UE-dedicated reception(s) on PDCCH/PDSCH and/or dynamic-grant/configured-grant PUSCH and all of PUCCH transmission(s) associated with the serving cell PCI. When the first (or second) one-bit indicator is set to “1” (or “0”), the UE could identify/determine that the first (or second) subset of TCI states/pairs of TCI states are from a PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs).

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I (or TCI state(s) II) to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. The first and second one-bit indicators as specified herein could also be provided/indicated/configured in a DCI - e.g., the beam indication DCI (a new/dedicated DCI field or by repurposing one or more bits of one or more existing DCI fields).

The UE could identify/determine, according to/based on the first and second one-bit indicators in the DCI, which of the serving cell PCI/PCI index and the PCI/PCI index other than the serving cell PCI/PCI index the TCI state(s) I and/or TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a UE could be indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI.

For this case, a first PCI or a first PCI index (pointing to an entry/PCI in the list/set/pool of PCIs) and a second PCI or a second PCI index (pointing to another entry/PCI in the list/set/pool of PCIs) could be provided/indicated/configured in the beam activation/indication MAC CE, and therefore, respectively associated to the first subset of TCI states/pairs of TCI states and the second subset of TCI states/pairs of TCI states in the K sets of TCI states/pairs of TCI states indicated/provided therein (and therefore, the corresponding Octet(s) in the MAC CE).

When the first PCI value corresponds to the serving cell PCI or the first PCI index corresponds to the serving cell PCI index (e.g., pointing to the serving cell PCI in the list/set/pool of PCIs), the UE could identify/determine that the first subset of TCI states/pairs of TCI states are from the serving cell PCI and/or from the first group/list of TCI states/TCI state IDs that are associated/corresponding to the serving cell PCI (e.g., by indicating/providing the serving cell PCI/PCI index in the higher layer parameter that configures the first group/list of TCI states/TCI state IDs). For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the first TCI state and/or for at least UE-dedicated reception(s) on PDCCH/PDSCH and/or dynamic-grant/configured-grant PUSCH and all of PUCCH transmission(s) associated with the serving cell PCI.

When the second PCI value corresponds to a PCI other than the serving cell PCI or the second PCI index corresponds to the PCI index other than the serving cell PCI index (e.g., pointing to the PCI other than the serving cell PCI in the list/set/pool of PCIs), the UE could identify/determine that the second subset of TCI states/pairs of TCI states are from the PCI other than the serving cell PCI and/or from the second group/list of TCI states/TCI state IDs that are associated/corresponding to the PCI other than the serving cell PCI (e.g., by indicating/providing the PCI/PCI index other than the serving cell PCI/PCI index in the higher layer parameter that configures the second group/list of TCI states/TCI state IDs).

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) II to update the second TCI state and/or for at least UE-dedicated reception(s) on PDCCH/PDSCH and/or dynamic-grant/configured-grant PUSCH and all of PUCCH transmission(s) associated with the PCI other than the serving cell PCI. The first and second PCIs/PCI indexes as specified herein could also be provided/indicated/configured in a DCI - e.g., the beam indication DCI (a new/dedicated DCI field or by repurposing one or more bits of one or more existing DCI fields).

The UE could identify/determine, according to/based on the first and second PCIs/PCI indexes in the DCI, which of the serving cell PCI/PCI index and the PCI/PCI index other than the serving cell PCI/PCI index the TCI state(s) I and/or TCI state(s) II is associated with/from and/or which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure.

In yet another example, a set of two TCI state group/list IDs (denoted by TCI state group/list ID 1 and TCI state group/list ID 2) could be provided/indicated/configured in the beam activation/indication MAC CE, and therefore, associated to the K sets of TCI states/pairs of TCI states indicated/provided therein (and therefore, the corresponding Octet(s) in the MAC CE). When the TCI state group/list ID 1 corresponds to the first TCI state group/list ID and the TCI state group/list ID 2 corresponds to the second TCI state group/list ID as specified herein in the present disclosure, the UE could identify/determine that the first subset of TCI states/pairs of TCI states are from the first group/list of TCI states/TCI state IDs, and the second subset of TCI states/pairs of TCI states are from the second group/list of TCI states/TCI state IDs.

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the first TCI state, and the TCI state(s) II to update the second TCI state. When the TCI state group/list ID 1 corresponds to the second TCI state group/list ID and the TCI state group/list ID 2 corresponds to the first TCI state group/list ID as specified herein in the present disclosure, the UE could identify/determine that the first subset of TCI states/pairs of TCI states are from the second group/list of TCI states/TCI state IDs, and the second subset of TCI states/pairs of TCI states are from the first group/list of TCI states/TCI state IDs.

For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the second TCI state, and the TCI state(s) II to update the first TCI state. The set of two TCI state group/list IDs (denoted by TCI state group/list ID 1 and TCI state group/list ID 2) could also be provided/indicated/configured in a DCI - e.g., the beam indication DCI (a new/dedicated DCI field or by repurposing one or more bits of one or more existing DCI fields).

The UE could identify/determine, according to/based on the set of two TCI state group/list IDs in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure. Here, the TCI state group/list ID 1 or the first TCI state group/list ID could correspond to a PCI or a PCI index (pointing to an entry/PCI in the list/set/pool of PCIs) - e.g., the serving cell PCI/PCI index, and the TCI state group/list ID 2 or the second TCI state group/list ID could correspond another PCI or another PCI index (pointing to another entry/PCI in the list/set/pool of PCIs) - e.g., the PCI/PCI index other than the serving cell PCI/PCI index.

When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the TCI state group/list ID 1 and TCI state group/list ID 2 (or equivalently, the first and the second TCI state group/list IDs) corresponds to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s)/subset(s) of TCI state(s) such as TCI state(s) I and/or TCI state(s) II for SDCI based inter-cell MTRP operation.

In yet another example, a bitmap of length two - e.g., denoted by [x y] with x=0 or 1 and y=0 or 1 - could be provided/indicated/configured in the beam activation/indication MAC CE, and therefore, associated to the K sets of TCI states/pairs of TCI states indicated/provided therein (and therefore, the corresponding Octet(s) in the MAC CE). When the bitmap is set to [0 1], the UE could identify/determine that the first subset of TCI states/pairs of TCI states are from the first group/list of TCI states/TCI state IDs, and the second subset of TCI states/pairs of TCI states are from the second group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the first TCI state, and the TCI state(s) II to update the second TCI state.

When the bitmap is set to [1 0], the UE could identify/determine that the first subset of TCI states/pairs of TCI states are from the second group/list of TCI states/TCI state IDs, and the second subset of TCI states/pairs of TCI states are from the first group/list of TCI states/TCI state IDs. For this case, when one of the K sets is indicated by one or more TCI codepoints of one or more TCI fields in the beam indication DCI (e.g., DCI format 1_1/1_2 with or without DL assignment) and the indicated set of TCI states/pairs of TCI states contains/includes/comprises a TCI state/pair of TCI states (denoted by TCI state(s) I) belonging to the first subset and another TCI state/pair of TCI states (denoted by TCI state(s) II) belonging to the second subset, the UE could apply the TCI state(s) I to update the second TCI state, and the TCI state(s) II to update the first TCI state.

The bitmap could also be provided/indicated/configured in a DCI - e.g., the beam indication DCI (a new/dedicated DCI field or by repurposing one or more bits of one or more existing DCI fields). The UE could identify/determine, according to/based on the bitmap in the DCI, which of the first group/list of TCI states/TCI state IDs and/or the second group/list of TCI states/TCI state IDs the TCI state(s) I and/or TCI state(s) II is selected/determined from and/or which of the first TCI state and/or the second TCI state are updated by the TCI state(s) I and/or TCI state(s) II following those described/specified herein in the present disclosure. Here, each value, i.e., 0 and/or 1, of an entry/bit position of the bitmap of [x y], i.e., x or y, could correspond to a PCI or a PCI index (pointing to an entry/PCI in the list/set/pool of PCIs) - e.g., the serving cell PCI/PCI index or a PCI/PCI index other than the serving cell PCI/PCI index. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each value of an entry/bit position of the bitmap corresponds to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s)/subset(s) of TCI state(s) such as TCI state(s) I and/or TCI state(s) II for SDCI based inter-cell MTRP operation.

In yet another example, when, e.g., the bitwidth of the TCI state ID in each group/list is determined according to the total number of TCI states/TCI state IDs across both of the configured groups/lists, the UE could identify, according to/based on the IDs of the K sets of TCI states/pairs of TCI states in the MAC CE, which of the first group/list of TCI states/TCI state IDs and/or the second group/list of TCI states/TCI state IDs the K sets of TCI states/pairs of TCI states in the MAC CE are selected/determined from. For instance, the first group/list could contain/include/comprise TCI state IDs ranging from #0 - #7, while the second group/list could contain/include/comprise TCI state IDs ranging from #8 - #15. If the IDs of the TCI states in the first subset of TCI states/pairs of TCI states as specified herein in the present disclosure are #4 and #5, the UE could identify that the first subset of TCI states/pairs of TCI states are selected/determined from the first group/list of TCI states/TCI state IDs, and if the IDs of the TCI states in the second subset of TCI states/pairs of TCI states as specified herein in the present disclosure are #9 and #11, the UE could identify that the second subset of TCI states/pairs of TCI states are selected/determined from the second group/list of TCI states/TCI state IDs.

When one of the K sets is indicated by one or more TCI codepoints of one or more TCI fields in the beam indication DCI (e.g., DCI format 1_1/1_2 with or without DL assignment), the UE could also identify, according to/based on the IDs of the indicated set of TCI state/pair of TCI states, which of the first TCI state and/or the second TCI state are updated by the indicated set of TCI state/pair of TCI states. For instance, when/if the UE could identify, according to/based on the ID of the TCI state(s) I (or TCI state(s) II) in the indicated set of TCI state/pair of TCI states, that the TCI state(s) I (or TCI state(s) II) is selected/determined from the first group/list of TCI states/TCI state IDs, the UE could apply the TCI state(s) I (or TCI state(s) II) to update the first TCI state. When/if the UE could identify, according to/based on the ID of the TCI state(s) I (or TCI state(s) II) in the indicated set of TCI state/pair of TCI states, that the TCI state(s) I (or TCI state(s) II) is selected/determined from the second group/list of TCI states/TCI state IDs, the UE could apply the TCI state(s) I (or TCI state(s) II) to update the second TCI state.

For this design example, the first group/list of TCI states/TCI state IDs could be associated to a PCI or PCI index pointing to an entry/PCI in the list/set/pool of PCIs - e.g., the serving cell PCI/PCI index as specified herein in the present disclosure, and the second group/list of TCI states/TCI state IDs could be associated to another PCI or PCI index pointing to another entry/PCI in the list/set/pool of PCIs - e.g., a PCI/PCI index other than the serving cell PCI/PCI index as specified herein in the present disclosure. When the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or indicated/provided/configured by the network, e.g., via higher layer RRC signaling/parameter and/or MAC CE command and/or dynamic DCI based L1 signaling, that each of the first and second groups/lists of TCI states/TCI state IDs is associated to a PCI or PCI index pointing to an entry/PCI in the list/set/pool of PCIs, the UE could follow those specified herein in the present disclosure, e.g., those specified in the examples of the present disclosure, to use/apply the configured/activated/indicated set(s)/subset(s) of TCI state(s) such as TCI state(s) I and/or TCI state(s) II for SDCI based inter-cell MTRP operation.

The UE could receive one or multiple (unified) TCI states activation/indication MAC CEs as specified herein in the present disclosure (e.g., those specified/described in the design examples and their corresponding sub-examples), e.g., in a slot or in a configured time period/window.

In the present disclosure, when M≥1 or N≥1 (e.g., M=2 or N=2) groups/lists of TCI states or TCI state IDs with each group/list comprising/containing/including one or more TCI states or TCI state IDs are configured and/or when the bitwidth of the TCI state ID in each group/list is determined according to the total number of TCI states/TCI state IDs in the corresponding group/list, the UE could follow one or more of the design examples in the present disclosure (e.g., the design examples and their corresponding sub-examples as specified herein in the present disclosure) to determine which of the M or N (e.g., M=2 or N=2) TCI state groups/lists the activated/indicated TCI state(s) in the beam indication/activation MAC CE/DCI is from and/or which of the TCI states that UE maintains/tracks (e.g., the first TCI state and the second TCI state in the above examples) could be updated by the activated/indicated TCI state(s) in the beam indication/activation MAC CE/DCI.

In particular, the UE could follow one or more of the indicators provided in the MAC CE/DCI (such as those specified in the design examples in the present disclosure) to determine which of the M or N (e.g., M=2 or N=2) TCI state groups/lists the activated/indicated TCI state(s) in the beam indication/activation MAC CE/DCI is from and/or which of the TCI states that UE maintains/tracks (e.g., the first TCI state and the second TCI state in the above examples) could be updated by the activated/indicated TCI state(s) in the beam indication/activation MAC CE/DCI.

In the present disclosure, when M≥1 or N≥1 (e.g., M=2 or N=2) groups/lists of TCI states or TCI state IDs with each group/list comprising/containing/including one or more TCI states or TCI state IDs are configured and/or when the bitwidth of the TCI state ID in each group/list is determined according to the total number of TCI states/TCI state IDs across all the configured groups/lists, the UE could follow one or more of the design examples in the present disclosure (e.g., the design examples and their corresponding sub-examples as specified herein in the present disclosure) to determine which of the M or N (e.g., M=2 or N=2) TCI state groups/lists the activated/indicated TCI state(s) in the beam indication/activation MAC CE/DCI is from and/or which of the TCI states that UE maintains/tracks (e.g., the first TCI state and the second TCI state in the above examples) could be updated by the activated/indicated TCI state(s) in the beam indication/activation MAC CE/DCI.

In particular, the UE could follow the ID(s) of the activated/indicated TCI state(s) in the beam indication/activation MAC CE/DCI (such as those specified in the design examples in the present disclosure) to determine which of the M or N (e.g., M=2 or N=2) TCI state groups/lists the activated/indicated TCI state(s) in the beam indication/activation MAC CE/DCI is from and/or which of the TCI states that UE maintains/tracks (e.g., the first TCI state and the second TCI state in the above examples) could be updated by the activated/indicated TCI state(s) in the beam indication/activation MAC CE/DCI.

In one embodiment, the UE could be configured/provided/indicated, e.g., via higher layer RRC signaling and/or MAC CE command and/or dynamic DCI based L1 signaling, M≥1 or N ≥ 1 (e.g., M=2 or N=2) groups/lists of SSBs or SSB indexes with each group/list comprising/containing/including one or more SSBs or SSB indexes. The bitwidth of the SSB index in each group/list could be determined according to the total number of SSBs/SSB indexes in the corresponding group/list. Alternatively, the bitwidth of the SSB index in each group/list could be determined according to the total number of SSBs/SSB indexes across all the configured groups/lists.

Furthermore, the SSB index(es) in different groups/lists may not overlap - i.e., different groups/lists may not comprise/include/contain the same SSB(s) or SSB index(es). Additionally, each group/list of SSBs or SSB indexes could be configured with a (unique) SSB group/list ID. The UE could also be configured/provided/indicated, e.g., via higher layer RRC signaling and/or MAC CE command and/or dynamic DCI based L1 signaling, a pool of TCI states or TCI state IDs. The UE could identify/determine or could be configured by the network one or more effective groups/lists of TCI states or TCI state IDs from the pool of TCI states/TCI state IDs such that the RS(s) in each of the TCI states in an effective group/list of TCI states/TCI state IDs corresponds to the SSB(s) in the same group/list of SSBs or is quasi co-located (QCLed) with the SSB(s) in the same group/list of SSBs.

The UE could then follow one or more of the design examples in the present disclosure (e.g., the design examples and their corresponding sub-examples as specified herein in the present disclosure) to determine which of the effective TCI state groups/lists (or the corresponding/associated SSB groups/lists) - e.g., by replacing the TCI state groups/lists in the design examples specified herein in the present disclosure with the effective TCI state groups/lists - the activated/indicated TCI state(s) in the beam indication/activation MAC CE/DCI is from (or the RS(s) in the activated/indicated TCI state(s) in the beam indication/activation MAC CE/DCI is QCLed with) and/or which of the TCI states that UE maintains/tracks (e.g., the first TCI state and the second TCI state in the above examples) could be updated by the activated/indicated TCI state(s) in the beam indication/activation MAC CE/DCI.

For M=2 or N=2, the UE could be configured/provided/indicated by the network, e.g., via higher layer RRC signaling and/or MAC CE command and/or dynamic DCI based L1 signaling, a first group/list of I≥1 SSBs/SSB indexes and a second group/list of J≥1 SSBs/SSB indexes as specified herein in the present disclosure. The first group/list could be configured with a first SSB group/list ID while the second group/list could be configured with a second SSB group/list ID. For example, when the bitwidth of the SSB index in each group/list is determined according to the total number of SSBs/SSB indexes in the corresponding group/list, the SSB indexes in the first group/list could be {0, 1, ..., I - 1}, and the SSB indexes in the second group/list could be {0, 1, ..., J - 1}.

For another example, when the bitwidth of the SSB index in each group/list is determined according to the total number of SSBs/SSB indexes across both of the configured groups/lists, the SSB indexes in the first group/list could be {0, 1, ..., I - 1}, while the SSB indexes in the second group/list could be {I, I + 1, ..., I + J - 1}. The UE could also be configured/provided/indicated, e.g., via higher layer RRC signaling and/or MAC CE command and/or dynamic DCI based L1 signaling, a pool of TCI states or TCI state IDs. The UE could identify/determine or could be configured by the network a first effective group/list of TCI states or TCI state IDs and a second effective group/list of TCI states or TCI state IDs from the pool of TCI states/TCI state IDs such that the RS(s) in each of the TCI states in the first effective group/list of TCI states/TCI state IDs corresponds to the SSB(s) in the first (or second) group/list of SSBs or is quasi co-located (QCLed) with the SSB(s) in the first (or second) group/list of SSBs, and the RS(s) in each of the TCI states in the second effective group/list of TCI states/TCI state IDs corresponds to the SSB(s) in the second (or first) group/list of SSBs or is quasi co-located (QCLed) with the SSB(s) in the second (or first) group/list of SSBs.

The association between the first/second effective groups/lists of TCI states/TCI state IDs and the first/second groups/lists of SSBs/SSB indexes could be (i) fixed in the system specification(s), (ii) configured/indicated by the network, e.g., via higher layer RRC signaling/parameter and/or MAC CE command and/or dynamic DCI based L1 signaling, and/or (iii) autonomously determined by the UE and reported to the network, e.g., in part of a CSI report or capability signaling. The UE could then follow one or more of the design examples in the present disclosure (e.g., the design examples and their corresponding sub-examples as specified herein in the present disclosure) to determine which of the first effective TCI state group/list (or the corresponding/associated first SSB group/list) and/or the second effective TCI state group/list (or the corresponding/associated second SSB group/list) - e.g., by replacing the first (second) TCI state group/list in the design examples specified herein in the present disclosure with the first (second) effective TCI state group/list - the activated/indicated TCI state(s) in the beam indication/activation MAC CE/DCI is from (or the RS(s) in the activated/indicated TCI state(s) in the beam indication/activation MAC CE/DCI is QCLed with) and/or which of the TCI states that UE maintains/tracks (e.g., the first TCI state and the second TCI state in the above examples) could be updated by the activated/indicated TCI state(s) in the beam indication/activation MAC CE/DCI.

A UE could be configured by the network, e.g., via higher layer RRC signaling/parameter and/or MAC CE command and/or dynamic DCI based L1 signaling, “joint” or “separate” mode for TCI state configuration, activation and/or indication. As specified herein in the present disclosure, the UE could maintain/track a first TCI state and a second TCI state for at least UE-dedicated reception on PDSCH/PDCCH and dynamic-grant/configured-grant PUSCH transmission and all of PUCCH transmission in a multi-TRP system. When/if the “joint” mode is configured/provided, the first/second TCI state could correspond to a joint TCI state provided by DLorJoint-TCIState. When/if the “separate” mode is configured/provided, the first/second TCI state could correspond a DL TCI state provided by DLorJoint-TCIState, an UL TCI state provided by ULTCI-State or a pair of DL and UL TCI states.

In one example, for a configured mode (i.e., “joint” or “separate”), the UE could update first TCI state(s)/pair(s) of TCI states activated/indicated/maintained/tracked under the configured mode, e.g., with/by second TCI state(s)/pair(s) of TCI states activated/indicated/maintained/tracked under the same configured mode, wherein the first TCI state(s)/pair(s) of TCI states and the second TCI state(s)/pair(s) of TCI states could be of the same TCI state type (i.e., “joint” or “separate”). For instance, for M=2 or N=2, for a configured mode (i.e., “joint” or “separate”), the UE could update one or more of the first TCI state and the second TCI state as specified herein in the present disclosure with one or more indicated TCI states according to those specified herein in the present disclosure, wherein the first TCI state, the second TCI state and the indicated TCI state(s) are of the same TCI state type (i.e., “joint” or “separate”).

In one example, a UE could be operation under a first mode (e.g., “joint” or “separate” as specified herein in the present disclosure) for TCI state configuration, activation and indication. The UE could then be configured by the network, e.g., via higher layer RRC signaling/parameter and/or MAC CE command and/or dynamic DCI based L1 signaling, a second mode (e.g., “joint” or “separate” as specified herein in the present disclosure) for TCI state configuration, activation and/or indication.

In one example, before the first TCI state(s)/pair(s) of TCI states activated/indicated under the second mode becomes effective or applicable (e.g., before the corresponding beam application time as specified herein in the present disclosure), the UE could continue to apply/use the TCI state(s)/pair(s) of TCI states activated/indicated/maintained/tracked under the first mode for at least UE-dedicated reception(s) on PDCCH/PDSCH and configured-grant/dynamic-grant PUSCH transmission(s) and all of PUCCH transmission(s).

In another example, after the first TCI state(s)/pair(s) of TCI states activated/indicated under the second mode becomes effective or applicable (e.g., after the corresponding beam application time as specified herein in the present disclosure), the UE could (start to) apply/use the TCI state(s)/pair(s) of TCI states activated/indicated/maintained/tracked under the second mode for at least UE-dedicated reception(s) on PDCCH/PDSCH and configured-grant/dynamic-grant PUSCH transmission(s) and all of PUCCH transmission(s). For this case, the UE may not need to update the TCI state(s)/pair(s) of TCI states activated/indicated/maintained/tracked under the first mode, e.g., with/by the TCI state(s)/pair(s) of TCI states activated/indicated/maintained/tracked under the second mode.

As specified herein in the present disclosure, one or more TCI states that are activated by/in a beam indication/activation MAC CE, e.g., (enhanced) unified TCI state activation/deactivation MAC CE, could be for single-DCI (SDCI) based MTRP operation and/or multi-DCI (MDCI) based MTRP operation.

In one example, the beam indication/activation MAC CE, e.g., (enhanced) unified TCI state(s) activation/deactivation MAC CE, could indicate/provide/configure one or more fields (or one or more MAC CE entries or one or more Octets) that could indicate the switching between single-DCI (SDCI) based MTRP operation and multi-DCI based MTRP operation.

For example, the field(s) could be new and/or dedicated field(s) in the MAC CE. For instance, the field(s) could correspond to a one-bit indicator; when/if the field(s) - or the one-bit indicator - is set to “0” (or “1”), the TCI state(s) activated in/by the MAC CE could be for the SDCI based MTRP operation; when/if the field(s) - or the one-bit indicator - is set to “1” (or “0”), the TCI state(s) activated in/by the MAC CE could be for the MDCI based MTRP operation.

For another example, the field(s) could correspond to one or more reserved (i.e., “R”) fields (or one or more reserved MAC CE entries or one or more reserved Octets) in the MAC CE that could be repurposed/used to indicate the switching between the SDCI and MDCI based MTRP operations. For instance, the field(s) could correspond to a “R” field repurposed/used as a one-bit indicator; when/if the repurposed field(s) – or the one-bit indicator – is set to “0” (or “1”), the TCI state(s) activated in/by the MAC CE could be for the SDCI based MTRP operation; when/if the repurposed field(s) – or the one-bit indicator – is set to “1” (or “0”), the TCI state(s) activated in/by the MAC CE could be for the MDCI based MTRP operation.

In another example, the UE could be indicated/provided/configured by the network, e.g., via higher layer RRC signaling/parameter and/or MAC CE command and/or dynamic DCI based L1 signaling, to switch between the SDCI based and MDCI based MTRP operations. For instance, when/if the UE is indicated/provided/configured by the network, e.g., via higher layer RRC signaling/parameter and/or MAC CE command and/or dynamic DCI based L1 signaling, that the SDCI based MTRP operation is enabled, the TCI states that are activated in/by the MAC CE are for the SDCI based MTRP operation; and when/if the UE is indicated/provided/configured by the network, e.g., via higher layer RRC signaling/parameter and/or MAC CE command and/or dynamic DCI based L1 signaling, that the MDCI based MTRP operation is enabled, the TCI states that are activated in/by the MAC CE are for the MDCI based MTRP operation.

For example, the UE could be indicated/provided/configured by the network, e.g., via higher layer RRC signaling and/or MAC CE command and/or dynamic DCI based L1 signaling, a one-bit indicator; when/if the one-bit indicator is set to “0” (or “1”), the SDCI based MTRP operation is enabled, and therefore, the TCI states that are activated by/in the MAC CE as specified herein in the present disclosure are for the SDCI based MTRP operation; and when/if the one-bit indicator is set to “1” (or “0”), the MDCI based MTRP operation is enabled, and therefore, the TCI states that are activated by/in the MAC CE as specified herein in the present disclosure are for the MDCI based MTRP operation.

For another example, the UE could be provided in PDCCH-Config two values (e.g., 0 and 1) of CORESETPoolIndex, and each CORESET could be configured/associated with a value of CORESETPoolIndex. For this case, the beam indication/activation MAC CE as specified herein in the present disclosure could provide/indicate/configure one or more fields (new/dedicated or reserved “R”) providing one or more values of CORESETPoolIndex, wherein each indicated CORESETPoolIndex value could be associated to at least one TCI state activated in/by the MAC CE. For this case, when/if the beam indication/activation MAC CE, e.g., (enhanced) unified TCI state activation/deactivation MAC CE, indicates/provides/configures/comprises/includes/contains one or more fields providing one or more (valid) values of CORESETPoolIndex, the TCI states activated by/in the MAC CE are for the MDCI based MTRP operation; otherwise, when/if the beam indication/activation MAC CE, e.g., (enhanced) unified TCI state activation/deactivation MAC CE, does not indicate/provide/configure/comprise/include/contain any CORESETPoolIndex value(s)/CORESETPoolIndex field(s) or indicates/provide/configures/comprises/includes/contains one or more fields providing invalid value(s) of CORESETPoolIndex or only value 0 (or 1) of CORESETPoolIndex, the TCI states activated in/by the MAC EC are for the SDCI based MTRP operation.

Yet for another example, when/if the UE is provided in PDCCH-Config or other relevant RRC signaling/parameters two values (e.g., 0 and 1) of CORESETPoolIndex or indicators that represent or are associated to the two values of CORESETPoolIndex, the TCI states activated by/in the MAC CE could be for the MDCI based MTRP operation; otherwise, e.g., when/if the UE is not provided in PDCCH-Config or other relevant RRC signaling/parameters two values (e.g., 0 and 1) of CORESETPoolIndex or indicators that represent or are associated to the two values of CORESETPoolIndex, or when/if the UE is provided in PDCCH-Config or other relevant RRC signaling/parameters only one value (e.g., either 0 or 1) of CORESETPoolIndex or indicator(s) that represents or is associated to the only one value of CORESETPoolIndex, the TCI states activated by/in the MAC CE could be for the SDCI based MTRP operation.

As specified herein in the present disclosure, the beam indication/activation MAC CE as specified herein in the present disclosure could also provide/indicate/configure one or more fields (new/dedicated or reserved “R”) providing one or more values of CORESETPoolIndex. When the MDCI based MTRP operation is enabled, or the TCI states activated by/in the MAC CE are for the MDCI based MTRP operation, according to those specified herein in the present disclosure, the CORESETPoolIndex value(s)/field(s) could also become applicable. Otherwise, the CORESETPoolIndex value(s)/field(s) in the beam indication/activation MAC CE may not be applicable.

When the MDCI based MTRP operation is enabled, or the TCI states activated by/in the MAC CE are for the MDCI based MTRP operation, according to those specified herein in the present disclosure, a set of TCI states (mapped to a TCI codepoint in the beam indication DCI) in the MAC CE could correspond to one or more of: (1) a joint TCI state (when the “joint” TCI state type/mode is configured); (2) a separate DL TCI state (when the “separate” TCI state type/mode is configured); (3) a separate UL TCI state (when the “separate” TCI state type/mode is configured); and/or (4) a pair of separate DL and UL TCI states (when the “separate” TCI state type/mode is configured).

When the SDCI based MTRP operation is enabled, or the TCI states activated by/in the MAC CE are for the SDCI based MTRP operation, according to those specified herein in the present disclosure, a set of TCI state(s) (mapped to a TCI codepoint in the beam indication DCI) in the MAC CE could correspond to one or more of the followings.

In addition, the UE could determine the mapping/association between the TCI state(s) in the set and different TRPs according to those specified herein in the present disclosure (e.g., according to the design examples and their sub-examples described herein in the present disclosure): (1) a joint TCI state (when the “joint” TCI state type/mode is configured); (2) a separate DL TCI state (when the “separate” TCI state type/mode is configured); (3) a separate UL TCI state (when the “separate” TCI state type/mode is configured); (4) a pair of separate DL and UL TCI states (when the “separate” TCI state type/mode is configured); (5) two joint TCI states (when the “joint” TCI state type/mode is configured); (6) two separate DL TCI states (when the “separate” TCI state type/mode is configured); (7) two separate UL TCI states (when the “separate” TCI state type/mode is configured); (8) a separate DL TCI state and a separate UL TCI state (when the “separate” TCI state type/mode is configured); (9) two pairs of separate DL and UL TCI states (when the “separate” TCI state type/mode is configured); (10) a separate DL TCI state and a pair of separate DL and UL TCI states (when the “separate” TCI state type/mode is configured); and/or (11) a separate UL TCI state and a pair of separate DL and UL TCI states (when the “separate” TCI state type/mode is configured).

The beam indication/activation MAC CE, e.g., (enhanced) unified TCI state(s) activation/deactivation MAC CE, could comprise/include/contain/indicate/configure/activate one or more TCI states for the SDCI based MTRP operation and one or more TCI states for the MDCI based MTRP operation. That is, both of the TCI state(s) for the SDCI based MTRP operation and the TCI state(s) for the MDCI based MTRP operation could be mixed in the same beam indication/activation MAC CE. The UE could be indicated/configured/provided by the network, e.g., via higher layer RRC signaling/parameter and/or MAC CE command and/or dynamic DCI based L1 signaling, which one or more of the TCI state(s) activated by/in the MAC CE could be for the SDCI based MTRP operation, and/or which one or more of the TCI state(s) activated by/in the same MAC CE could be for the MDCI based MTRP operation. Furthermore, the UE could be indicated/configured/provided by the network, e.g., via higher layer RRC signaling/parameter and/or MAC CE command and/or dynamic DCI based L1 signaling, association between the one or more TCI states for the MDCI based MTRP operation and the value(s) of CORESETPoolIndex.

As specified herein in the present disclosure, one or more TCI states that are activated by/in a beam indication/activation MAC CE, e.g., (enhanced) unified TCI state activation/deactivation MAC CE, could be for intra-cell MTRP and/or inter-cell MTRP operations. For both intra-cell and inter-cell MTRP operations, both SDCI and MDCI based schemes can be supported/enabled.

In one example, the beam indication/activation MAC CE, e.g., (enhanced) unified TCI state(s) activation/deactivation MAC CE, could indicate/provide/configure one or more fields (or one or more MAC CE entries or one or more Octets) that could indicate the switching between the intra-cell and inter-cell MTRP operations.

For example, the field(s) could be new and/or dedicated field(s) in the MAC CE. For instance, the field(s) could correspond to a one-bit indicator; when/if the field(s) – or the one-bit indicator – is set to “0” (or “1”), the TCI state(s) activated in/by the MAC CE could be for the intra-cell MTRP operation; when/if the field(s) – or the one-bit indicator – is set to “1” (or “0”), the TCI state(s) activated in/by the MAC CE could be for the inter-cell MTRP operation.

For another example, the field(s) could correspond to one or more reserved (i.e., “R”) fields (or one or more reserved MAC CE entries or one or more reserved Octets) in the MAC CE that could be repurposed/used to indicate the switching between the intra-cell and inter-cell MTRP operations. For instance, the field(s) could correspond to a “R” field repurposed/used as a one-bit indicator; when/if the repurposed field(s) – or the one-bit indicator – is set to “0” (or “1”), the TCI state(s) activated in/by the MAC CE could be for the intra-cell MTRP operation; when/if the repurposed field(s) – or the one-bit indicator – is set to “1” (or “0”), the TCI state(s) activated in/by the MAC CE could be for the inter-cell MTRP operation.

In another example, the UE could be indicated/provided/configured by the network, e.g., via higher layer RRC signaling/parameter and/or MAC CE command and/or dynamic DCI based L1 signaling, to switch between the intra-cell and inter-cell MTRP operations. For instance, when/if the UE is indicated/provided/configured by the network, e.g., via higher layer RRC signaling/parameter and/or MAC CE command and/or dynamic DCI based L1 signaling, that the intra-cell MTRP operation is enabled, the TCI states that are activated in/by the MAC CE are for the intra-cell MTRP operation; and when/if the UE is indicated/provided/configured by the network, e.g., via higher layer RRC signaling/parameter and/or MAC CE command and/or dynamic DCI based L1 signaling, that the inter-cell MTRP operation is enabled, the TCI states that are activated in/by the MAC CE are for the inter-cell MTRP operation.

For example, the UE could be indicated/provided/configured by the network, e.g., via higher layer RRC signaling and/or MAC CE command and/or dynamic DCI based L1 signaling, a one-bit indicator; when/if the one-bit indicator is set to “0” (or “1”), the intra-cell MTRP operation is enabled, and therefore, the TCI states that are activated by/in the MAC CE as specified herein in the present disclosure are for the intra-cell MTRP operation; and when/if the one-bit indicator is set to “1” (or “0”), the inter-cell MTRP operation is enabled, and therefore, the TCI states that are activated by/in the MAC CE as specified herein in the present disclosure are for the inter-cell MTRP operation.

For another example, when the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that the inter-cell MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or provided in PDCCH-Config or other relevant RRC signaling/parameters two values (e.g., 0 and 1) of CORESETPoolIndex or indicators that represent or are associated to the two values of CORESETPoolIndex, the TCI states activated by/in the MAC CE could be for the inter-cell MTRP operation; otherwise, the TCI states activated by/in the MAC CE could be for the intra-cell MTRP operation.

Yet for another example, when the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that the inter-cell MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, and/or when one or more PCIs/PCI indexes are provided/indicated in the MAC CE and associated to one or more TCI states activated/indicated therein according to those specified herein in the present disclosure such as those described in the design examples and their sub-examples in the present disclosure, and/or when one or more indicators representing/associating to one or more PCIs/PCI indexes are provided/indicated in the MAC CE and associated to one or more TCI states activated/indicated therein according to those specified herein in the present disclosure such as those described in the design examples and their sub-examples in the present disclosure, the TCI states activated by/in the MAC CE could be for the inter-cell MTRP operation; otherwise, the TCI states activated by/in the MAC CE could be for the intra-cell MTRP operation.

When the intra-cell MTRP operation is enabled as specified herein in the present disclosure, the UE could identify/determine, according to/based on those specified herein in the present disclosure - e.g., those described in the design examples and their sub-examples specified herein in the present disclosure, which of the first group/list of TCI states/TCI state IDs and/or the second group/list of TCI states/TCI state IDs the configured/activated/indicated TCI state(s) and/or set(s)/subset(s) of TCI state(s) such as the TCI state(s) I and/or TCI state(s) II is selected/determined from and/or which of the first TCI state and/or the second TCI state are updated by the configured/activated/indicated TCI state(s) and/or set(s)/subset(s) of TCI state(s) such as the TCI state(s) I and/or TCI state(s) II following those described/specified herein in the present disclosure.

When the inter-cell MTRP operation is enabled, the UE could identify/determine, according to/based on those specified herein in the present disclosure - e.g., those described in the design examples and their sub-examples specified herein in the present disclosure, which of the serving cell PCI/PCI index and the PCI/PCI index other than the serving cell PCI/PCI index the configured/activated/indicated TCI state(s) and/or set(s)/subset(s) of TCI state(s) such as the TCI state(s) I and/or TCI state(s) II is associated with/from and/or which of the first group/list of TCI states/TCI state IDs and/or the second group/list of TCI states/TCI state IDs the configured/activated/indicated TCI state(s) and/or set(s)/subset(s) of TCI state(s) such as the TCI state(s) I and/or TCI state(s) II is selected/determined from and/or which of the first TCI state and/or the second TCI state are updated by the configured/activated/indicated TCI state(s) and/or set(s)/subset(s) of TCI state(s) such as the TCI state(s) I and/or TCI state(s) II following those described/specified herein in the present disclosure.

The beam indication/activation MAC CE, e.g., (enhanced) unified TCI state(s) activation/deactivation MAC CE, could comprise/include/contain/indicate/configure/activate one or more TCI states for the intra-cell MTRP operation and one or more TCI states for the inter-cell MTRP operation. That is, both of the TCI state(s) for the intra-cell MTRP operation and the TCI state(s) for the inter-cell MTRP operation could be mixed in the same beam indication/activation MAC CE. The UE could be indicated/configured/provided by the network, e.g., via higher layer RRC signaling/parameter and/or MAC CE command and/or dynamic DCI based L1 signaling, which one or more of the TCI state(s) activated by/in the MAC CE could be for the intra-cell MTRP operation, and/or which one or more of the TCI state(s) activated by/in the same MAC CE could be for the inter-cell MTRP operation.

Furthermore, the UE could be indicated/configured/provided by the network, e.g., via higher layer RRC signaling/parameter and/or MAC CE command and/or dynamic DCI based L1 signaling, association between the one or more TCI states for the inter-cell MTRP operation and the PCI(s)/PCI index(es).

As specified herein in the present disclosure - e.g., those described in the design examples and their corresponding sub-examples, one or more indicators such as the one-bit indicator(s), TCI state group/list ID(s), PCI(s), PCI index(es) pointing to an entry/PCI in the list/set/pool of PCIs, bitmap(s) and etc. provided/indicated/configured in relevant RRC signaling/parameter(s) and/or beam indication/activation MAC CE(s) and/or dynamic DCI based L1 signaling could be generalized as/to one or more entity IDs, wherein an entity ID could correspond to an indicator specified herein in the present disclosure, and each entity ID could be TRP-specific.

Furthermore, an entity ID could also correspond to other TRP-specific ID(s)/index(es) such as TRP index/ID, CORESETPoolIndex (index/ID configured/associated to a pool of CORESETs), CORESETGroupIndex (index/ID configured/associated to a group of CORESETs), CORESET index/ID, RS index/ID, RS resource pair index/ID, RS resource set index/ID, RS resource setting index/ID, RS reporting setting index/ID, TRP-specific higher layer signaling index/ID, and etc.; For this case, one or more such (TRP-specific) entity IDs could be provided/indicated/configured in relevant RRC signaling/parameter(s) and/or beam indication/activation MAC CE(s) and/or dynamic DCI based L1 signaling, and could have similar/same functionalities/roles as the one or more indicators as specified herein in the present disclosure (such as the one-bit indicator(s), TCI state group/list ID(s), PCI(s), PCI index(es) pointing to an entry/PCI in the list/set/pool of PCIs, bitmap(s) and etc.) for the intra-cell MTRP, inter-cell MTRP, SDCI based MTRP and/or MDCI based MTRP operations.

As specified herein in the present disclosure, in a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling – e.g., in higher layer RRC signaling/parameter ControlResourceSet that configures a CORESET – a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET.

For instance, for N=2 (i.e., a set of two TCI states/pairs of TCI states are indicated), the first indicator could be a two-bit indicator with “00” indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, “01” indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, “10” indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)– e.g., first and second PDCCH candidates – in the corresponding CORESET(s), and “11” indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s) – e.g., first and second PDCCH candidates – in the corresponding CORESET(s), wherein the first and second PDCCH candidates could be received in search space sets that are higher layer linked via SearchSpaceLinking and/or the first and second PDCCH candidates carry the same/identical DCI payload.

Furthermore, throughout the present disclosure, the first TCI state(s) or the second TCI state(s) – specified herein in the present disclosure – could correspond to a joint DL and UL TCI state provided by TCI-State/DLorJointTCI-State, a separate DL TCI state provided by TCIState/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling - e.g., in a DL DCI (e.g., DCI format 1_0/1_1/1_2) that schedules the PDSCH - a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s).

For instance, for N=2 (i.e., a set of two TCI states/pairs of TCI states are indicated), the second indicator could be a two-bit indicator with “00” indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s) - e.g., scheduled by the DL DCI/PDCCH, “01” indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s) - e.g., scheduled by the DL DCI/PDCCH, “10” indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s) – e.g., first and second PDSCHs – e.g., scheduled by the DL DCI/PDCCH, and “11” indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s) – e.g., first and second PDSCHs – e.g., scheduled by the DL DCI/PDCCH, wherein the first and second PDSCHs could correspond to two PDSCH transmission occasions or repetition in space, time and/or frequency.

Furthermore, throughout the present disclosure, the first TCI state(s) or the second TCI state(s) – specified herein in the present disclosure – could correspond to a joint DL and UL TCI state provided by TCI-State/DLorJointTCI-State, a separate DL TCI state provided by TCIState/DLorJointTCI-State, a separate UL TCI state provided by TCI-State/UL-TCIState, or a pair of separate DL and separate UL TCI states.

Furthermore, for PDSCH reception in a (single-DCI based) multi-TRP system, for M=2 or N=2, as specified herein in the present disclosure, a UE could be configured/provided/indicated by the network, e.g., via higher layer RRC signaling and/or MAC CE command and/or dynamic DCI based L1 signaling, a first group/list of I≥1 TCI states/TCI state IDs and a second group/list of J≥1 TCI states/TCI state IDs. The first group/list could be configured with a first TCI state group/list ID while the second group/list could be configured with a second TCI state group/list ID. The UE could also be indicated/provided/configured by the network, e.g., via higher layer RRC signaling/parameter (e.g., by setting/configuring a higher layer parameter InterCellSDCIMTRP to ‘enabled’) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI. Additionally, the UE could maintain/track a first TCI state and a second TCI state for at least UE-dedicated reception on PDSCH/PDCCH and dynamic-grant/configured-grant PUSCH transmission and all of PUCCH transmission in a multi-TRP system.

When a single TCI state/pair of TCI states is indicated by a TCI codepoint of a TCI field in the beam indication DCI, the second indicator (if present) could also be used/applied to indicate which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure. For instance, when the second indicator is set to “00” (“01,” “10,” or “11”), the UE could determine/identify that the indicated TCI state(s) is from the first group/list of TCI states/TCI state IDs and use/apply the indicated TCI state(s) to update the first TCI state; when the second indicator is set to “01” (“00,” “10,” or “11”), the UE could determine/identify that the indicated TCI state(s) is from the second group/list of TCI states/TCI state IDs and use/apply the indicated TCI state(s) to update the second TCI state.

When a single TCI state/pair of TCI states is indicated by a TCI codepoint of a TCI field in the beam indication DCI, and when the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, the second indicator (if present) could also be used/applied to indicate which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For instance, when the second indicator is set to “00” (“01,” “10,” or “11”), the UE could determine/identify that the indicated TCI state(s) is from the first group/list of TCI states/TCI state IDs and associated to a first PCI (e.g., the serving cell PCI) according to those (e.g., the design example-X, example-Y and their corresponding sub-examples) specified herein in the present disclosure, and use/apply the indicated TCI state(s) to update the first TCI state for at least UE-dedicated reception(s) on PDCCH/PDSCH, configured-grant/dynamic-grant PUSCH transmission(s) and all of PUCCH transmission(s) associated to the first PCI; when the second indicator is set to “01” (“00,” “10,” or “11”), the UE could determine/identify that the indicated TCI state(s) is from the second group/list of TCI states/TCI state IDs and associated to a second PCI (e.g., a PCI other than the serving cell PCI) according to those (e.g., the design example-X, example-Y and their corresponding sub-examples) specified herein in the present disclosure, and use/apply the indicated TCI state(s) to update the second TCI state for at least UE-dedicated reception(s) on PDCCH/PDSCH, configured-grant/dynamic-grant PUSCH transmission(s) and all of PUCCH transmission(s) associated to the second PCI.

When two TCI states/pairs of TCI states - denoted by TCI state(s) A and TCI state(s) B - are indicated by a TCI codepoint of a TCI field in the beam indication DCI, the second indicator (if present) could also be used/applied to indicate which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For instance, when the second indicator is set to “00” (“01,” “10,” or “11”), the UE could determine/identify that the indicated TCI state(s) A is from the first group/list of TCI states/TCI state IDs and use/apply the indicated TCI state(s) A to update the first TCI state, and the indicated TCI state(s) B is from the second group/list of TCI states/TCI state IDs and use/apply the indicated TCI state(s) B to update the second TCI state; when the second indicator is set to “01” (“00,” “10,” or “11”), the UE could determine/identify that the indicated TCI state(s) A is from the second group/list of TCI states/TCI state IDs and use/apply the indicated TCI state(s) A to update the second TCI state, and the indicated TCI state(s) B is from the first group/list of TCI states/TCI state IDs and use/apply the indicated TCI state(s) B to update the first TCI state.

When two TCI states/pairs of TCI states - denoted by TCI state(s) A and TCI state(s) B - are indicated by a TCI codepoint of a TCI field in the beam indication DCI, and when the UE is indicated/provided/configured by the network, e.g., via higher layer RRC signaling/parameter (e.g., by setting/configuring a higher layer parameter InterCellSDCIMTRP to “enabled”) and/or MAC CE command and/or dynamic DCI based L1 signaling, that inter-cell SDCI based MTRP operation is enabled, and/or indicated/provided/configured by the network, e.g., via higher layer RRC signaling/parameter and/or MAC CE command and/or dynamic DCI based L1 signaling, a list/set/pool of PCIs comprising at least one PCI other than the serving cell PCI, the second indicator (if present) could also be used/applied to indicate which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For instance, when the second indicator is set to “00” (“01,” “10,” or “11”), the UE could determine/identify that the indicated TCI state(s) A is from the first group/list of TCI states/TCI state IDs and associated to a first PCI (e.g., the serving cell PCI) according to those (e.g., the design example-X, example-Y and their corresponding sub-examples) specified herein in the present disclosure, and use/apply the indicated TCI state(s) A to update the first TCI state for at least UE-dedicated reception(s) on PDCCH/PDSCH, configured-grant/dynamic-grant PUSCH transmission(s) and all of PUCCH transmission(s) associated to the first PCI, and the indicated TCI state(s) B is from the second group/list of TCI states/TCI state IDs and associated to a second PCI (e.g., a PCI other than the serving cell PCI) according to those (e.g., the design example-X, example-Y and their corresponding sub-examples) specified herein in the present disclosure, and use/apply the indicated TCI state(s) B to update the second TCI state for at least UE-dedicated reception(s) on PDCCH/PDSCH, configured-grant/dynamic-grant PUSCH transmission(s) and all of PUCCH transmission(s) associated to the second PCI; when the second indicator is set to “01” (“00,” “10,” or “11”), the UE could determine/identify that the indicated TCI state(s) A is from the second group/list of TCI states/TCI state IDs and associated to a second PCI (e.g., a PCI other than the serving cell PCI) according to those (e.g., the design example-X, example-Y and their corresponding sub-examples) specified herein in the present disclosure, and use/apply the indicated TCI state(s) A to update the second TCI state for at least UE-dedicated reception(s) on PDCCH/PDSCH, configured-grant/dynamic-grant PUSCH transmission(s) and all of PUCCH transmission(s) associated to the second PCI, and the indicated TCI state(s) B is from the first group/list of TCI states/TCI state IDs and associated to a first PCI (e.g., the serving cell PCI) according to those (e.g., the design example-X, example-Y and their corresponding sub-examples) specified herein in the present disclosure, and use/apply the indicated TCI state(s) B to update the first TCI state for at least UE-dedicated reception(s) on PDCCH/PDSCH, configured-grant/dynamic-grant PUSCH transmission(s) and all of PUCCH transmission(s) associated to the first PCI.

A UE could be provided/indicated/configured by the network, e.g., via higher layer RRC signaling/parameter and/or MAC CE command and/or dynamic DCI based L1 signaling, whether the second indicator (if present in the corresponding DCI) is applied for (i) indicating which of the first and second TCI states that the UE maintains/tracks – according to those specified herein in the present disclosure – to use for PDSCH reception(s) and/or (ii) indicating which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For instance, the UE could be provided/indicated/configured by the network an indicator, e.g., a one-bit flag indicator. In the present disclosure, the indicator, e.g., the one-bit flag indicator, could be a RRC signaling/parameter, an entry of a MAC CE activation/deactivation command, and/or a new or repurposed field in a DCI format (e.g., 1_1, 1_2, 0_1, 0_2 and etc.). When/if the indicator, e.g., the one-bit flag indicator, is set to “0” (or “1”) or “enabled” or configured/indicated/provided, the UE could identify/determine that the second indicator (if present in the corresponding DCI format) is to indicate which of the first and second TCI states that the UE maintains/tracks – according to those specified herein in the present disclosure – to use for PDSCH reception(s); otherwise, i.e., when/if the indicator, e.g., the one-bit flag indicator, is set to “1” (or “0”) or ‘disabled’ or not configured/indicated/provided, the UE could identify/determine that the second indicator (if present in the corresponding DCI format) is to indicate which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For certain settings of the indicator, the UE could identify/determine that the second indicator (if present in the corresponding DCI format) is to indicate both (1) which of the first and second TCI states that the UE maintains/tracks – according to those specified herein in the present disclosure – to use for PDSCH reception(s), and (2) which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure.

For PUCCH transmission in a (single-DCI based) multi-TRP system, a UE could be configured/provided/indicated by the network via higher layer RRC signaling/parameter and/or MAC CE command and/or dynamic DCI based L1 signaling – e.g., in higher layer RRC signaling/parameter PUCCH-Config that configures PUCCH(s)/PUCCH resource(s) – a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s).

For instance, for N=2 (i.e., a set of two TCI states/pairs of TCI states are indicated), the third indicator could be a two-bit indicator with “00” indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), “01” indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), “10” indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s) – e.g., first PUCCH/PUCCH resource and second PUCCH/PUCCH resource, and “11” indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s) – e.g., first PUCCH/PUCCH resource and second PUCCH/PUCCH resource, wherein the first and second PUCCHs/PUCCH resources could correspond to two PUCCH transmission occasions or repetitions in space, time and/or frequency.

Furthermore, throughout the present disclosure, the first TCI state(s) or the second TCI state(s) – specified herein in the present disclosure – could correspond to a joint DL and UL TCI state provided by TCI-State/DLorJointTCI-State, a separate DL TCI state provided by TCIState/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network via higher layer RRC signaling/parameter and/or MAC CE command and/or dynamic DCI based L1 signaling – e.g., in an UL DCI (e.g., DCI format 0_0/0_1/0_2) that schedules the PUSCH – a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s).

For instance, for N=2 (i.e., a set of two TCI states/pairs of TCI states are indicated), the fourth indicator could be a two-bit indicator with “00” indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s) – e.g., scheduled by the UL DCI/PDCCH, “01” indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s) – e.g., scheduled by the UL DCI/PDCCH, “10” indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s) – e.g., first and second PUSCHs – e.g., scheduled by the UL DCI/PDCCH, and “11” indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s) - e.g., first and second PUSCHs - e.g., scheduled by the UL DCI/PDCCH, wherein the first and second PUSCHs could correspond to two PUSCH transmission occasions or repetition in space, time and/or frequency.

Furthermore, throughout the present disclosure, the first TCI state(s) or the second TCI state(s) – specified herein in the present disclosure – could correspond to a joint DL and UL TCI state provided by TCI-State/DLorJointTCI-State, a separate DL TCI state provided by TCIState/DLorJointTCI-State, a separate UL TCI state provided by TCI-State/UL-TCIState, or a pair of separate DL and separate UL TCI states.

The fourth indicator could correspond to the 2-bit SRS resource set indicator in the corresponding DCI format (e.g., 0_1 and/or 0_2) repurposed to indicate which one or more of the set of TCI states/pairs of TCI states.

A UE could receive from the network a DCI that schedules aperiodic CSI report(s) -e.g., on PUSCH - by a “CSI request” field in the DCI (e.g., DCI format 0_1). The UE could determine a trigger/triggering state initiated/indicated by the “CSI request” field in the DCI. The trigger/triggering state – configured using the higher layer parameter CSI-AperiodicTriggerState – initiated/indicated by the “CSI request” field in the DCI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).

In a SDCI based MTRP system, the UE could first determine which one or more of the set of TCI states/pairs of TCI states (e.g., one or more joint DL and UL TCI states or one or more separate DL TCI states provided by DLorJoint-TCIState) indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure. The UE could then measure the CSI-RS(s) triggered by/associated to the trigger/triggering state as specified herein in the present disclosure, and use/apply the corresponding measurement result(s) for the aperiodic CSI reporting.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to the first indicator configured/associated with the CORESET(s) as specified herein in the present disclosure, in which the PDCCH candidate(s) that carries the corresponding DCI (e.g., DCI format 0_1) that indicates the “CSI request” field is received.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

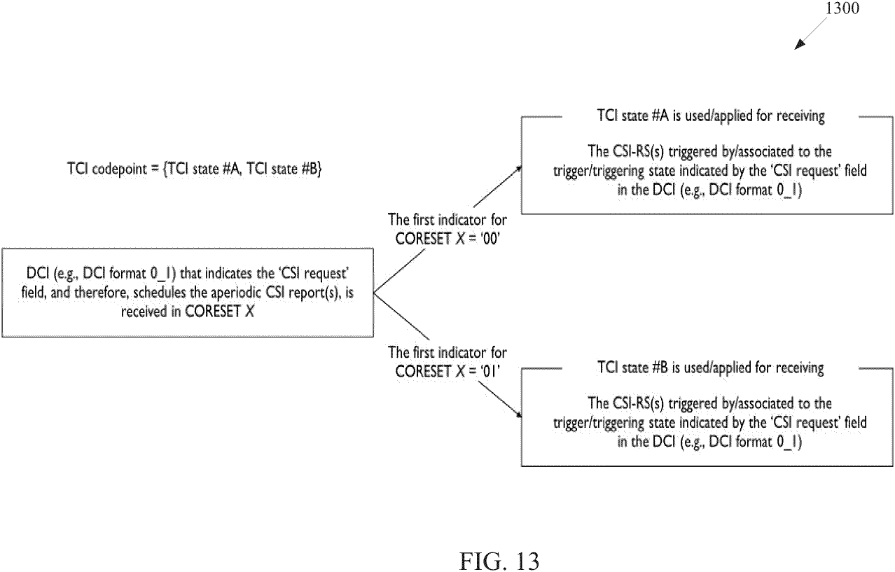

FIG. 13 illustrates an example of associating TCI states to aperiodic CSI-RS resources 1300 according to embodiments of the present disclosure. An embodiment of associating the TCI states to the aperiodic CSI-RS resources 1300 shown in FIG. 13 is for illustration only.

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In FIG. 13, a conceptual example of the above described design procedure(s) is provided. As depicted/illustrated in FIG. 13, when the first indicator for CORESET X is set to “00,” wherein PDCCH candidate(s) that carries the DCI (e.g., DCI format 0_1) that indicates the “CSI request” field is received in CORESET X, the first TCI state(s), i.e., TCI state #A among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1); when the first indicator for CORESET X is set to “01,” wherein PDCCH candidate(s) that carries the DCI (e.g., DCI format 0_1) that indicates the “CSI request” field is received in CORESET X, the second TCI state(s), i.e., TCI state #B among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1).

In yet another example, a (new or repurposed) DCI indicator field could be indicated/provided in the DCI (e.g., DCI format 0_1) that indicates the “CSI request” field, and therefore, triggers/schedules the aperiodic CSI report(s). For instance, the DCI indicator could be a 2-bit indicator with four states/representations “00,” “01,” “10” and “11.” As described herein in the present disclosure, the (2-bit) DCI indicator field could be a new/dedicated DCI field, e.g., denoted by “TCI selection” field, in the corresponding DCI format that indicates/provides the “CSI request” field. Alternatively, the (2-bit) DCI indicator field could be implemented/realized by repurposing one or more DCI field bits of one or more existing DCI fields in the corresponding DCI format that indicates/provides the “CSI request” field.

For example, when/if the (2-bit) DCI indicator in the DCI (e.g., DCI format 0_1) is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the (2-bit) DCI indicator in the DCI (e.g., DCI format 0_1) is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the (2-bit) DCI indicator in the DCI (e.g., DCI format 0_1) is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In addition to the DCI based L1 signaling, optionally, the UE could be provided/indicated/configured by the network, e.g., via higher layer RRC signaling/parameter and/or MAC CE command, the (2-bit) indicator.

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to in which CORESET(s), the PDCCH candidate(s) that carries the corresponding DCI (e.g., DCI format 0_1) that indicates the “CSI request” field is received.

For example, when/if the PDCCH candidate(s) that carries the DCI (e.g., DCI format 0_1) that indicates the “CSI request” field is received in CORESET(s) associated/configured with the first indicator as specified herein in the present disclosure set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the PDCCH candidate(s) that carries the DCI (e.g., DCI format 0_1) that indicates the “CSI request” field is received in CORESET(s) associated/configured with the first indicator as specified herein in the present disclosure set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the PDCCH candidate(s) that carries the DCI (e.g., DCI format 0_1) that indicates the “CSI request” field is received in CORESET(s) associated/configured with the first indicator as specified herein in the present disclosure set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

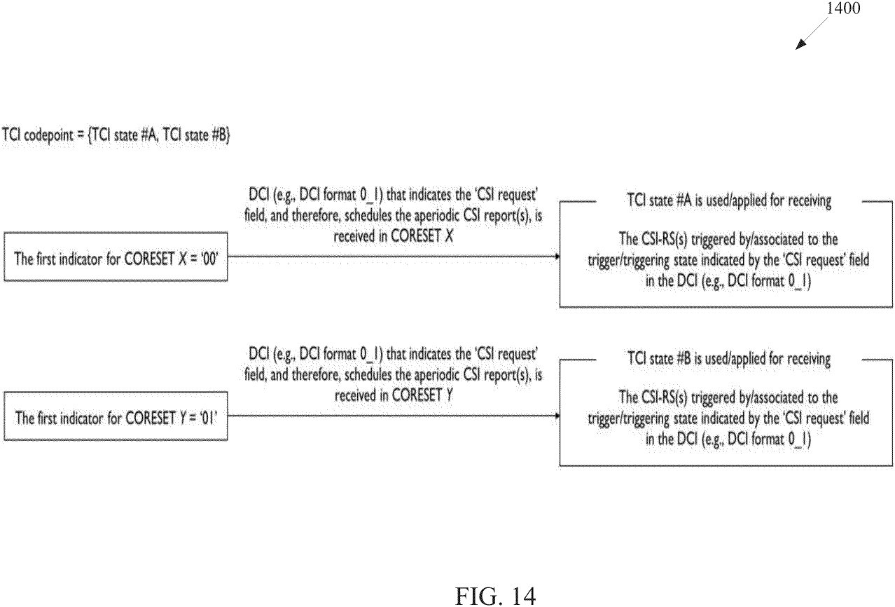

FIG. 14 illustrates another example of associating TCI states to aperiodic CSI-RS resources 1400 according to embodiments of the present disclosure. An embodiment of associating the TCI states to the aperiodic CSI-RS resources 1400 shown in FIG. 14 is for illustration only.

In FIG. 14, a conceptual example depicting the above discussed design procedure(s) is presented. As illustrated in FIG. 14, when/if the DCI (e.g., DCI format 0_1) that indicates the “CSI request” field, and therefore, schedules the aperiodic CSI report(s) is received in CORESET X configured/associated with the first indicator set to “00,” the first TCI state, i.e., TCI state #A among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1); when/if the DCI (e.g., DCI format 0_1) that indicates the “CSI request” field, and therefore, schedules the aperiodic CSI report(s) is received in CORESET Y configured/associated with the first indicator set to “01,” the second TCI state, i.e., TCI state #B among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1).

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to the first indicator configured/associated with the CORESET(s) as specified herein in the present disclosure, in which the PDCCH candidate(s) that carries the corresponding DCI (e.g., DCI format 0_1) that indicates the “CSI request” field is received, and a (new or repurposed) DCI indicator field indicated/provided in the DCI (e.g., DCI format 0_1) that indicates the “CSI request” field, and therefore, triggers/schedules the aperiodic CSI report(s).

For instance, the DCI indicator could be a 1-bit flag indicator with two states/representations “0” and “1.” As described herein in the present disclosure, the (1-bit) DCI indicator field could be a new/dedicated DCI field, e.g., denoted by “TRP selection” field, in the corresponding DCI format that indicates/provides the “CSI request” field. Alternatively, the (1-bit) DCI indicator field could be implemented/realized by repurposing one or more DCI field bits of one or more existing DCI fields in the corresponding DCI format that indicates/provides the “CSI request” field.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” and the 1-bit DCI indicator in the DCI (e.g., DCI format 0_1) is set to “0” (or “1”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” and the 1-bit DCI indicator in the DCI (e.g., DCI format 0_1) is set to “1” (or “0”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” and the 1-bit DCI indicator in the DCI (e.g., DCI format 0_1) is set to “0” (or “1”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” and the 1-bit DCI indicator in the DCI (e.g., DCI format 0_1) is set to “1” (or “0”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In addition to the DCI based L1 signaling, optionally, the UE could be provided/indicated/configured by the network, e.g., via higher layer RRC signaling/parameter and/or MAC CE command, the (1-bit) indicator.

The aperiodic CSI-RS resource(s) specified herein in the present disclosure could be (higher layer) configured to follow one or more of the indicated TCI states for at least the UE-dedicated channels such as PDCCH(s) and/or PDSCH(s).

A UE could receive from the network a DCI that indicates a “SRS request” field. The “SRS request” field in DCI format 0_1, 1_1, 0_2 (if the “SRS request” field is present), 1_2 (if the “SRS request” field is present) indicates the corresponding triggered SRS resource set. The 2-bit “SRS request” field in DCI format 2_3 indicates the corresponding triggered SRS resource set and defined by the entries of the higher layer parameter srs-ResourceSetToAddModList if the UE is configured with higher layer parameter srs-TPC-PDCCH-Group set to “typeB,” or indicates the SRS transmission on a set of serving cells configured by higher layers if the UE is configured with higher layer parameter srs-TPC-PDCCH-Group set to “typeA.”

For this case, the UE could be indicated/configured/provided by the network, e.g., via higher layer RRC signaling/parameter and/or MAC CE command and/or dynamic DCI based L1 signaling, whether (i) the SRS resource set indicator is used/repurposed as the fourth indicator as specified herein in the present disclosure, or (ii) the SRS resource set indicator is used to determine the associated SRS resource indicator (field) and Precoding information and number of layers (field) for the uplink transmission(s) as specified in the Rel-16/17. For instance, the UE could be provided/indicated/configured by the network a one-bit flag indicator. In the present disclosure, the one-bit flag indicator could be a RRC signaling/parameter, an entry of a MAC CE activation/deactivation command, and/or a new or repurposed field in a DCI format (e.g., 1_1, 1_2, 0_1/0_2 - with the SRS resource set indicator field present). When/if the one-bit flag indicator is set to “0” (or “1”) or “enabled” or configured/indicated/provided, the UE could use/interpret/determine that the SRS resource set indicator is used/repurposed as the fourth indicator as specified herein in the present disclosure; otherwise, i.e., when/if the one-bit flag indicator is set to “1” (or “0”) or ‘disabled’ or not configured/indicated/provided, the UE could use/interpret/determine that the SRS resource set indicator is used to determine the associated SRS resource indicator (field) and Precoding information and number of layers (field) for the uplink transmission(s) as specified in the Rel-16/17.

As specified herein in the present disclosure, the second indicator (if present in the corresponding DCI) could be applied for (i) indicating which of the first and second TCI states that the UE maintains/tracks – according to those specified herein in the present disclosure – to use for PDSCH reception(s) and/or (ii) indicating which of the serving cell PCI/PCI index and the PCI/PCI index other than the serving cell PCI/PCI index the indicated TCI state(s) is associated with/from and/or which of the first group/list of TCI states/TCI state IDs and/or the second group/list of TCI states/TCI state IDs the indicated TCI state(s) is selected/determined from and/or which of the first TCI state and/or the second TCI state is updated by the indicated TCI state(s) following those described/specified herein in the present disclosure; the corresponding/same network’s configuration(s)/indication(s)/operation(s) and the corresponding/same UE’s operation(s)/behavior(s) specified for the second indicator (if present in the corresponding DCI format) as specified herein in the present disclosure could be extended to/applied for PUSCH transmission(s) – e.g., by replacing the second indicator with the fourth indicator, and by replacing the downlink channels/signals/operations with the uplink counterparts, in the above design examples/descriptions.

As specified herein in the present disclosure (e.g., in the design example-X, example-Y and their corresponding sub-examples in the present disclosure), the UE could be configured/provided/indicated by the network, e.g., via higher layer RRC signaling and/or MAC CE command and/or dynamic DCI based L1 signaling, a first group/list of TCI states/TCI state IDs or SSBs/SSB indexes - e.g., associated to a first TRP or first TCI state(s) of a TCI codepoint – and/or a second group/list of TCI states/TCI state IDs or SSBs/SSB indexes – e.g., associated to a second TRP or second TCI state(s) of a TCI codepoint - as specified herein in the present disclosure. The UE could use/apply, e.g., by default, only the first (or second) group/list of TCI states/TCI state IDs or SSBs/SSB indexes according to those specified herein in the present disclosure (e.g., those specified in the design example-X, example-Y and their corresponding sub-examples in the present disclosure) for TCI state(s) configuration/activation/indication. When/if one or more of the following conditions are achieved/satisfied, the UE could use/apply the additional second (or first) group/list of TCI states/TCI state IDs or SSBs/SSB indexes, or equivalently, both of the first and second groups/lists of TCI states/TCI state IDs or SSBs/SSB indexes according to those specified herein in the present disclosure (e.g., those specified in the design example-X, example-Y and their corresponding sub-examples in the present disclosure) for TCI state(s) configuration/activation/indication in a multi-TRP system.

The second indicator for PDSCH reception(s) – as specified herein in the present disclosure – is (RRC configured to be) present in the corresponding DCI format.

The SRS resource set indicator in a corresponding DCI format (e.g., 0_1 and/or 0_2) –as specified herein in the present disclosure – is, according to network’s configuration/indication, used/repurposed as the fourth indicator as specified herein in the present disclosure.

Different or separate beams or TCI states are indicated for PDCCH and PDSCH reception(s) – e.g., the UE could be indicated/provided/configured by the network different values of the first indicator for PDCCH reception(s) and the second indicator for PDSCH reception(s).

Different or separate beams or TCI states are indicated for PUCCH and PUSCH transmission(s) – e.g., the UE could be indicated/provided/configured by the network different values of the third indicator for PUCCH transmission(s) and the fourth indicator for PUSCH transmission(s).

Different or separate beams or TCI states are indicated for any two of the PDCCH reception(s), PDSCH reception(s), PUCCH transmission(s) and PUSCH transmission(s) - e.g., the UE could be indicated/provided/configured by the network different values of any two of the first, second, third and fourth indicators specified herein in the present disclosure.

The UE receives from the network a RRC signaling/parameter that configures/indicates the presence or absence of the second indicator in the corresponding DCI format according to those specified herein in the present disclosure.

The UE receives from the network a RRC signaling/parameter and/or a MAC CE activation/deactivation command and/or a DCI indicator that configures/indicates the presence or absence of the fourth indicator in the corresponding DCI format, e.g., whether or not the SRS resource set indicator in the corresponding DCI format is used/repurposed as the fourth indicator, according to those specified herein in the present disclosure.

Otherwise, e.g., when/if one or more of the following conditions are achieved/satisfied, the UE could use/apply only the first (or second) group/list of TCI states/TCI state IDs or SSBs/SSB indexes according to those specified herein in the present disclosure (e.g., those specified in the design example-X, example-Y and their corresponding sub-examples in the present disclosure) for TCI state(s) configuration/activation/indication, i.e., the default operation.

The second indicator for PDSCH reception(s) – as specified herein in the present disclosure – is (RRC configured to be) not present or absent in the corresponding DCI format.

The SRS resource set indicator in a corresponding DCI format (e.g., 0_1 and/or 0_2) –as specified herein in the present disclosure – is, according to network’s configuration/indication, used to determine the associated SRS resource indicator (field) and Precoding information and number of layers (field) for the uplink transmission(s) as specified in the Rel-16/17.

Same beam(s) or TCI state(s) could be indicated for PDCCH and PDSCH reception(s) – e.g., the UE could be indicated/provided/configured by the network the same value(s) of the first indicator for PDCCH reception(s) and the second indicator for PDSCH reception(s).

Same beam(s) or TCI state(s) could be indicated for PUCCH and PUSCH transmission(s) – e.g., the UE could be indicated/provided/configured by the network the same value(s) of the third indicator for PUCCH transmission(s) and the fourth indicator for PUSCH transmission(s).

Same beam(s) or TCI state(s) could be indicated for all of the PDCCH reception(s), PDSCH reception(s), PUCCH transmission(s) and PUSCH transmission(s) – e.g., the UE could be indicated/provided/configured by the network the same value(s) of all of the first, second, third and fourth indicators specified herein in the present disclosure.

The UE receives from the network a RRC signaling/parameter that configures/indicates the presence or absence of the second indicator in the corresponding DCI format according to those specified herein in the present disclosure.

The UE receives from the network a RRC signaling/parameter and/or a MAC CE activation/deactivation command and/or a DCI indicator that configures/indicates the presence or absence of the fourth indicator in the corresponding DCI format, e.g., whether or not the SRS resource set indicator in the corresponding DCI format is used/repurposed as the fourth indicator, according to those specified herein in the present disclosure, or whether or not the SRS resource set indicator in the corresponding DCI format is used to determine the associated SRS resource indicator (field) and Precoding information and number of layers (field) for the uplink transmission(s) as specified in the Rel-16/17.

Furthermore, when/if the UE is provided/indicated/configured by the network, e.g., via higher layer RRC signaling/parameter and/or MAC CE command and/or dynamic DCI based L1 signaling, a first group/list of TCI states/TCI state IDs or SSBs/SSB indexes - e.g., associated to a first TRP or first TCI state(s) of a TCI codepoint – and/or a second group/list of TCI states/TCI state IDs or SSBs/SSB indexes – e.g., associated to a second TRP or second TCI state(s) of a TCI codepoint – as specified herein in the present disclosure, the UE could assume/expect/determine/identify following examples.

In one example, the second indicator for PDSCH reception(s) as specified herein in the present disclosure is present in the corresponding DCI format (e.g., DCI format 1_1/1_2). That is, configuring both of the first and second groups/lists of TCI states/TCI state IDs or SSBs/SSB indexes – e.g., as/via a RRC configuration – could also configure or indicate (to the UE) the presence of the second indicator in the corresponding DCI format for PDSCH reception(s).

In one example, the fourth indicator for PUSCH transmission(s) as specified herein in the present disclosure is present in the corresponding DCI format (e.g., DCI format 0_1/0_2). That is, configuring both of the first and second groups/lists of TCI states/TCI state IDs or SSBs/SSB indexes – e.g., as/via a RRC configuration – could also configure or indicate (to the UE) the presence of the fourth indicator in the corresponding DCI format for PUSCH transmission(s). Or equivalently, the SRS resource set indicator in the corresponding DCI format is used/repurposed as the fourth indicator, according to those specified herein in the present disclosure. That is, configuring both of the first and second groups/lists of TCI states/TCI state IDs or SSBs/SSB indexes – e.g., as/via a RRC configuration – could also configure or indicate (to the UE) that the SRS resource set indicator in the corresponding DCI format is used/repurposed as the fourth indicator, according to those specified herein in the present disclosure.

A UE could receive from the network a DCI that schedules aperiodic CSI report(s) -e.g., on PUSCH – by a “CSI request” field in the DCI (e.g., DCI format 0_1). The UE could determine a trigger/triggering state initiated/indicated by the “CSI request” field in the DCI. The trigger/triggering state – configured using the higher layer parameter CSI-AperiodicTriggerState – initiated/indicated by the “CSI request” field in the DCI could be associated with one or multiple CSI reporting settings each provided by CSI-ReportConfig, wherein a CSI reporting setting provided by CSI-ReportConfig could be linked to one or multiple periodic, semi-persistent, or aperiodic CSI resource settings (and therefore, the corresponding CSI resource set(s) and CSI-RS resource(s) configured/provided therein).

In a SDCI based MTRP system, the UE could first determine which one or more of the set of TCI states/pairs of TCI states (e.g., one or more joint DL and UL TCI states or one or more separate DL TCI states provided by DLorJoint-TCIState) indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure. The UE could then measure the CSI-RS(s) triggered by/associated to the trigger/triggering state as specified herein in the present disclosure, and use/apply the corresponding measurement result(s) for the aperiodic CSI reporting.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to the first indicator configured/associated with the CORESET(s) as specified herein in the present disclosure, in which the PDCCH candidate(s) that carries the corresponding DCI (e.g., DCI format 0_1) that indicates the “CSI request” field is received.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

As illustrated in FIG. 12, a conceptual example of the above described design procedure(s) is provided. As depicted/illustrated in FIG. 10, when the first indicator for CORESET X is set to “00,” wherein PDCCH candidate(s) that carries the DCI (e.g., DCI format 0_1) that indicates the “CSI request” field is received in CORESET X, the first TCI state(s), i.e., TCI state #A among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1); when the first indicator for CORESET X is set to “01,” wherein PDCCH candidate(s) that carries the DCI (e.g., DCI format 0_1) that indicates the “CSI request” field is received in CORESET X, the second TCI state(s), i.e., TCI state #B among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1).

In yet another example, a (new or repurposed) DCI indicator field could be indicated/provided in the DCI (e.g., DCI format 0_1) that indicates the “CSI request” field, and therefore, triggers/schedules the aperiodic CSI report(s). For instance, the DCI indicator could be a 2-bit indicator with four states/representations “00,” “01,” “10,” and “11.” As described herein in the present disclosure, the (2-bit) DCI indicator field could be a new/dedicated DCI field, e.g., denoted by “TCI selection” field, in the corresponding DCI format that indicates/provides the “CSI request” field. Alternatively, the (2-bit) DCI indicator field could be implemented/realized by repurposing one or more DCI field bits of one or more existing DCI fields in the corresponding DCI format that indicates/provides the “CSI request” field.

For example, when/if the (2-bit) DCI indicator in the DCI (e.g., DCI format 0_1) is set to “00” (“01,” “10,” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the (2-bit) DCI indicator in the DCI (e.g., DCI format 0_1) is set to “01” (“00,” “10,” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the (2-bit) DCI indicator in the DCI (e.g., DCI format 0_1) is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In addition to the DCI based L1 signaling, optionally, the UE could be provided/indicated/configured by the network, e.g., via higher layer RRC signaling/parameter and/or MAC CE command, the (2-bit) indicator.

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to in which CORESET(s), the PDCCH candidate(s) that carries the corresponding DCI (e.g., DCI format 0_1) that indicates the “CSI request” field is received.

For example, when/if the PDCCH candidate(s) that carries the DCI (e.g., DCI format 0_1) that indicates the “CSI request” field is received in CORESET(s) associated/configured with the first indicator as specified herein in the present disclosure set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

For another example, when/if the PDCCH candidate(s) that carries the DCI (e.g., DCI format 0_1) that indicates the “CSI request” field is received in CORESET(s) associated/configured with the first indicator as specified herein in the present disclosure set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the PDCCH candidate(s) that carries the DCI (e.g., DCI format 0_1) that indicates the “CSI request” field is received in CORESET(s) associated/configured with the first indicator as specified herein in the present disclosure set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

As illustrated in FIG. 13, a conceptual example depicting the above discussed design procedure(s) is presented. As illustrated in FIG. 13, when/if the DCI (e.g., DCI format 0_1) that indicates the “CSI request” field, and therefore, schedules the aperiodic CSI report(s) is received in CORESET X configured/associated with the first indicator set to “00,” the first TCI state, i.e., TCI state #A among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1); when/if the DCI (e.g., DCI format 0_1) that indicates the “CSI request” field, and therefore, schedules the aperiodic CSI report(s) is received in CORESET Y configured/associated with the first indicator set to “01,” the second TCI state, i.e., TCI state #B among the two TCI states indicated by a TCI codepoint in this example, is used/applied for receiving the CSI-RS(s) that is triggered by or associated to the trigger/triggering state indicated by the “CSI request” field in the corresponding triggering DCI (e.g., DCI format 0_1).

In yet another example, the UE could determine, which one or more of the set of TCI states/pairs of TCI states indicated, e.g., by a TCI codepoint, in a beam indication DCI or MAC CE as specified herein in the present disclosure, to use/apply for receiving the CSI-RS(s) triggered by/associated to the trigger/triggering state that is indicated by the “CSI request” field in the corresponding DCI (e.g., DCI format 0_1) as specified herein in the present disclosure, according to the first indicator configured/associated with the CORESET(s) as specified herein in the present disclosure, in which the PDCCH candidate(s) that carries the corresponding DCI (e.g., DCI format 0_1) that indicates the “CSI request” field is received, and a (new or repurposed) DCI indicator field indicated/provided in the DCI (e.g., DCI format 0_1) that indicates the “CSI request” field, and therefore, triggers/schedules the aperiodic CSI report(s).

For instance, the DCI indicator could be a 1-bit flag indicator with two states/representations “0” and “1.” As described herein in the present disclosure, the (1-bit) DCI indicator field could be a new/dedicated DCI field, e.g., denoted by ‘TRP selection’ field, in the corresponding DCI format that indicates/provides the “CSI request” field. Alternatively, the (1-bit) DCI indicator field could be implemented/realized by repurposing one or more DCI field bits of one or more existing DCI fields in the corresponding DCI format that indicates/provides the “CSI request” field.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” and the 1-bit DCI indicator in the DCI (e.g., DCI format 0_1) is set to “0” (or “1”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSIrequest” field in the corresponding DCI (e.g., DCI format 0_1) as specified herein in the present disclosure.

For another example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “00,” and the 1-bit DCI indicator in the DCI (e.g., DCI format 0_1) is set to “1” (or “0”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” and the 1-bit DCI indicator in the DCI (e.g., DCI format 0_1) is set to “0” (or “1”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI (e.g., DCI format 0_1) that indicates the “CSI request” field is received, is set to “01,” and the 1-bit DCI indicator in the DCI (e.g., DCI format 0_1) is set to “1” (or “0”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the CSI-RS(s) triggered by/associated to the trigger/triggering state that is indicated by the “CSI request” field in the corresponding DCI (e.g., DCI format 0_1) as specified herein in the present disclosure.

In addition to the DCI based L1 signaling, optionally, the UE could be provided/indicated/configured by the network, e.g., via higher layer RRC signaling/parameter and/or MAC CE command, the (1-bit) indicator.

The aperiodic CSI-RS resource(s) specified herein in the present disclosure could be (higher layer) configured to follow one or more of the indicated TCI states for at least the UE-dedicated channels such as PDCCH(s) and/or PDSCH(s).

A UE could receive from the network a DCI that indicates a “SRS request” field. The “SRS request” field in DCI format 0_1, 1_1, 0_2 (if the “SRS request” field is present), 1_2 (if the “SRS request” field is present) indicates the corresponding triggered SRS resource set. The 2-bit “SRS request” field in DCI format 2_3 indicates the corresponding triggered SRS resource set and defined by the entries of the higher layer parameter srs-ResourceSetToAddModList if the UE is configured with higher layer parameter srs-TPC-PDCCH-Group set to ‘typeB’, or indicates the SRS transmission on a set of serving cells configured by higher layers if the UE is configured with higher layer parameter srs-TPC-PDCCH-Group set to “typeA.”

In a SDCI based MTRP system, the UE could first determine which one or more of the set of TCI states/pairs of TCI states (e.g., one or more joint DL and UL TCI states provided by DLorJoint-TCIState or one or more separate UL TCI states provided by ULTCI-State) indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to the first indicator configured/associated with the CORESET(s) as specified herein in the present disclosure, in which the PDCCH candidate(s) that carries the corresponding DCI that indicates the “SRS request” field is received.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

AS illustrated in FIG. 14, a conceptual example of the above described design procedure(s) is provided. As depicted/illustrated in FIG. 14, when the first indicator for CORESET X is set to “00,” wherein PDCCH candidate(s) that carries the DCI that indicates the “SRS request” field is received in CORESET X, the first TCI state(s), i.e., TCI state #A among the two TCI states indicated by a TCI codepoint in this example, is used/applied for transmitting the SRS(s) in the SRS resource set(s) triggered by the “SRS request” field in the corresponding triggering DCI; when the first indicator for CORESET X is set to “01,” wherein PDCCH candidate(s) that carries the DCI that indicates the “SRS request” field is received in CORESET X, the second TCI state(s), i.e., TCI state #B among the two TCI states indicated by a TCI codepoint in this example, is used/applied for transmitting the SRS(s) in the SRS resource set(s) triggered by the “SRS request” field in the corresponding triggering DCI.

In yet another example, a (new or repurposed) DCI indicator field could be indicated/provided in the DCI that indicates the “SRS request” field. For instance, the DCI indicator could be a 2-bit indicator with four states/representations “00,” “01,” 10′ and “11.” As described herein in the present disclosure, the (2-bit) DCI indicator field could be a new/dedicated DCI field, e.g., denoted by “TCI selection” field, in the corresponding DCI format that indicates/provides the “SRS request” field. Alternatively, the (2-bit) DCI indicator field could be implemented/realized by repurposing one or more DCI field bits of one or more existing DCI fields in the corresponding DCI format that indicates/provides the “SRS request” field.

For example, when/if the (2-bit) DCI indicator in the DCI is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the (2-bit) DCI indicator in the DCI is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the (2-bit) DCI indicator in the DCI is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In addition to the DCI based L1 signaling, optionally, the UE could be provided/indicated/configured by the network, e.g., via higher layer RRC signaling/parameter and/or MAC CE command, the (2-bit) indicator.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to in which CORESET(s), the PDCCH candidate(s) that carries the corresponding DCI that indicates the “SRS request” field is received.

For example, when/if the PDCCH candidate(s) that carries the DCI that indicates the “SRS request” field is received in CORESET(s) associated/configured with the first indicator as specified herein in the present disclosure set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the PDCCH candidate(s) that carries the DCI that indicates the “SRS request” field is received in CORESET(s) associated/configured with the first indicator as specified herein in the present disclosure set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the PDCCH candidate(s) that carries the DCI that indicates the “SRS request” field is received in CORESET(s) associated/configured with the first indicator as specified herein in the present disclosure set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

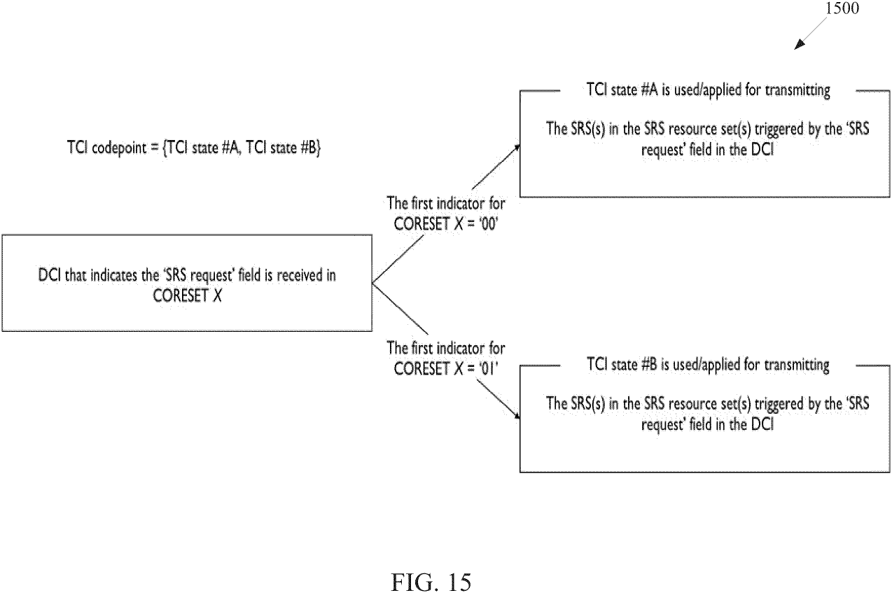

As illustrated in FIG. 15, a conceptual example depicting the above discussed design procedure(s) is presented. As illustrated in FIG. 15, when/if the DCI that indicates the “SRS request” field is received in CORESET X configured/associated with the first indicator set to “00,” the first TCI state(s), i.e., TCI state #A among the two TCI states indicated by a TCI codepoint in this example, is used/applied for transmitting the SRS(s) in the SRS resource set(s) triggered by the “SRS request” field in the corresponding triggering DCI; when/if the DCI that indicates the “SRS request” field is received in CORESET Y configured/associated with the first indicator set to “01,” the second TCI state(s), i.e., TCI state #B among the two TCI states indicated by a TCI codepoint in this example, is used/applied for transmitting the SRS(s) in the SRS resource set(s) triggered by the “SRS request” field in the corresponding triggering DCI.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to the first indicator configured/associated with the CORESET(s) as specified herein in the present disclosure, in which the PDCCH candidate(s) that carries the corresponding DCI that indicates the “SRS request” field is received, and a (new or repurposed) DCI indicator field indicated/provided in the DCI that indicates the “SRS request” field. For instance, the DCI indicator could be a 1-bit flag indicator with two states/representations “0” and “1.”

As described herein in the present disclosure, the (1-bit) DCI indicator field could be a new/dedicated DCI field, e.g., denoted by “TRP selection” field, in the corresponding DCI format that indicates/provides the “SRS request” field. Alternatively, the (1-bit) DCI indicator field could be implemented/realized by repurposing one or more DCI field bits of one or more existing DCI fields in the corresponding DCI format that indicates/provides the “SRS request” field.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” and the 1-bit DCI indicator in the DCI (e.g., DCI format 0_1) is set to “0” (or “1”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” and the 1-bit DCI indicator in the DCI (e.g., DCI format 0_1) is set to “1” (or “0”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” and the 1-bit DCI indicator in the DCI (e.g., DCI format 0_1) is set to “0” (or “1”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” and the 1-bit DCI indicator in the DCI (e.g., DCI format 0_1) is set to “1” (or “0”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In addition to the DCI based L1 signaling, optionally, the UE could be provided/indicated/configured by the network, e.g., via higher layer RRC signaling/parameter and/or MAC CE command, the (1-bit) indicator.

The triggered SRS resource set(s) - and therefore, the SRS resource(s) configured/provided therein - specified herein in the present disclosure could be (higher layer) configured to follow one or more of the indicated TCI states for at least the UE-dedicated channels such as PUCCH(s) and/or PUSCH(s).

For semi-persistent scheduling (SPS) PDSCH reception(s) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) according to one or more of the followings.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In yet another example, the UE could be indicated/provided/configured by the network, e.g., via higher layer RRC signaling/parameter (e.g., in the higher layer parameter SPS-Config that configures the corresponding SPS PDSCH(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). For instance, a 2-bit indicator could be provided in the higher layer parameter SPS-Config that configures the corresponding SPS PDSCH(s).

For example, when/if the (2-bit) indicator in the SPS-Config is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

For another example, when/if the (2-bit) indicator in the SPS-Config is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

Yet for another example, when/if the (2-bit) indicator in the SPS-Config is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

For periodic PUCCH transmission(s) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) according to one or more of the following examples.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In yet another example, the UE could be indicated/provided/configured by the network, e.g., via higher layer RRC signaling/parameter (e.g., in the higher layer parameter PUCCH-Config that configures the corresponding periodic PUCCH transmission(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). For instance, a 2-bit indicator could be provided in the higher layer parameter PUCCH-Config that configures the corresponding periodic PUCCH transmission(s).

For example, when/if the (2-bit) indicator in the PUCCH-Config is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

For another example, when/if the (2-bit) indicator in the PUCCH-Config is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

Yet for another example, when/if the (2-bit) indicator in the PUCCH-Config is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the periodic PUCCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

For configured-grant (CG) PUSCH transmission(s) - e.g., type1 CG-PUSCH (uplink grant is configured via RRC) or type2 CG-PUSCH (uplink grant is provided via the PDCCH addressed to CS-RNTI) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) according to one or more of the followings.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In yet another example, the UE could be indicated/provided/configured by the network, e.g., via higher layer RRC signaling/parameter (e.g., in the higher layer parameter ConfiguredGrantConfig that configures the corresponding CG-PUSCH(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). For instance, a 2-bit indicator could be provided in the higher layer parameter ConfiguredGrantConfig that configures the corresponding CG-PUSCH(s).

For example, when/if the (2-bit) indicator in the ConfiguredGrantConfig is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

For another example, when/if the (2-bit) indicator in the ConfiguredGrantConfig is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

Yet for another example, when/if the (2-bit) indicator in the ConfiguredGrantConfig is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG PUSCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the CG-PUSCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

In a SDCI based MTRP system, the UE could first determine which one or more of the set of TCI states/pairs of TCI states (e.g., one or more joint DL and UL TCI states provided by DLorJoint-TCIState or one or more separate UL TCI states provided by ULTCI-State) indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to the first indicator configured/associated with the CORESET(s) as specified herein in the present disclosure, in which the PDCCH candidate(s) that carries the corresponding DCI that indicates the “SRS request” field is received.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

FIG. 15 illustrates an example of associating TCI states to aperiodic SRS resources 1500 according to embodiments of the present disclosure. An embodiment of associating the TCI states to the aperiodic SRS resources 1500 shown in FIG. 15 is for illustration only.

In FIG. 15, a conceptual example of the above described design procedure(s) is provided. As depicted/illustrated in FIG. 15, when the first indicator for CORESET X is set to “00,” wherein PDCCH candidate(s) that carries the DCI that indicates the “SRS request” field is received in CORESET X, the first TCI state(s), i.e., TCI state #A among the two TCI states indicated by a TCI codepoint in this example, is used/applied for transmitting the SRS(s) in the SRS resource set(s) triggered by the “SRS request” field in the corresponding triggering DCI; when the first indicator for CORESET X is set to “01,” wherein PDCCH candidate(s) that carries the DCI that indicates the “SRS request” field is received in CORESET X, the second TCI state(s), i.e., TCI state #B among the two TCI states indicated by a TCI codepoint in this example, is used/applied for transmitting the SRS(s) in the SRS resource set(s) triggered by the “SRS request” field in the corresponding triggering DCI.

In yet another example, a (new or repurposed) DCI indicator field could be indicated/provided in the DCI that indicates the “SRS request” field. For instance, the DCI indicator could be a 2-bit indicator with four states/representations “00,” “01,” “10” and “11.” As described herein in the present disclosure, the (2-bit) DCI indicator field could be a new/dedicated DCI field, e.g., denoted by “TCI selection” field, in the corresponding DCI format that indicates/provides the “SRS request” field. Alternatively, the (2-bit) DCI indicator field could be implemented/realized by repurposing one or more DCI field bits of one or more existing DCI fields in the corresponding DCI format that indicates/provides the “SRS request” field.

For example, when/if the (2-bit) DCI indicator in the DCI is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the (2-bit) DCI indicator in the DCI is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the (2-bit) DCI indicator in the DCI is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In addition to the DCI based L1 signaling, optionally, the UE could be provided/indicated/configured by the network, e.g., via higher layer RRC signaling/parameter and/or MAC CE command, the (2-bit) indicator.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to in which CORESET(s), the PDCCH candidate(s) that carries the corresponding DCI that indicates the “SRS request” field is received.

For example, when/if the PDCCH candidate(s) that carries the DCI that indicates the “SRS request” field is received in CORESET(s) associated/configured with the first indicator as specified herein in the present disclosure set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the PDCCH candidate(s) that carries the DCI that indicates the “SRS request” field is received in CORESET(s) associated/configured with the first indicator as specified herein in the present disclosure set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the PDCCH candidate(s) that carries the DCI that indicates the “SRS request” field is received in CORESET(s) associated/configured with the first indicator as specified herein in the present disclosure set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

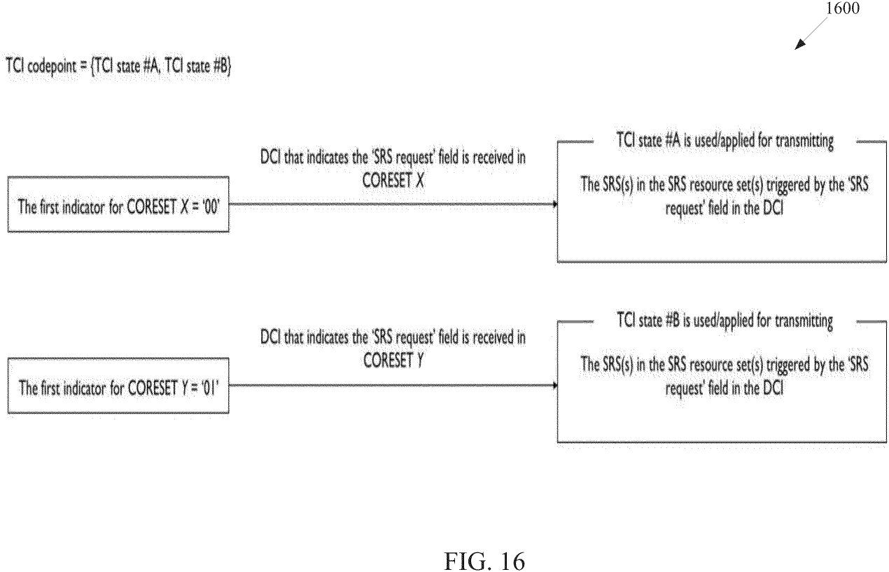

FIG. 16 illustrates another example of associating TCI states to aperiodic SRS resources 1600 according to embodiments of the present disclosure. An embodiment of associating the TCI states to the aperiodic SRS resources 1600 shown in FIG. 16 is for illustration only.

In FIG. 16, a conceptual example depicting the above discussed design procedure(s) is presented. As illustrated in FIG. 16, when/if the DCI that indicates the “SRS request” field is received in CORESET X configured/associated with the first indicator set to “00,” the first TCI state(s), i.e., TCI state #A among the two TCI states indicated by a TCI codepoint in this example, is used/applied for transmitting the SRS(s) in the SRS resource set(s) triggered by the “SRS request” field in the corresponding triggering DCI; when/if the DCI that indicates the “SRS request” field is received in CORESET Y configured/associated with the first indicator set to “01,” the second TCI state(s), i.e., TCI state #B among the two TCI states indicated by a TCI codepoint in this example, is used/applied for transmitting the SRS(s) in the SRS resource set(s) triggered by the “SRS request” field in the corresponding triggering DCI.

In yet another example, the UE could determine, which one or more of the set of TCI states/pairs of TCI states indicated, e.g., by a TCI codepoint, in a beam indication DCI or MAC CE as specified herein in the present disclosure, to use/apply for transmitting the SRS(s) in the SRS resource set(s) triggered by the “SRS request” field in the corresponding DCI as specified herein in the present disclosure, according to the first indicator configured/associated with the2 CORESET(s) as specified herein in the present disclosure, in which the PDCCH candidate(s) that carries the corresponding DCI that indicates the “SRS request” field is received, and a (new or repurposed) DCI indicator field indicated/provided in the DCI that indicates the “SRS request” field. For instance, the DCI indicator could be a 1-bit flag indicator with two states/representations “0” and “1.” As described herein in the present disclosure, the (1-bit) DCI indicator field could be a new/dedicated DCI field, e.g., denoted by “TRP selection” field, in the corresponding DCI format that indicates/provides the “SRS request” field. Alternatively, the (1-bit) DCI indicator field could be implemented/realized by repurposing one or more DCI field bits of one or more existing DCI fields in the corresponding DCI format that indicates/provides the “SRS request” field.

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” and the 1-bit DCI indicator in the DCI (e.g., DCI format 0_1) is set to “0” (or “1”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

For another example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “00,” and the 1-bit DCI indicator in the DCI (e.g., DCI format 0_1) is set to “1” (or “0”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” and the 1-bit DCI indicator in the DCI (e.g., DCI format 0_1) is set to “0” (or “1”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

Yet for another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s), in which the PDCCH candidate(s) that carries the DCI that indicates the “SRS request” field is received, is set to “01,” and the 1-bit DCI indicator in the DCI (e.g., DCI format 0_1) is set to “1” (or “0”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the SRS(s) in the SRS resource set(s) triggered by the “SRS request” field in the corresponding DCI as specified herein in the present disclosure.

In addition to the DCI based L1 signaling, optionally, the UE could be provided/indicated/configured by the network, e.g., via higher layer RRC signaling/parameter and/or MAC CE command, the (1-bit) indicator.

The triggered SRS resource set(s) – and therefore, the SRS resource(s) configured/provided therein – specified herein in the present disclosure could be (higher layer) configured to follow one or more of the indicated TCI states for at least the UE-dedicated channels such as PUCCH(s) and/or PUSCH(s).

For semi-persistent scheduling (SPS) PDSCH reception(s) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) according to one or more of the followings.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the SPS PDSCH(s).

In yet another example, the UE could be indicated/provided/configured by the network, e.g., via higher layer RRC signaling/parameter (e.g., in the higher layer parameter SPS-Config that configures the corresponding SPS PDSCH(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). For instance, a 2-bit indicator could be provided in the higher layer parameter SPS-Config that configures the corresponding SPS PDSCH(s).

For example, when/if the (2-bit) indicator in the SPS-Config is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

For another example, when/if the (2-bit) indicator in the SPS-Config is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

Yet for another example, when/if the (2-bit) indicator in the SPS-Config is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s) - e.g., configured by the SPS-Config.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for receiving the corresponding SPS PDSCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for receiving the corresponding SPS PDSCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

For periodic PUCCH transmission(s) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) according to one or more of the followings.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the periodic PUCCH(s).

In yet another example, the UE could be indicated/provided/configured by the network, e.g., via higher layer RRC signaling/parameter (e.g., in the higher layer parameter PUCCH-Config that configures the corresponding periodic PUCCH transmission(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). For instance, a 2-bit indicator could be provided in the higher layer parameter PUCCH-Config that configures the corresponding periodic PUCCH transmission(s).

For example, when/if the (2-bit) indicator in the PUCCH-Config is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

For another example, when/if the (2-bit) indicator in the PUCCH-Config is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

Yet for another example, when/if the (2-bit) indicator in the PUCCH-Config is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s) - e.g., configured by the PUCCH-Config.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure – e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure – e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure – e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding periodic PUCCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the periodic PUCCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding periodic PUCCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

For configured-grant (CG) PUSCH transmission(s) - e.g., type1 CG-PUSCH (uplink grant is configured via RRC) or type2 CG-PUSCH (uplink grant is provided via the PDCCH addressed to CS-RNTI) in a single-DCI (SDCI) based MTRP system, the UE could determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) according to one or more of the followings.

In one example, the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In another example, the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In yet another example, the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the CG-PUSCH(s).

In yet another example, the UE could be indicated/provided/configured by the network, e.g., via higher layer RRC signaling/parameter (e.g., in the higher layer parameter ConfiguredGrantConfig that configures the corresponding CG-PUSCH(s)) and/or MAC CE command and/or dynamic DCI based L1 signaling, an indicator to indicate which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). For instance, a 2-bit indicator could be provided in the higher layer parameter ConfiguredGrantConfig that configures the corresponding CG-PUSCH(s).

For example, when/if the (2-bit) indicator in the ConfiguredGrantConfig is set to “00” (“01,” “10” or “11”), the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

For another example, when/if the (2-bit) indicator in the ConfiguredGrantConfig is set to “01” (“00,” “10” or “11”), the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

Yet for another example, when/if the (2-bit) indicator in the ConfiguredGrantConfig is set to “10” or “11” (“00” or “01”), the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s) - e.g., configured by the ConfiguredGrantConfig.

In yet another example, the UE could follow the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s).

For example, when/if the first TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “00,” the UE could use/apply the first TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s).

For another example, when/if the second TCI state(s) among the set of (e.g., N=2) TCI states/pairs of TCI states indicated, e.g., by a TCI codepoint, in a beam indication DCI or MAC CE as specified herein in the present disclosure is for PDCCH reception according to one or more of the design examples as specified herein in the present disclosure - e.g., when/if the first indicator configured/associated with the CORESET(s) is set to “01,” the UE could use/apply the second TCI state(s) among the set of (e.g., N=2) TCI states/pairs of TCI states indicated, e.g., by a TCI codepoint, in a beam indication DCI or MAC CE as specified herein in the present disclosure, for transmitting the corresponding CG PUSCH(s).

Yet for another example, when/if the first and second TCI states among the set of (e.g., N=2) TCI states/pairs of TCI states indicated, e.g., by a TCI codepoint, in a beam indication DCI or MAC CE as specified herein in the present disclosure are for PDCCH reception according to one or more of the design examples as specified herein in the present disclosure - e.g., when/if the first indicator configured/associated with the CORESET(s) is set to “10” or “11,” the UE could use/apply both of the first and second TCI states among the set of (e.g., N=2) TCI states/pairs of TCI states indicated, e.g., by a TCI codepoint, in a beam indication DCI or MAC CE as specified herein in the present disclosure, for transmitting the corresponding CG-PUSCH(s).

In yet another example, the UE could follow the second indicator indicated for PDSCH reception as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the CG-PUSCH(s) as specified herein in the present disclosure could be applied/extended to the second indicator for PDSCH reception here by replacing the first indicator configured for PDCCH reception in CORESET(s) with the second indicator indicated for PDSCH reception.

In yet another example, the UE could follow the third indicator configured for PUCCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) as specified herein in the present disclosure could be applied/extended to the third indicator for PUCCH transmission here by replacing the first indicator configured for PDCCH reception in CORESET(s) with the third indicator configured for PUCCH transmission.

In yet another example, the UE could follow the fourth indicator indicated for PUSCH transmission as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s). The design examples related to using the first indicator configured for PDCCH reception in one or more CORESETs as specified herein in the present disclosure to determine which one or more of the set of TCI states/pairs of TCI states indicated, e.g., by a TCI codepoint, in a beam indication DCI or MAC CE as specified herein in the present disclosure, to use/apply for transmitting the corresponding CG-PUSCH(s) as specified herein in the present disclosure could be applied/extended to the fourth indicator for PUSCH transmission here by replacing the first indicator configured for PDCCH reception in CORESET(s) with the fourth indicator indicated for PUSCH transmission.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a radio resource control (RRC) signaling, a first indicator associated with one or more transmission configuration indication (TCI) states;
receive, in a medium access control (MAC) control element (CE), a second indicator for a TCI codepoint including a first TCI state or a second TCI state;
receive, in downlink control information (DCI), scheduling information of a first physical downlink shared channel (PDSCH); and
receive, based on a first applied TCI state or a second applied TCI state, the first PDSCH; and
a processor operably coupled to the transceiver, the processor configured to:
identify, based on the first indicator, at least one of a first group or a second group of TCI states;
determine, based on the second indicator, whether the first or second TCI state updates the first or second applied TCI state; and
determine, based on the identification and the second indicator, whether the first and second TCI states belong to the first group or second group of TCI states.

2. The UE of claim 1, wherein:
the processor is further configured to determine, based on the identification, a presence or absence of a third indicator in the DCI, and
when the third indicator is determined to be present, the third indicator indicates whether to use the first applied TCI state or the second applied TCI state to receive the first PDSCH.

3. The UE of claim 2, wherein:
when only one of the first group of TCI states or the second group of TCI states is identified, the third indicator is determined to be absent; and
when both the first group of TCI states and the second group of TCI states are identified, the third indicator is determined to be present.

4. The UE of claim 1, wherein the first indicator is one of: (i) an index in a higher layer parameter, TCI-State, (ii) a number of TCI states in the first or second group of TCI states, and (iii) indexes or identities (IDs) of the TCI states in the first or second group of TCI states.

5. The UE of claim 1, wherein the second indicator indicates one of: (i) a presence or absence of the second TCI state and (ii), when the second TCI state is absent, whether the first TCI state updates the first or second applied TCI state.

6. The UE of claim 5, wherein:
when the second TCI state is present, the transceiver is further configured to receive a second PDSCH based on the first and second TCI states;
when the second TCI state is absent and the first TCI state is to update the first applied TCI state, the transceiver is further configured to receive the second PDSCH based on the first TCI state and the second applied TCI state; and
when the second TCI is absent and the first TCI state is to update the second applied TCI state, the transceiver is further configured to receive the second PDSCH based on the first TCI state and the first applied TCI state.

7. The UE of claim 1, wherein:
the transceiver is further configured to receive a trigger state to activate one or more aperiodic channel state information (CSI) reference signals (RSs) for measurement;
the RRC signaling includes a third indicator; and
the processor is further configured to determine, based on the third indicator, whether to use the first or second applied TCI state for receiving the one or more aperiodic CSI-RSs.

8. A base station (BS), comprising:
a transceiver configured to:
transmit, in a radio resource control (RRC) signaling, a first indicator associated with one or more transmission configuration indication (TCI) states;
transmit, in a medium access control (MAC) control element (CE), a second indicator for a TCI codepoint including a first TCI state or a second TCI state;
transmit, in downlink control information (DCI), scheduling information of a first physical downlink shared channel (PDSCH); and
transmit the first PDSCH for reception based on a first applied TCI state or a second applied TCI state;
wherein the first indicator provides an indication of at least one of a first group or a second group of TCI states,
wherein the second indicator indicates whether the first or second TCI state updates the first or second applied TCI state, and
wherein the indication and the second indicator indicate whether the first and second TCI states belong to the first group or second group of TCI states.

9. The BS of claim 8, wherein:
the indication further indicates a presence or absence of a third indicator in the DCI, and
when the third indicator is indicated as present, the third indicator indicates whether to use the first applied TCI state or the second applied TCI state for the first PDSCH.

10. The BS of claim 9, wherein:
when only one of the first group of TCI states or the second group of TCI states is indicated, the third indicator is indicated as absent; and
when both the first group of TCI states and the second group of TCI states are indicated, the third indicator is indicated as present.

11. The BS of claim 8, wherein the first indicator is one of: (i) an index in a higher layer parameter, TCI-State, (ii) a number of TCI states in the first or second group of TCI states, and (iii) indexes or identities (IDs) of the TCI states in the first or second group of TCI states.

12. The BS of claim 8, wherein the second indicator indicates one of: (i) a presence or absence of the second TCI state and (ii), when the second TCI state is absent, whether the first TCI state updates the first or second applied TCI state.

13. The BS of claim 12, wherein:
presence of the second TCI state indicates to use the first and second TCI states for a second PDSCH;
absence of the second TCI state and the first TCI state being to update the first applied TCI state, indicates to use the first TCI state and the second applied TCI state for the second PDSCH; and
absence of the second TCI is absent and the first TCI state being to update the second applied TCI state, indicates to use the first TCI state and the first applied TCI state for the second PDSCH.

14. The BS of claim 8, wherein:
the transceiver is further configured to transmit a trigger state to activate one or more aperiodic channel state information (CSI) reference signals (RSs) for measurement;
the RRC signaling includes a third indicator; and
the third indicator indicates whether to use the first or second applied TCI state for the one or more aperiodic CSI-RSs.

15. A method performed by a user equipment (UE), the method comprising:
receiving, in a radio resource control (RRC) signaling, a first indicator associated with one or more transmission configuration indication (TCI) states;
receiving, in a medium access control (MAC) control element (CE), a second indicator for a TCI codepoint including a first TCI state or a second TCI state;
receiving, in downlink control information (DCI), scheduling information of a first physical downlink shared channel (PDSCH);
receiving, based on a first applied TCI state or a second applied TCI state, the first PDSCH;
identifying, based on the first indicator, at least one of a first group or a second group of TCI states;
determining, based on the second indicator, whether the first or second TCI state updates the first or second applied TCI state; and
determining, based on the identification and the second indicator, whether the first and second TCI states belong to the first group or second group of TCI states.

16. The method of claim 15, further comprising:
determining, based on the identification, a presence or absence of a third indicator in the DCI,
wherein, when the third indicator is determined to be present, the third indicator indicates whether to use the first applied TCI state or the second applied TCI state to receive the first PDSCH.

17. The method of claim 16, wherein:
when only one of the first group of TCI states or the second group of TCI states is identified, the third indicator is determined to be absent; and
when both the first group of TCI states and the second group of TCI states are identified, the third indicator is determined to be present.

18. The method of claim 15, wherein the first indicator is one of: (i) an index in a higher layer parameter, TCI-State, (ii) a number of TCI states in the first or second group of TCI states, and (iii) indexes or identities (IDs) of the TCI states in the first or second group of TCI states.

19. The method of claim 15, wherein the second indicator indicates one of: (i) a presence or absence of the second TCI state and (ii), when the second TCI state is absent, whether the first TCI state updates the first or second applied TCI state.

20. The method of claim 19, further comprising:
when the second TCI state is present, receiving a second PDSCH based on the first and second TCI states;
when the second TCI state is absent and the first TCI state is to update the first applied TCI state, receiving the second PDSCH based on the first TCI state and the second applied TCI state; or
when the second TCI is absent and the first TCI state is to update the second applied TCI state, receiving the second PDSCH based on the first TCI state and the first applied TCI state.
